(19) United States
(12) Patent Application Publication
(10) Pub. No.: US 2010/0088139 A1
(43) Pub. Date: Apr. 8, 2010

(54) PROJECT MANAGEMENT SYSTEM ADAPTED FOR PLANNING AND MANAGING PROJECTS

(76) Inventors: M. AHSAN RAHI, Sugar Land, TX (US); Jose Roberto Scalon Cotello, Missouri City, TX (US); Alex Antonio Garcia Irausquin, Caracas (VE)

Correspondence Address: SCHLUMBERGER INFORMATION SOLUTIONS, 5599 SAN FELIPE, SUITE 1700, HOUSTON, TX, 77056-2722, US

(21) Appl. No.: 12/246,863

(22) Filed: Oct. 7, 2008

(51) Int. Cl. G06Q 10/00

(52) U.S. Cl. 705/8; 705/7; 705/11

(57) ABSTRACT

A method is disclosed, that is practiced by a computer system, for planning and managing project plans associated with one or more projects in a business, the computer system including a processor that is responsive to input data, a recorder or display device, and a memory, the memory storing software, comprising: executing, by the processor, the software stored in the memory of the computer system in response to the input data including knowledge and experience data, and, in response to the executing step, generating one or more output displays adapted for planning and managing the project plans of the one or more projects in the business; recording or displaying, by the recorder or display device, the one or more output displays on the recorder or display device; wherein the one or more output displays being recorded or displayed on the recorder or display device include, Line-of-Sight (LOS) views of information pertaining to the business, the Line-of-Sight views providing a user with a view into the project plans of the one or more projects that is filtered based on the user's discipline or responsibility in the project and a level of detail that is appropriate to the user's role in the one or more projects.

### CROSS REFERENCE TO RELATED APPLICATIONS

This application is related to a prior pending application entitled “Method and System for Delivering and Executing Best Practices in Oilfield Development Projects’, corresponding to attorney docket number 110.0126, which was filed as U.S. Provisional Patent Application Ser. No. 60/852,503 on Oct. 17, 2006 and was filed as U.S. Utility patent application Ser. No. 11/694,986 on Mar. 31, 2007, the disclosure of which is incorporated by reference into the specification of this application.

### BACKGROUND

The subject matter disclosed in this specification relates to a Project Management System, known as the ‘Enterprise Project Management System (EPMS)’, which is adapted for planning and managing projects of various sizes and types in an integrated and intuitive manner and for facilitating collaboration among the team members associated with the project and among members of a larger organization.

In the field, there are different functions involved in the delivery of oilfield projects, and, yet, management of the aforementioned projects was accomplished separately. During certain ‘coordination events’, coordination of these projects was accomplished verbally through the use of periodic meetings. The meetings were not necessarily held real time. When any information was shared at these ‘coordination events’, the information was usually considered ‘out of date’ and, in addition, the different functions were operating on different time and schedule horizons.

It would be desirable to provide ‘timely’ access to information that is ‘relevant’ to an individual's job or role in the project. The word ‘timely’ means that the information should be available to the team members of a project within a time frame that will ‘materially affect’ the outcome of the activity which is already underway. Given the different ‘disciplines’ involved in typical oilfield or other projects, an ‘integrated’ project planning approach would be very helpful. However, ‘integrated’ project plans usually entail a much higher project management burden and can create an overload of information. This, in turn, can create a situation where the project must rely on an individual team member's capabilities and experience in order to discern any relevant information and, responsive thereto, to take necessary actions. In addition, validating the information and understanding the inter-dependencies in such ‘integrated environments’ is often very problematic. Given the above mentioned reliance on the individual team member's capabilities and experience, inconsistent results were produced which limited how project teams could be ‘scaled up’ to handle bigger and more complex projects, and limited the ability to increase efficiency, which is defined as the amount of time and cost necessary to successfully deliver a project.

### SUMMARY

One aspect of the present invention involves a method, practiced by a computer system, for planning and managing project plans associated with one or more projects in a business, the computer system including a processor that is responsive to input data, a recorder or display device, and a memory, the memory storing software, comprising: executing, by the processor, the software stored in the memory of the computer system in response to the input data including knowledge and experience data, and, in response to the executing step, generating one or more output displays adapted for planning and managing the project plans of the one or more projects in the business; recording or displaying, by the recorder or display device, the one or more output displays on the recorder or display device; wherein the one or more output displays being recorded or displayed on the recorder or display device include, Line-of-Sight (LOS) views of information pertaining to the business, the Line-of-Sight views providing a user with a view into the project plans of the one or more projects that is filtered based on the user's discipline or responsibility in the project and a level of detail that is appropriate to the user's role in the one or more projects.

A further aspect of the present invention involves a program storage device readable by a processor, tangibly embodying a set of instructions executable by the processor, to perform method steps, which are practiced by a computer system, for planning and managing project plans associated with one or more projects in a business in response to a set of input data including knowledge and experience data, the computer system including the processor, and a recorder or display device, the method steps comprising: in response to the execution, by the processor, of the set of instructions responsive to the input data, recording or displaying, by the recorder or display device, one or more output displays on the recorder or display device, the one or more output displays adapted for planning and managing the project plans of the one or more projects in the business, wherein the one or more output displays, that are adapted for planning and managing the project plans of the one or more projects in a business and are being recorded or displayed on the recorder or display device, include, Line-of-Sight (LOS) views of information pertaining to the business, the Line-of-Sight views providing a user with a view into the project plans of the one or more projects that is filtered based on a user's discipline or responsibility in the project and a level of detail that is appropriate to the user's role in the one or more projects.

A further aspect of the present invention resides in a computer system including a processor and a recorder or display device and a memory, a computer program stored in the memory and adapted to be executed by a processor, the computer program, when executed by the processor, conducting a process for planning and managing project plans associated with one or more projects in a business in response to input data including knowledge and experience data, the process comprising: recording or displaying, by the recorder or display device, one or more output displays adapted for planning and managing the project plans of the one or more projects in the business on the recorder of display device, wherein the output displays being recorded or displayed on the recorder or display device include, Line-of-Sight (LOS) views of information pertaining to the business, the Line-of-Sight views providing a user with a view into the project plans of the one or more projects that is filtered based on a user's discipline or responsibility in the project and a level of detail that is appropriate to the user's role in the one or more projects.

A further aspect of the present invention involves a computer system adapted for planning and managing project plans associated with one or more projects in a business, comprising: a memory storing a software; a processor adapted for executing the software stored in the memory in response to a set of input data including knowledge and experience data; and a recorder or display device, responsive to the execution by the processor of the software stored in the memory, adapted for recording or displaying one or more output displays, adapted for planning and managing the project plans of the one or more projects in the business, on the recorder or display device, wherein the one or more output displays include, Line-of-Sight (LOS) views of information pertaining to the business, the Line-of-Sight views providing a user with a view into the project plans of the one or more projects that is filtered based on the user's discipline or responsibility in the project and a level of detail that is appropriate to the user's role in the one or more projects.

A further aspect of the present invention involves a computer readable memory medium configured to store program instructions, wherein the program instructions are configured to direct one or more computers to perform operations for planning and managing project plans associated with one or more projects in a business, the one or more computers including a processor that is responsive to input data including knowledge and experience data, a recorder or display device, and the computer readable memory medium adapted for storing the program instructions, the operations comprising: executing, by the processor, the program instructions stored in the computer readable medium in response to the input data, and, in response to the executing step, recording or displaying one or more output displays adapted for planning and managing the project plans of the one or more projects in the business on the recorder or display device, wherein the one or more output displays include, Line-of-Sight (LOS) views of information pertaining to the business, the Line-of-Sight views providing a user with a view into the project plans of the one or more projects that is filtered based on the user's discipline or responsibility in the project and a level of detail that is appropriate to the user's role in the one or more projects.

A further aspect of the present invention involves a method for planning and managing project plans associated with one or more projects in a business, comprising: in response to a set of input data, generating views representing one or more output displays adapted for planning and managing the project plans of the one or more projects in the business; and recording or displaying the views representing one or more output displays on a recorder or display device, the views including Line-of-Sight (LOS) views of information pertaining to the business, the Line-of-Sight views providing a user with a view into the project plans of the one or more projects that is filtered based on the user's discipline or responsibility in the project and a level of detail that is appropriate to the user's role in the one or more projects.

A further aspect of the present invention involves a program storage device readable by a machine, tangibly embodying a set of instructions executable by the machine, to perform method steps for planning and managing project plans associated with one or more projects in a business, the method steps comprising: in response to a set of input data, generating views representing one or more output displays adapted for planning and managing the project plans of the one or more projects in the business; and recording or displaying the views representing one or more output displays on a recorder or display device, the views including Line-of-Sight (LOS) views of information pertaining to the business, the Line-of-Sight views providing a user with a view into the project plans of the one or more projects that is filtered based on the user's discipline or responsibility in the project and a level of detail that is appropriate to the user's role in the one or more projects.

Further scope of applicability will become apparent from the detailed description presented hereinafter. It should be understood, however, that the detailed description and the specific examples set forth below are given by way of illustration only, since various changes and modifications within the spirit and scope of the ‘Project Management System Software’, as described and claimed in this specification, will become obvious to one skilled in the art from a reading of the following detailed description.

### BRIEF DESCRIPTION OF THE DRAWINGS

A full understanding will be obtained from the detailed description presented hereinbelow, and the accompanying drawings which are given by way of illustration only and are not intended to be limitative to any extent, and wherein:

FIG. 1 illustrates an example of an oilfield that may be developed using the project management system software disclosed in this specification;

FIG. 2 illustrates a portion of a wellbore operation, such as the wellbore operation shown in FIG. 1;

FIGS. 3 and 4 illustrate the ‘Project Management System (PMS)’ disclosed in this specification, wherein:

FIG. 3 illustrates an exemplary oilfield development ‘Project Management System’ disclosed in this specification, and

FIG. 4 illustrates an exemplary oilfield development project management server which stores the ‘Project Management System software’ that is disclosed in this specification;

FIG. 5 illustrates an exemplary oilfield development project planning tool;

FIGS. 6A through 34B illustrate a set of screenshots which are generated by the I/O device (e.g., a recorder or display device) of the project management server of FIG. 4 when the processor of the server executes the ‘Project Management System software’ that is stored in the server of FIG. 4, wherein:

FIGS. 6A through 13D illustrate Line of Sight (LOS) views of information and project status;

FIGS. 14A and 14B illustrate views of ad-hoc projects;

FIGS. 15A, 15B, 15C, 15D, and 16A and 16B illustrate a lessons learned view linked to an overall project context and other information;

FIGS. 17A, 17B, 17C, 17D, and 18A, 18B, 18C, and 18D illustrate a project risk register illustrating data to classify and report the project;

FIGS. 19A, 19B, 19C, and 19D illustrate a general project earned value graph;

FIGS. 20 through 24 illustrate project operational earned value, wherein FIGS. 21-23 illustrate Line of Sight visibility for earned value;

FIGS. 25A, 25B, 25C, and 25D illustrate a line of sight based data update view, namely, LOS filtered data entry/project statusing;

FIGS. 26A, 26B and 27A and 27B illustrate how Line of Sight (LOS) is used in resource utilization and management views;

FIGS. 28A through 28H, and 29A through 29F illustrate an operations portfolio view of multiple projects;

FIGS. 30A, 30B, 30C, and 30D illustrates another typical project dashboard;

FIGS. 31A through 31D, and 32A through 32D illustrate the summary of trainee information for a particular project;

FIGS. 33A through 33B, and 34A through 34B illustrate trainee tracking views in the ‘Project Management System’ disclosed in this specification;

FIG. 35 shows a diagram which illustrates ‘one dimension’ of the ‘Line-of-Sight (LOS)’ approach; that is, of viewing information at the level of details appropriate to one's role (however, the ‘other dimension’ would be the filtering of the information based on the discipline of the viewer);

FIGS. 36 and 37 illustrate various aspects associated with the construction of the ‘Project Management System software’ 412 of FIG. 4, wherein FIG. 36 represents plan generation (also illustrated in FIG. 39) and FIG. 37 representing data flow; and

FIGS. 38 through 43E illustrate a ‘detailed construction’ of the ‘Project Management System software’ 412 of FIG. 4, wherein:

FIG. 38 illustrates an ‘overall system workflow’ of the ‘Project Management System software’ 412 of FIG. 4;

FIGS. 39 and 40 illustrates a more detailed construction of the ‘system initialization’ step of the ‘overall system workflow’ of FIG. 38;

FIG. 41 illustrates a more detailed construction of the ‘status/update integrated plan’ step of the ‘overall system workflow’ of FIG. 38;

FIG. 42 illustrates a more detailed construction of the ‘update & maintain auxiliary content’ step of the ‘overall system workflow’ of FIG. 38; and

FIGS. 43A through 43E collectively illustrate a ‘full workflow’ and a ‘detailed construction’ of the ‘Project Management System software’ 412 of FIG. 4 where the ‘full workflow’ illustrated in FIGS. 43A through 43E includes the constructions illustrated in FIGS. 39, 40, 41, and 42.

### DESCRIPTION

This specification, and its accompanying drawings, discloses a ‘Project Management System (PMS)’ that is adapted for Planning and Managing Projects.

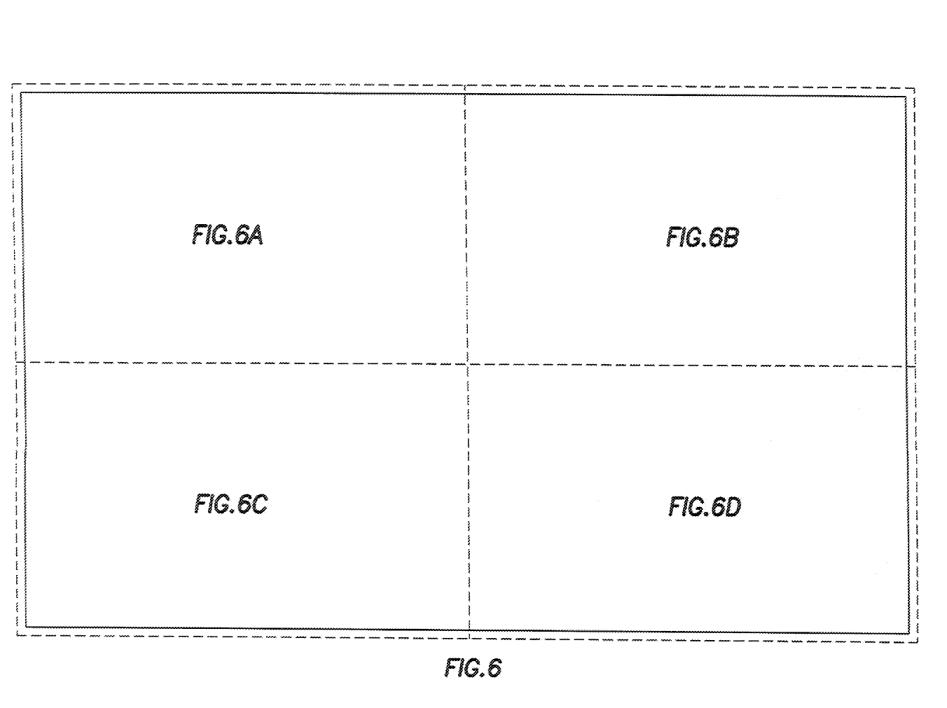

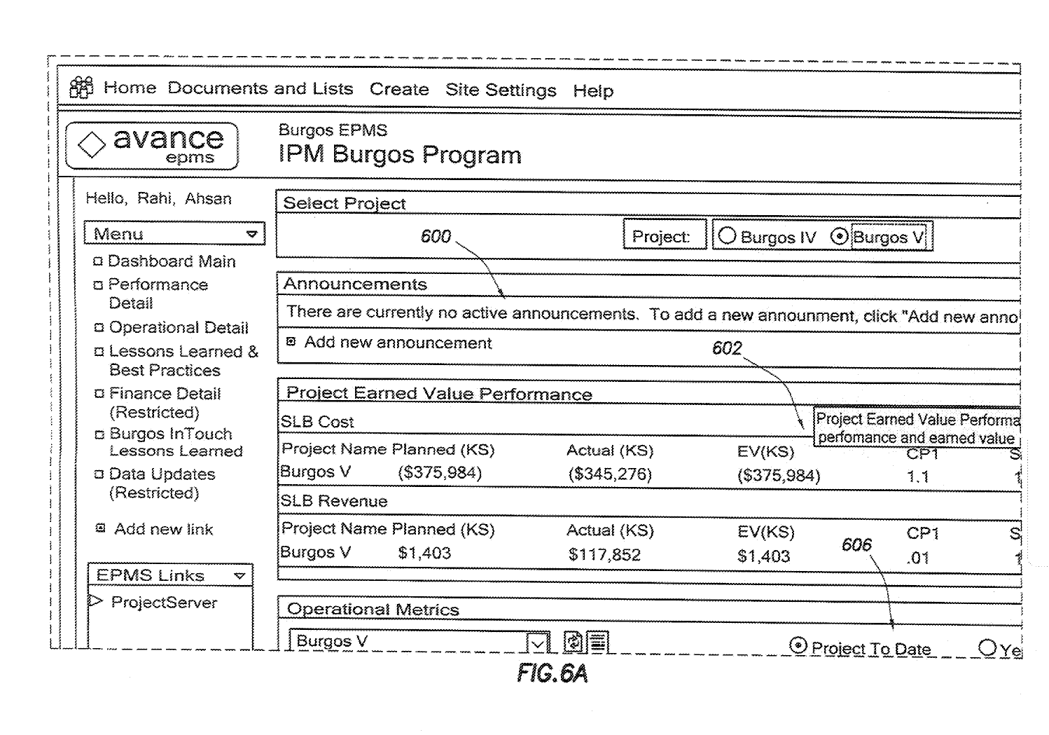

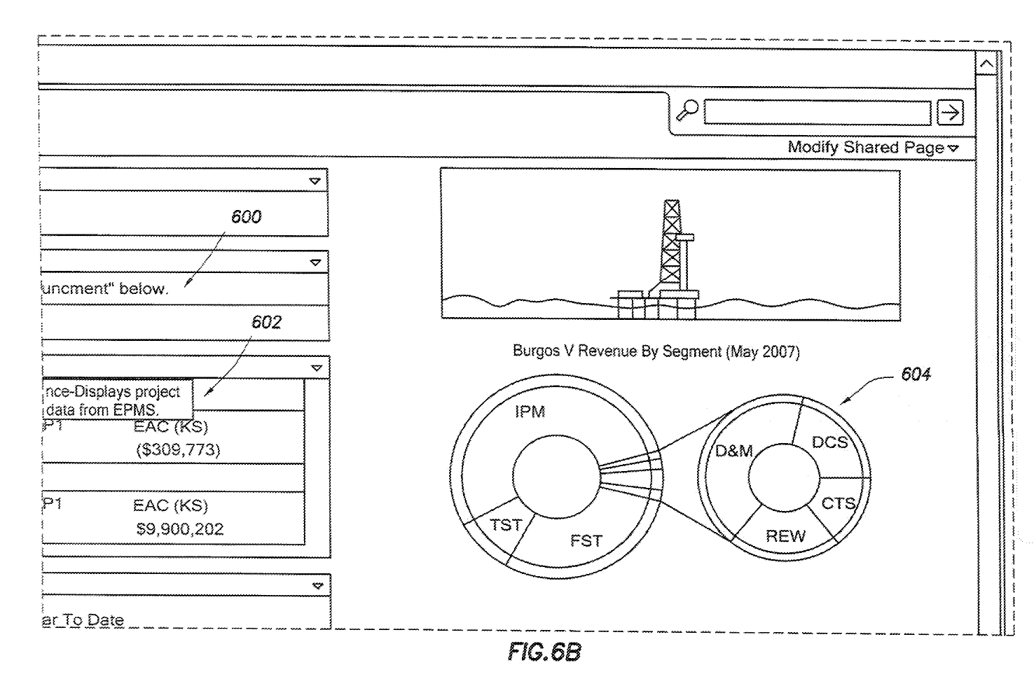

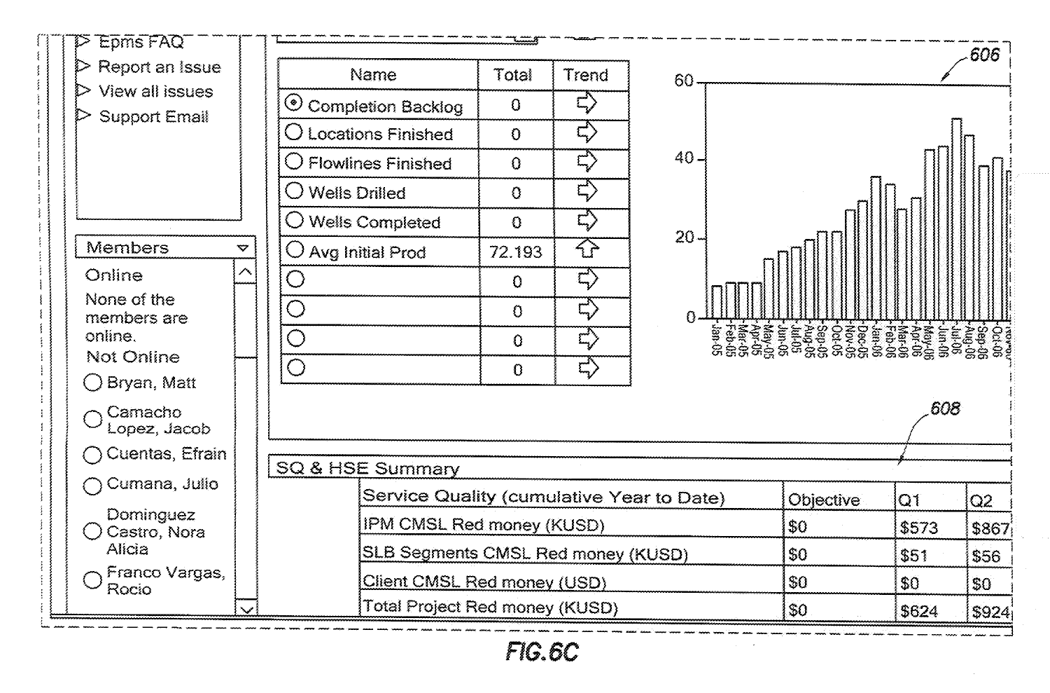

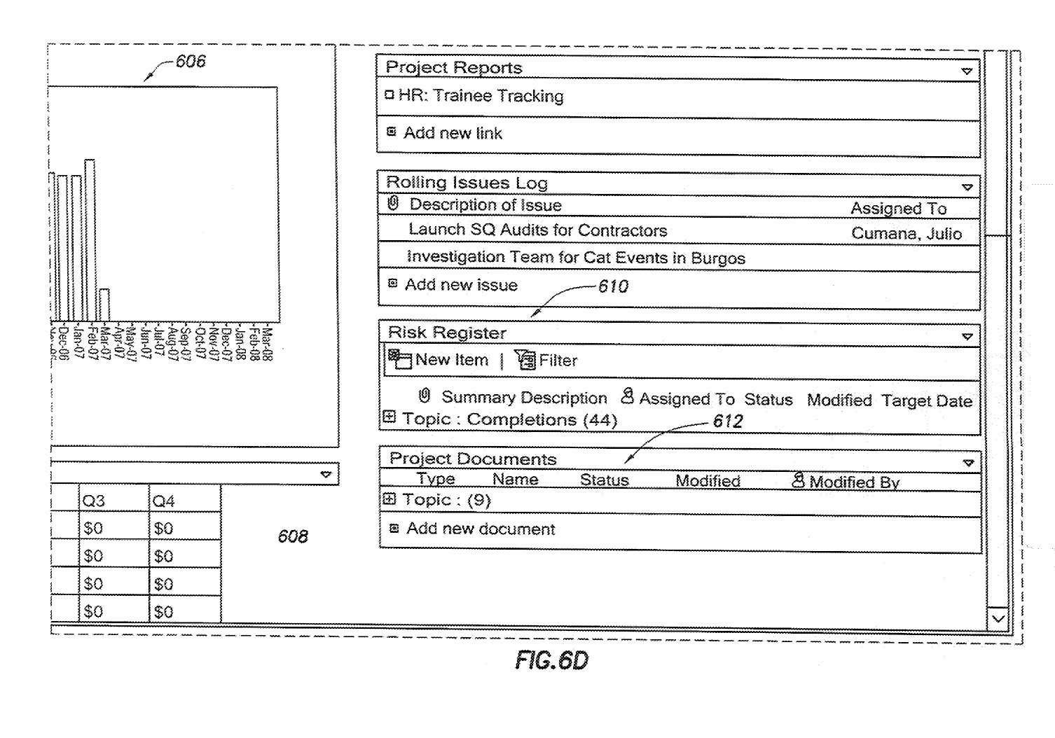

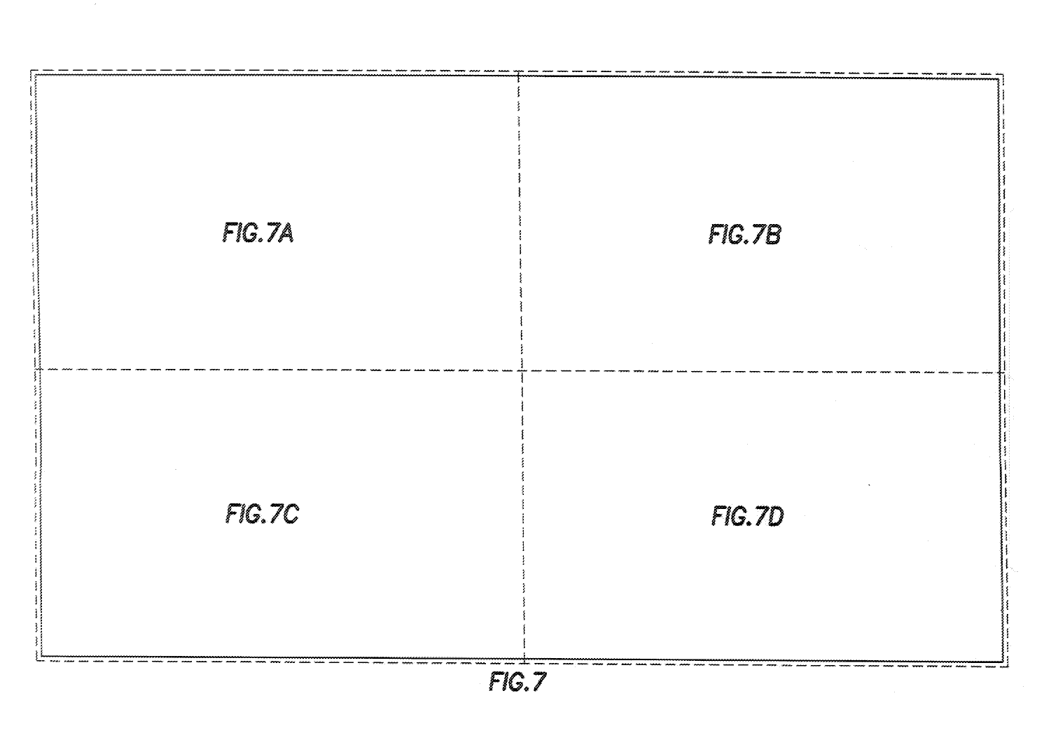

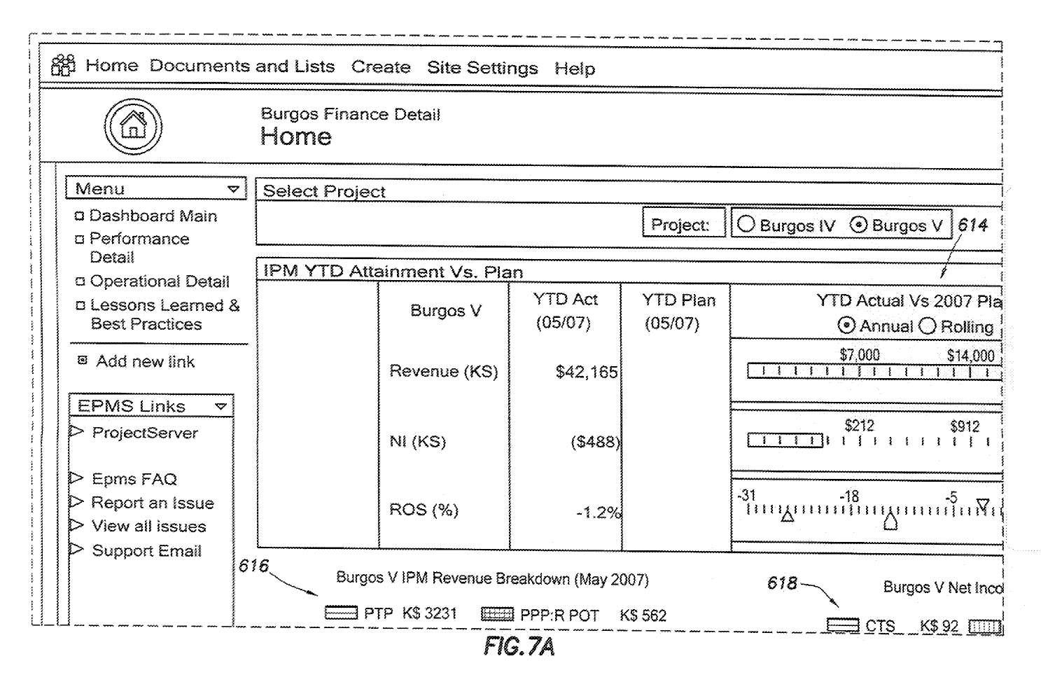

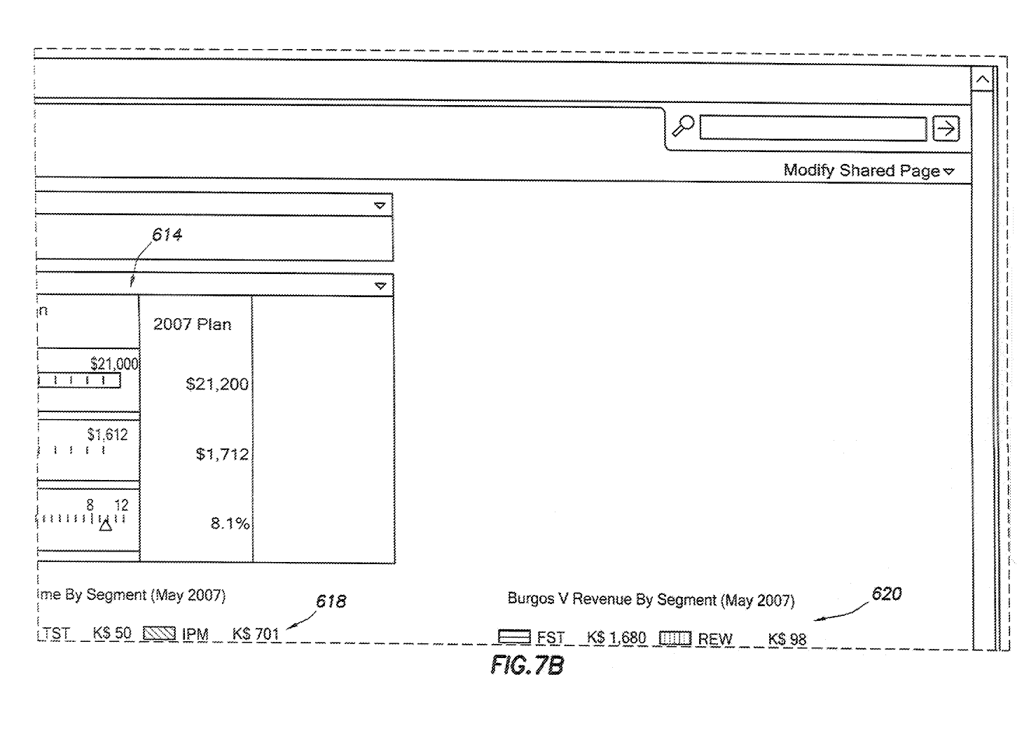

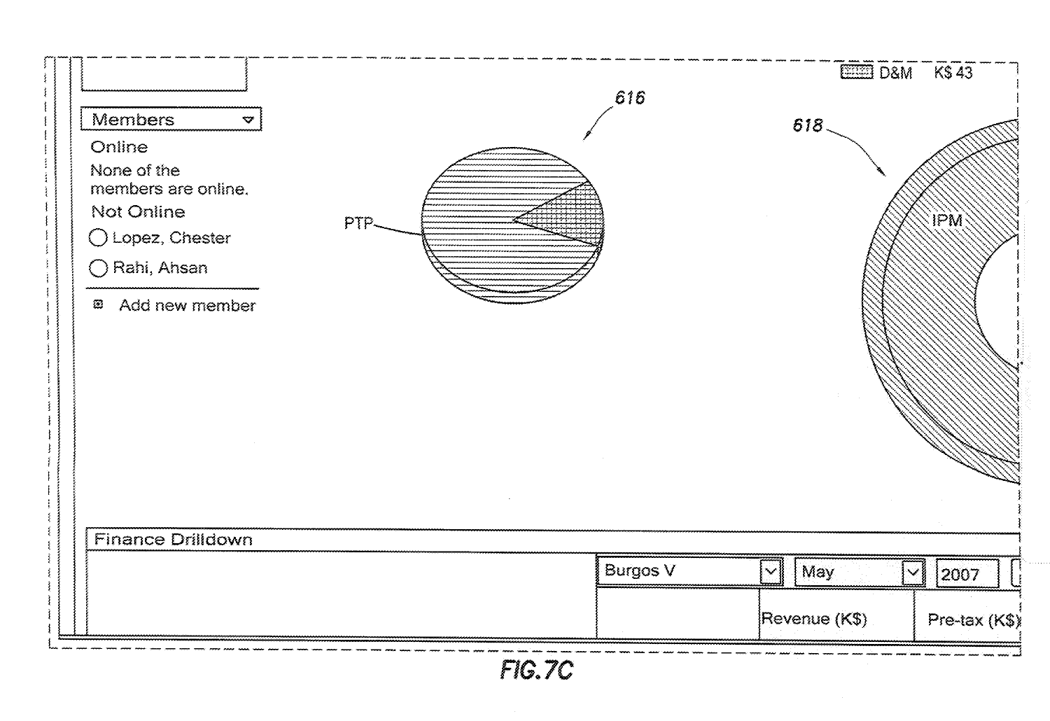

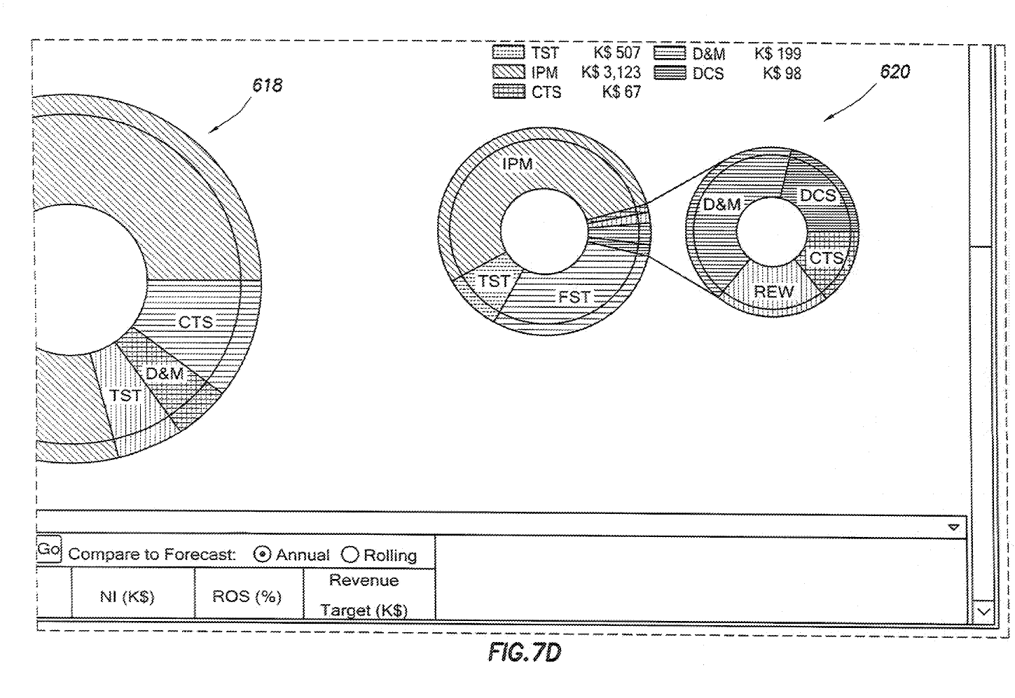

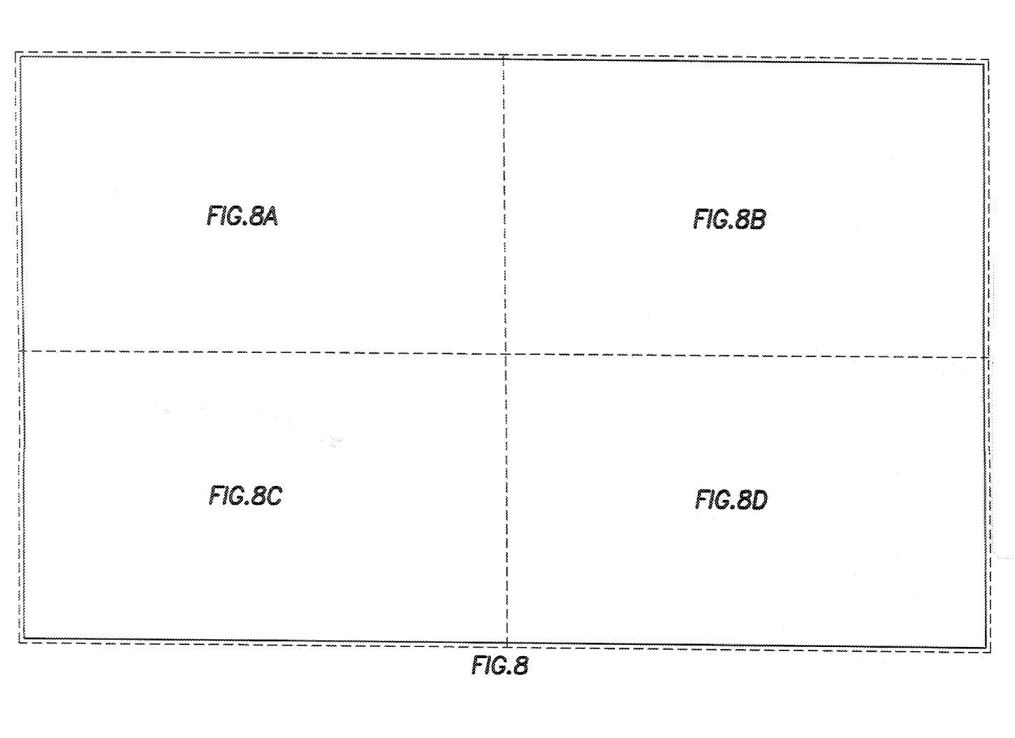

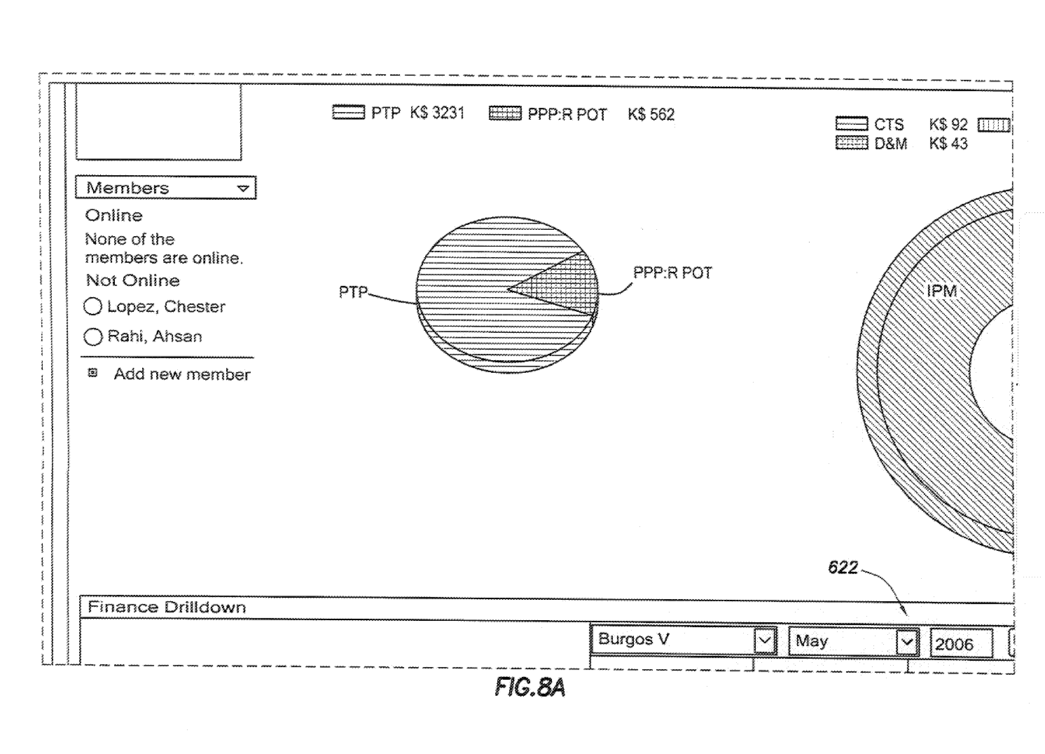

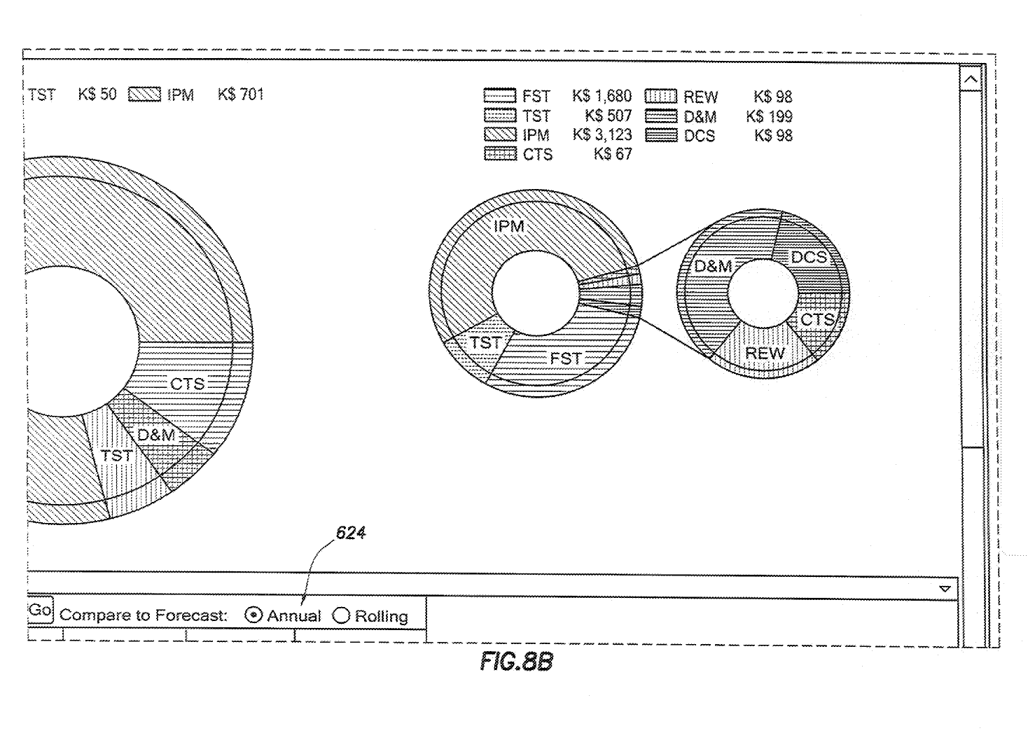

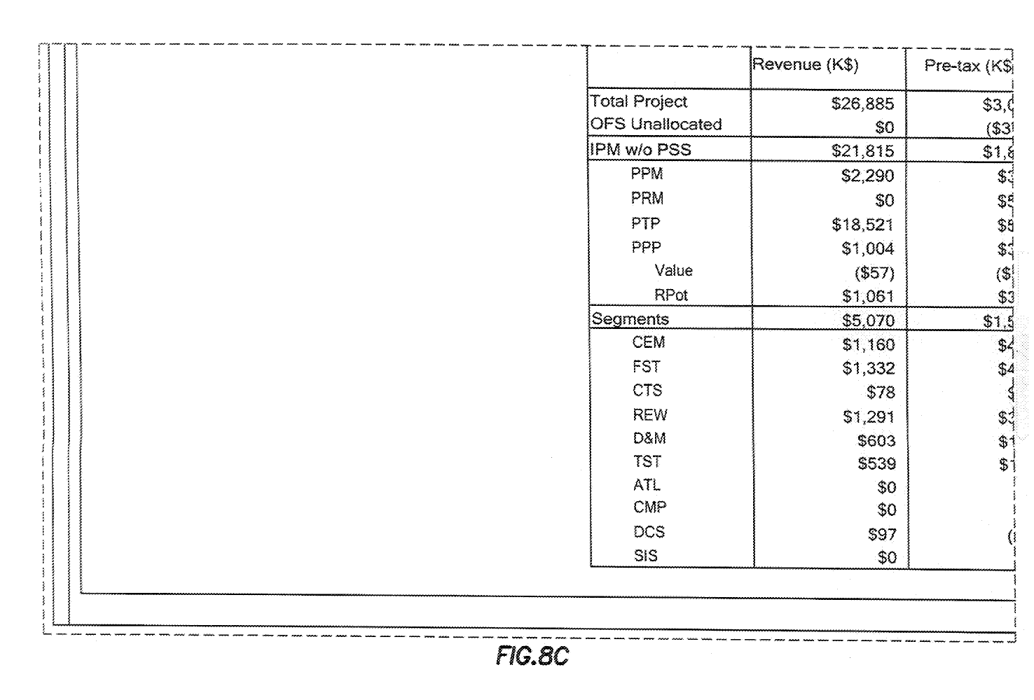

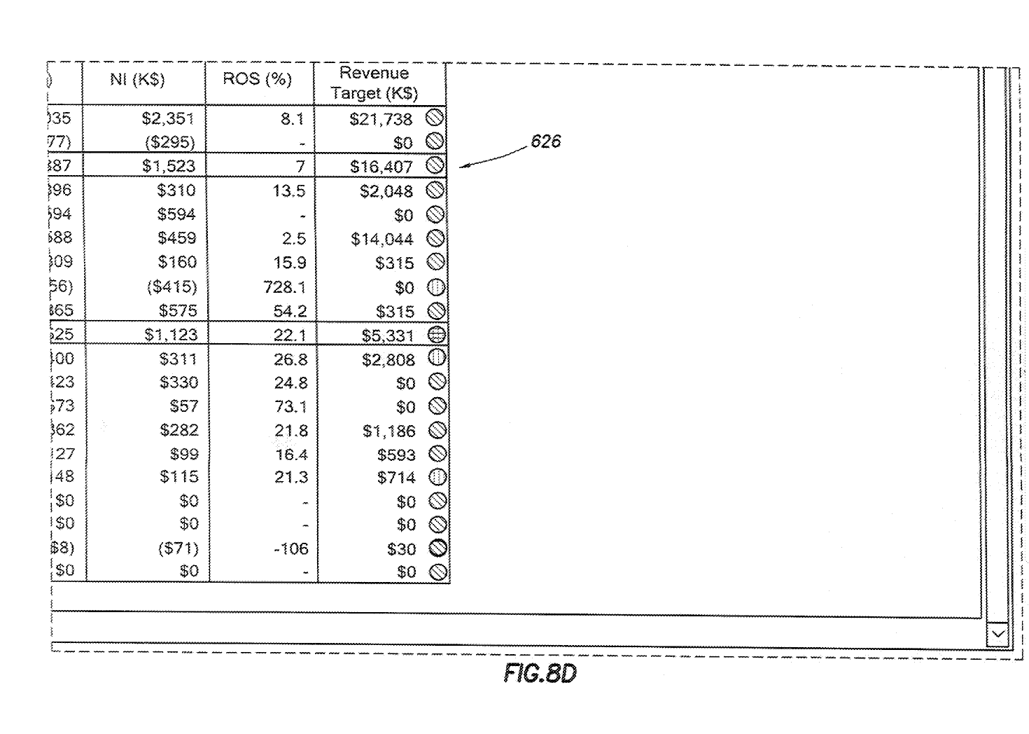

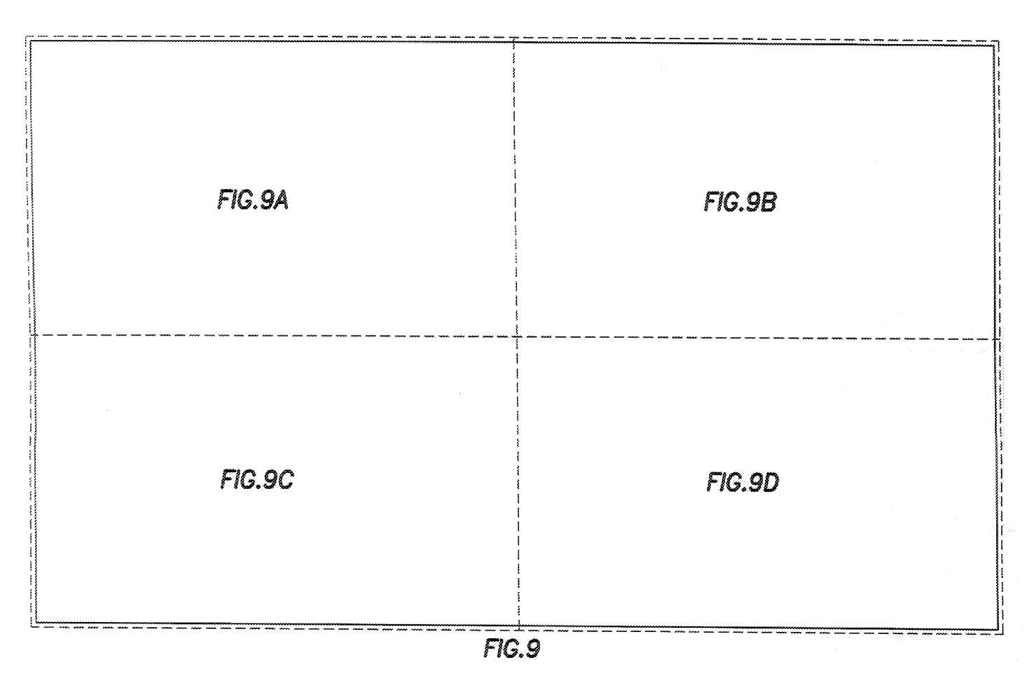

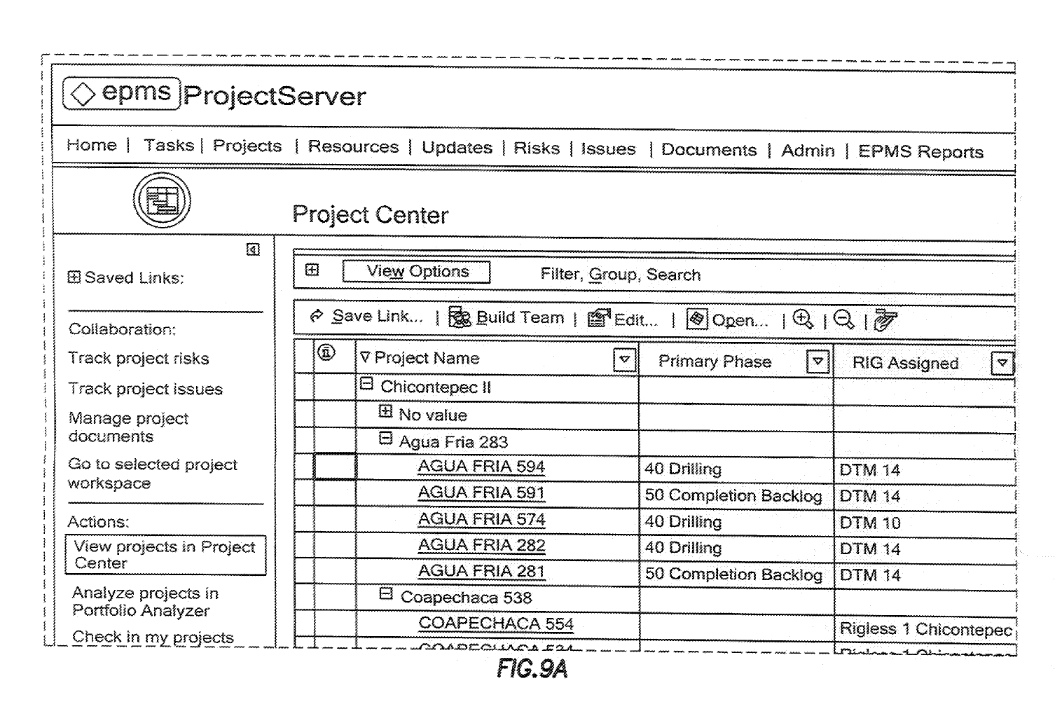

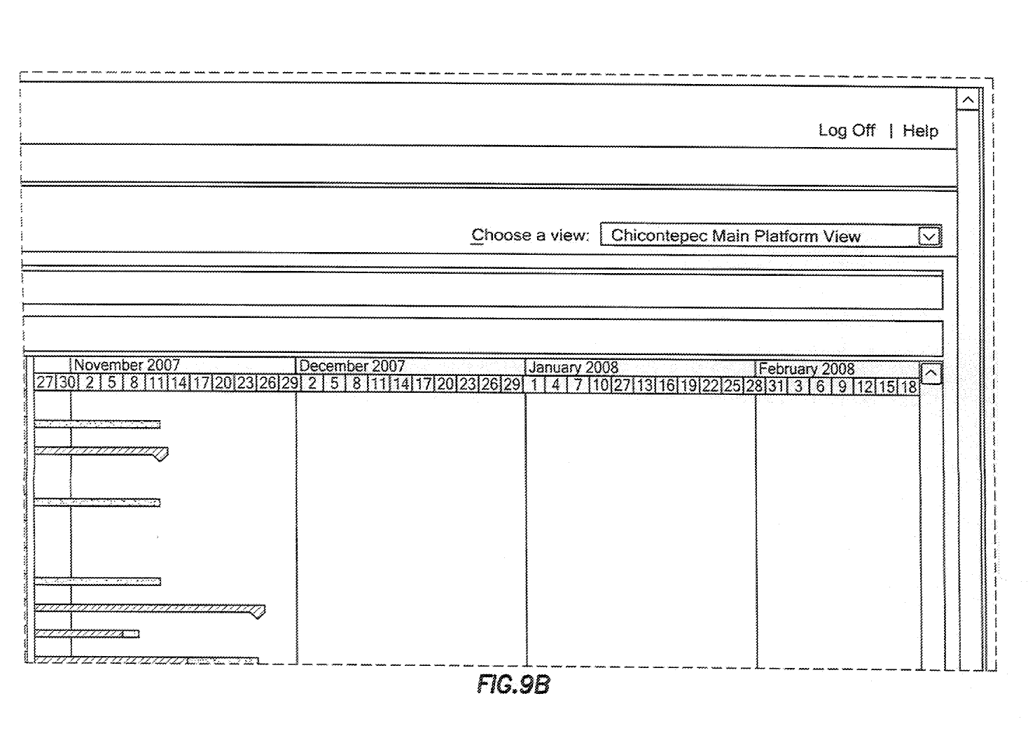

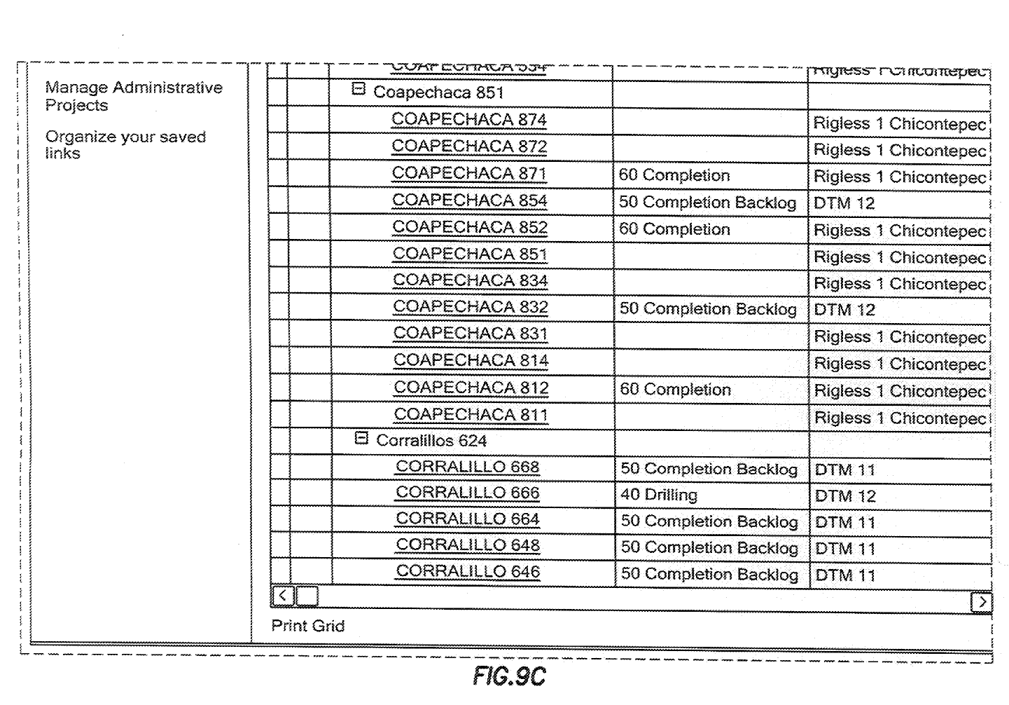

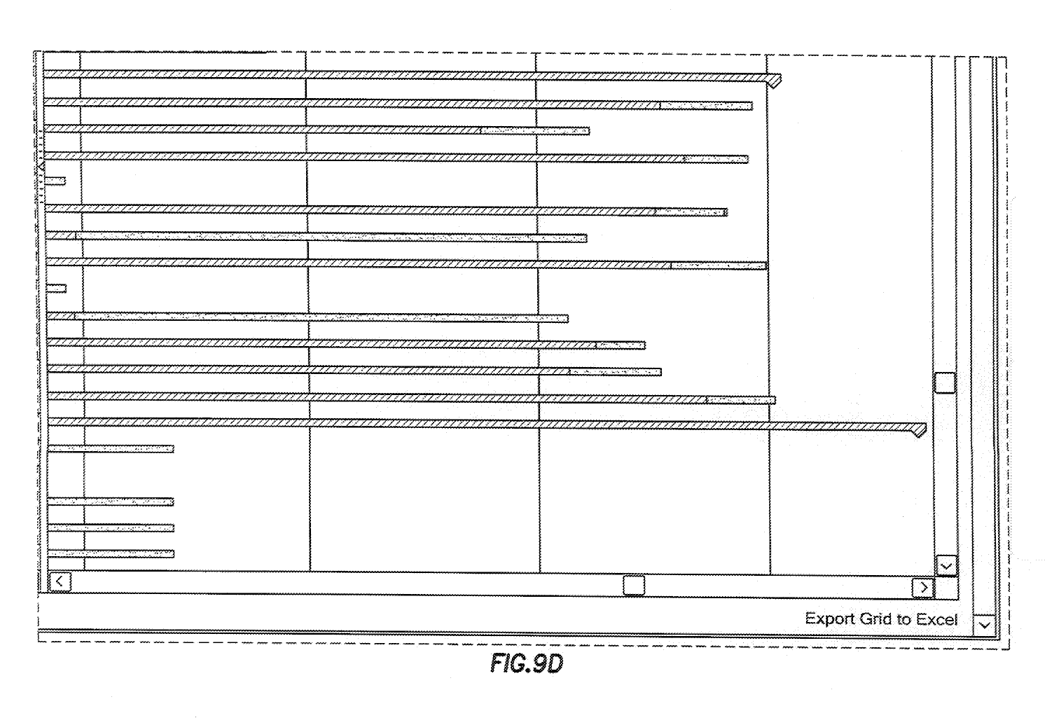

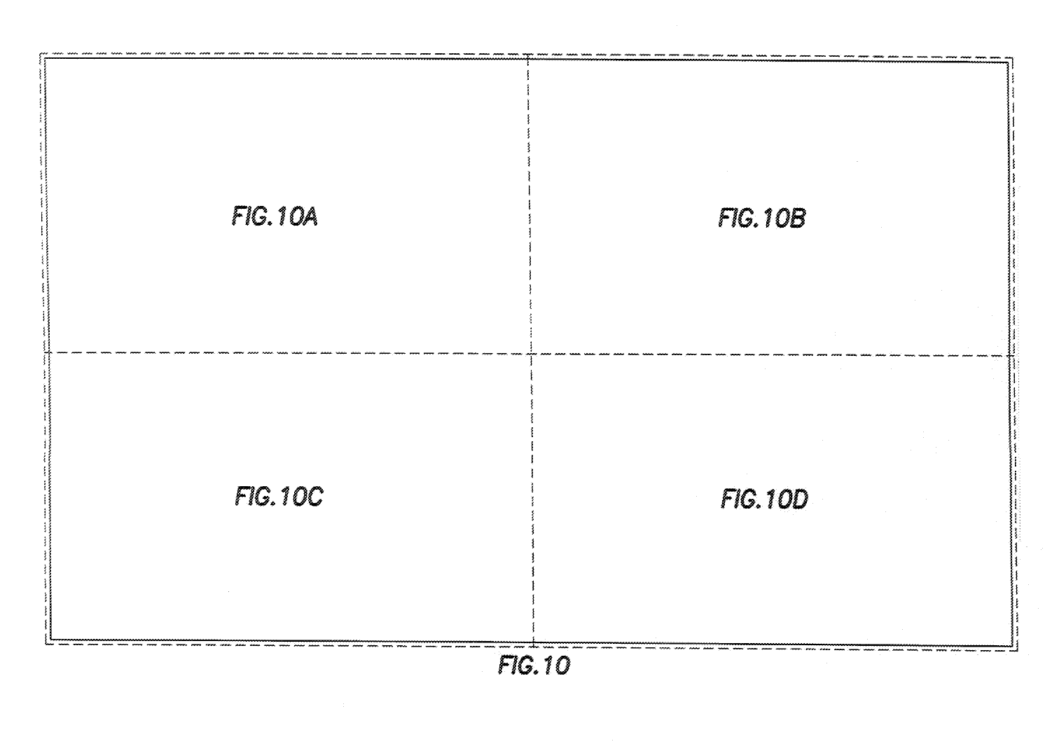

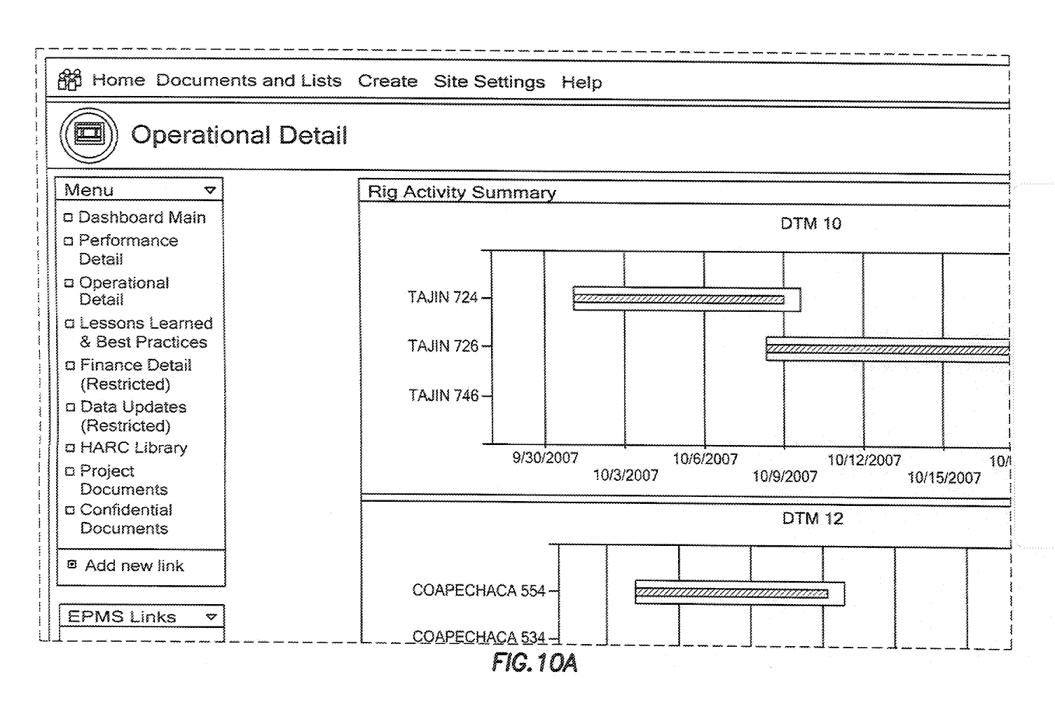

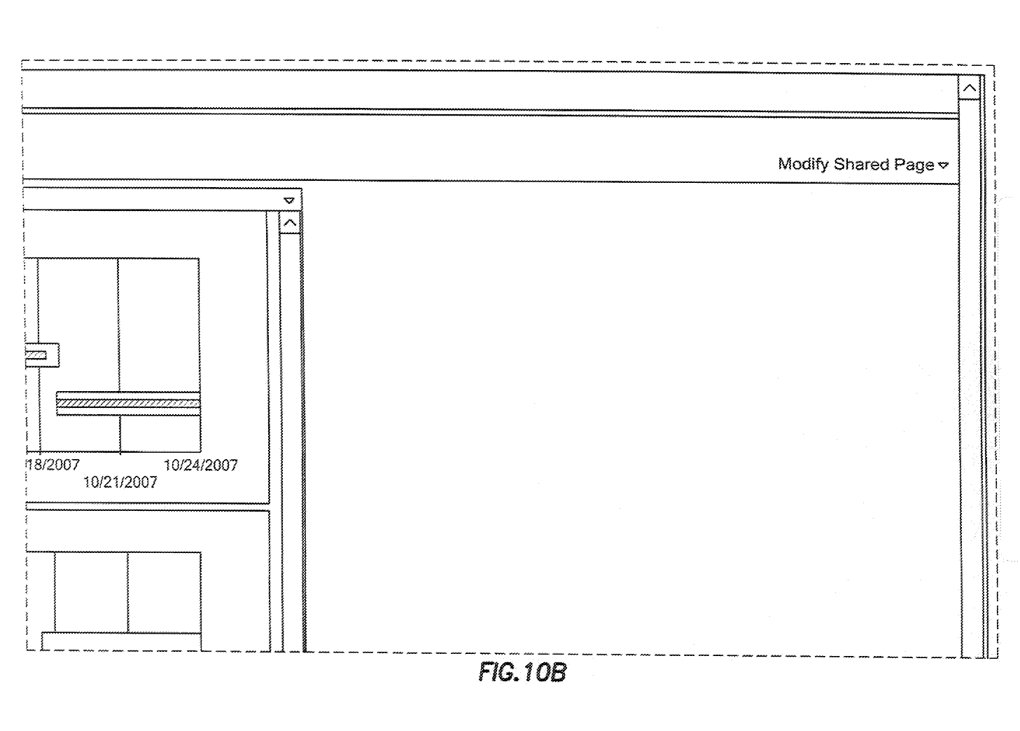

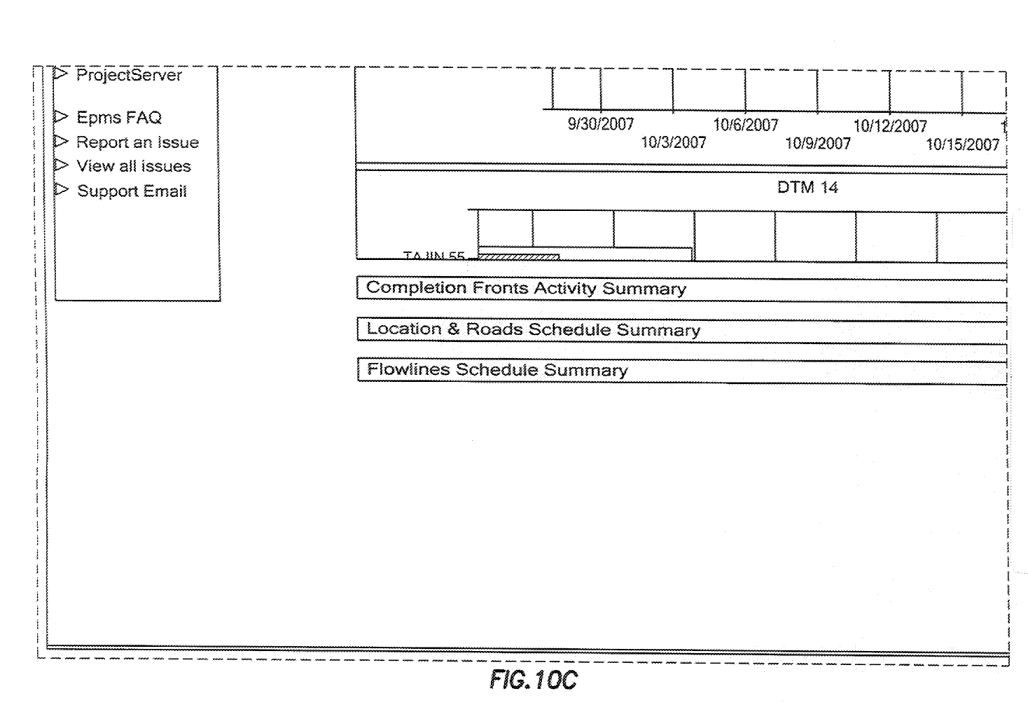

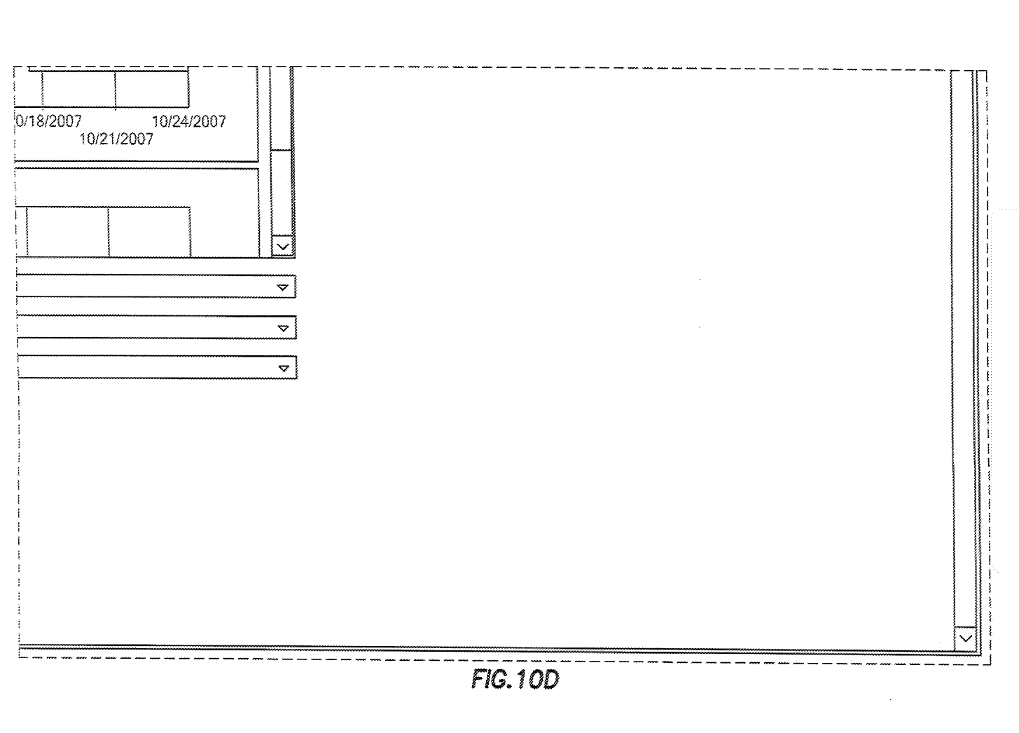

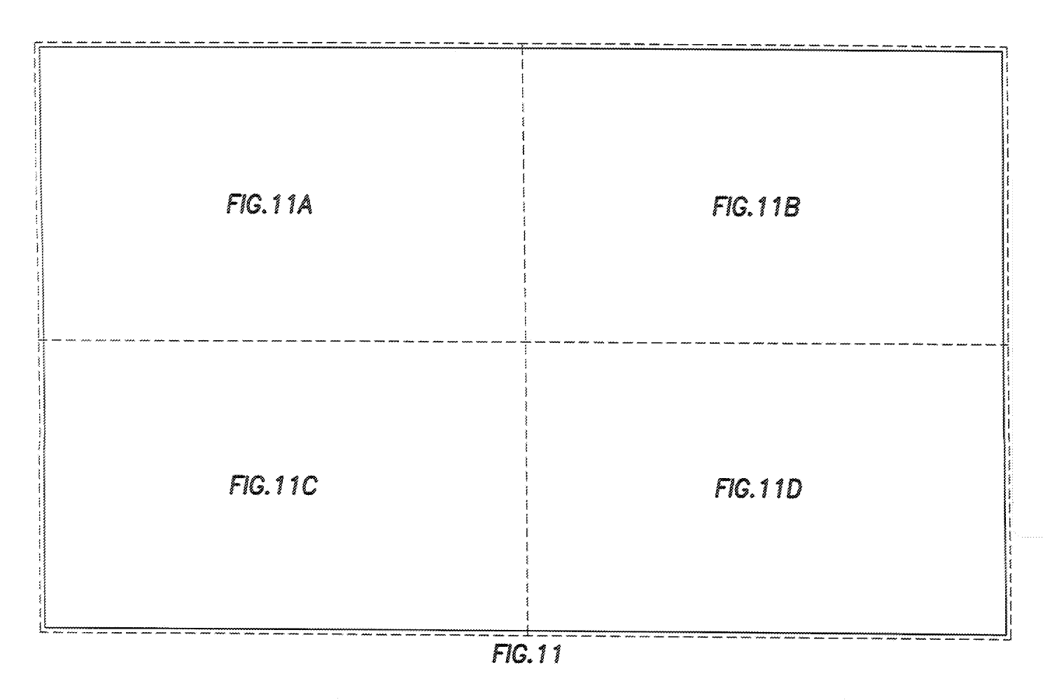

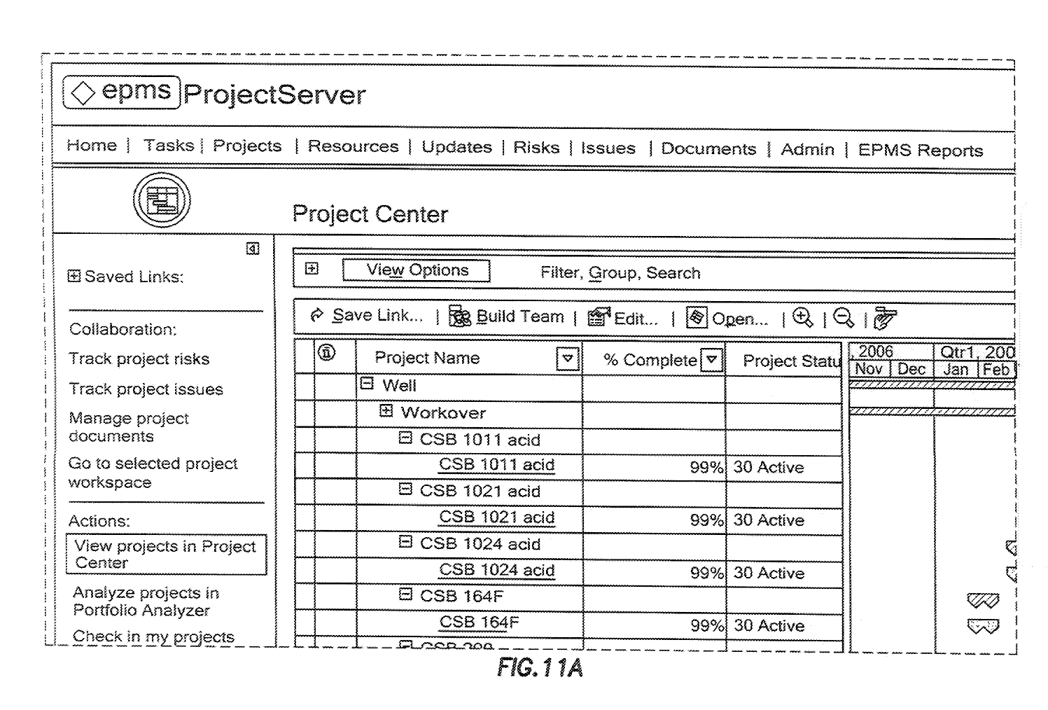

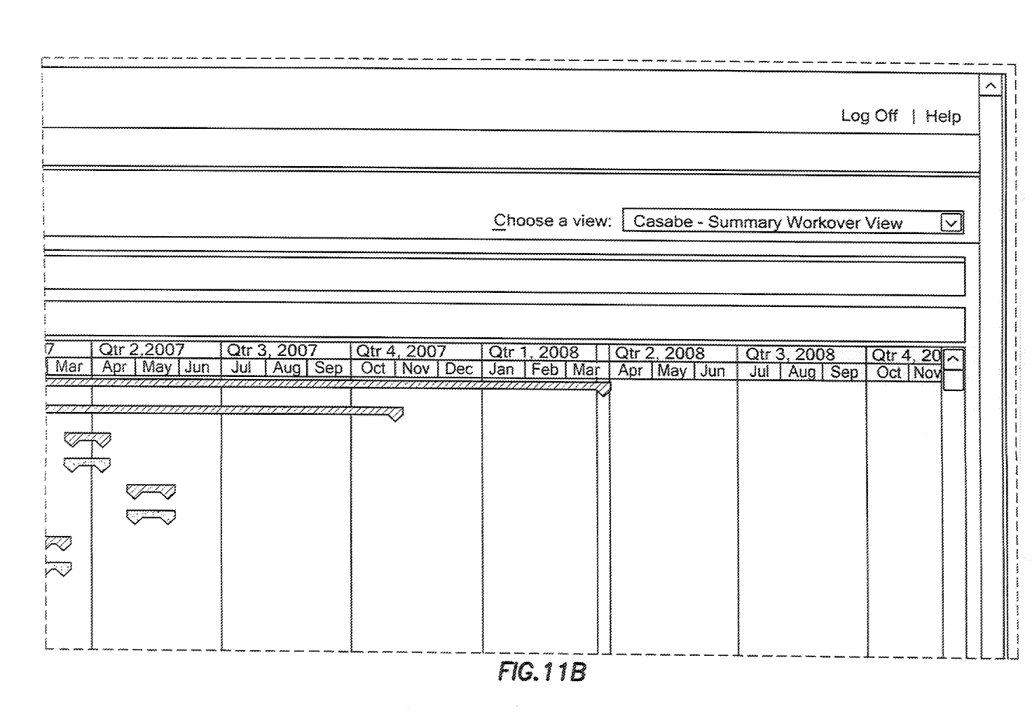

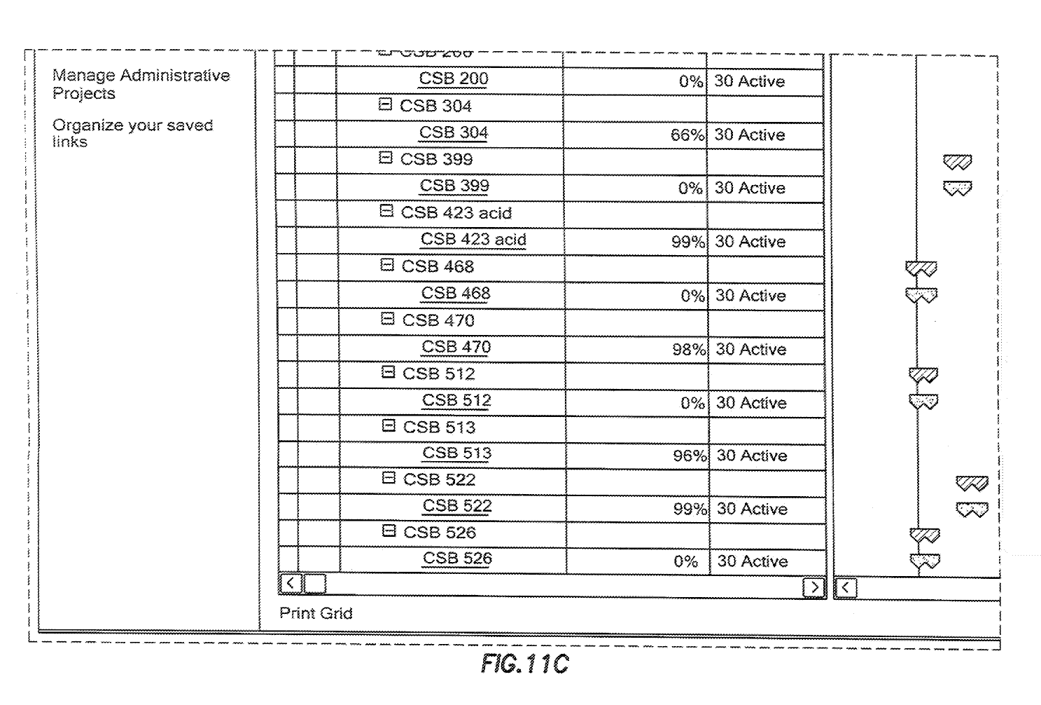

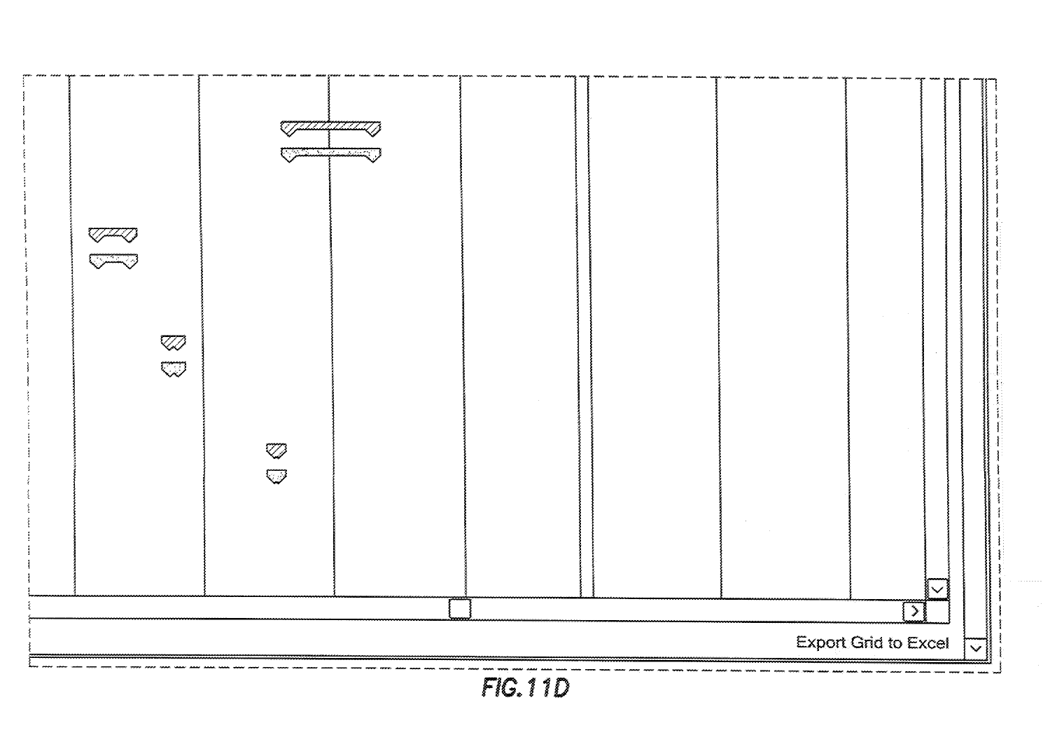

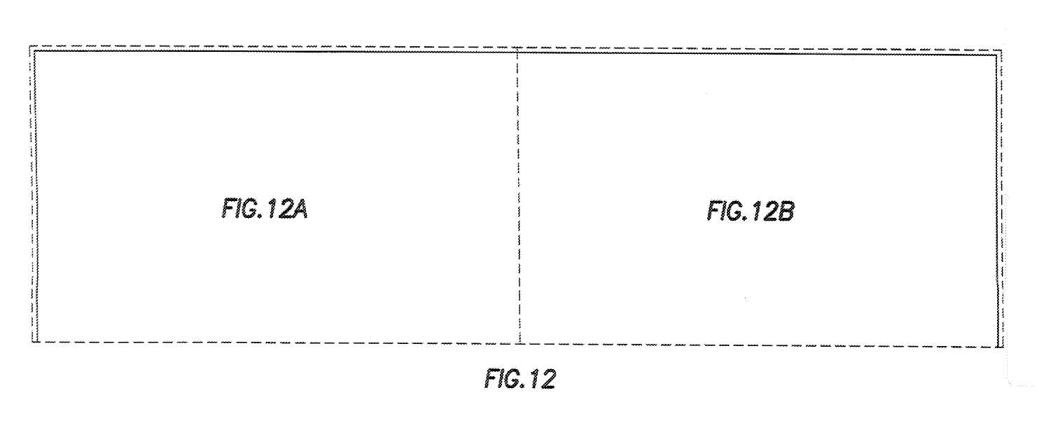

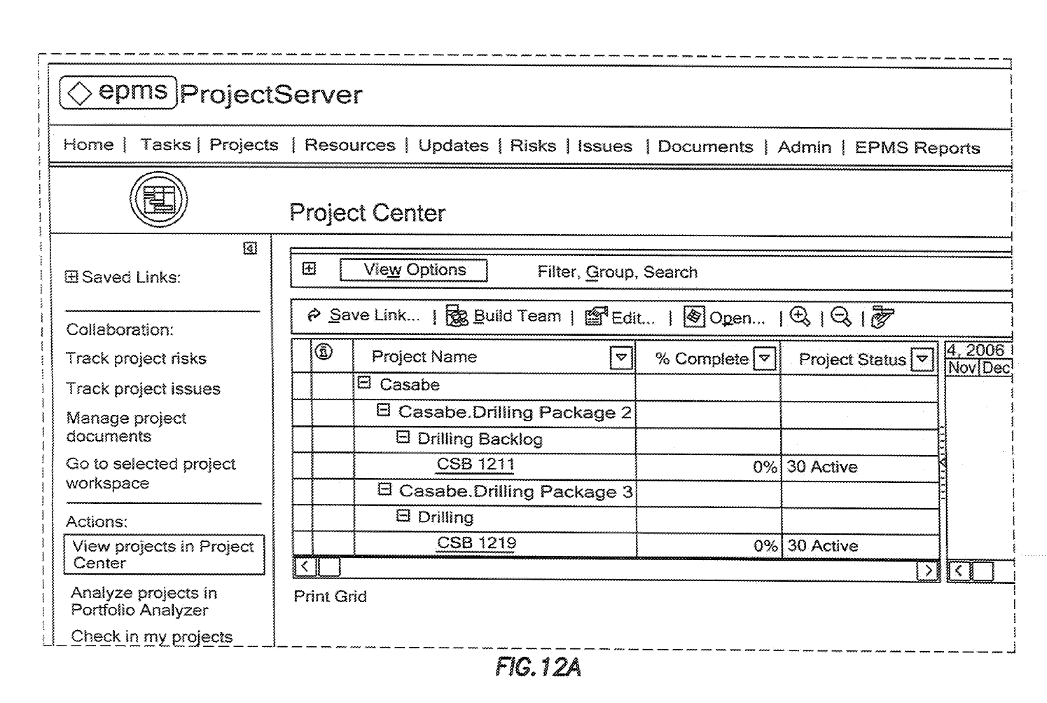

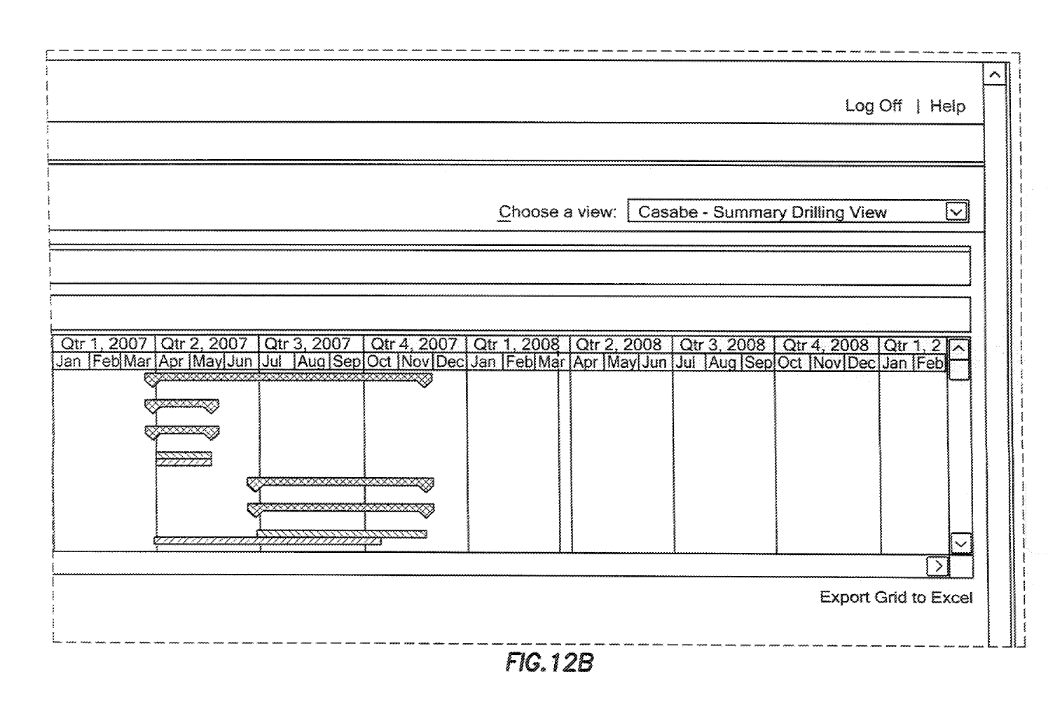

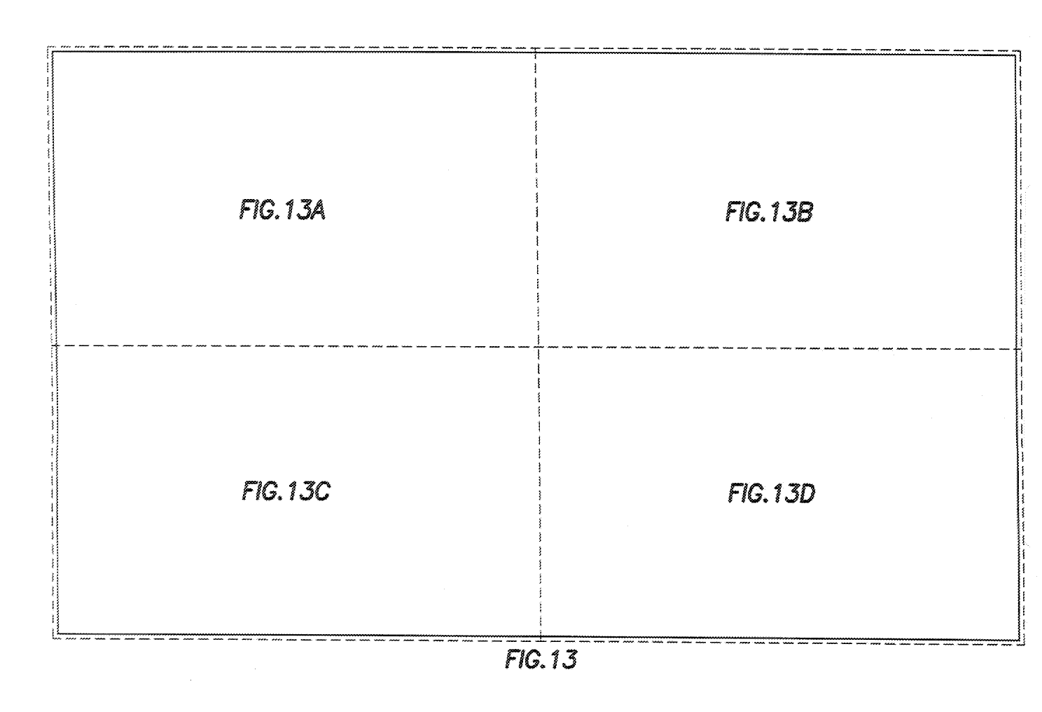

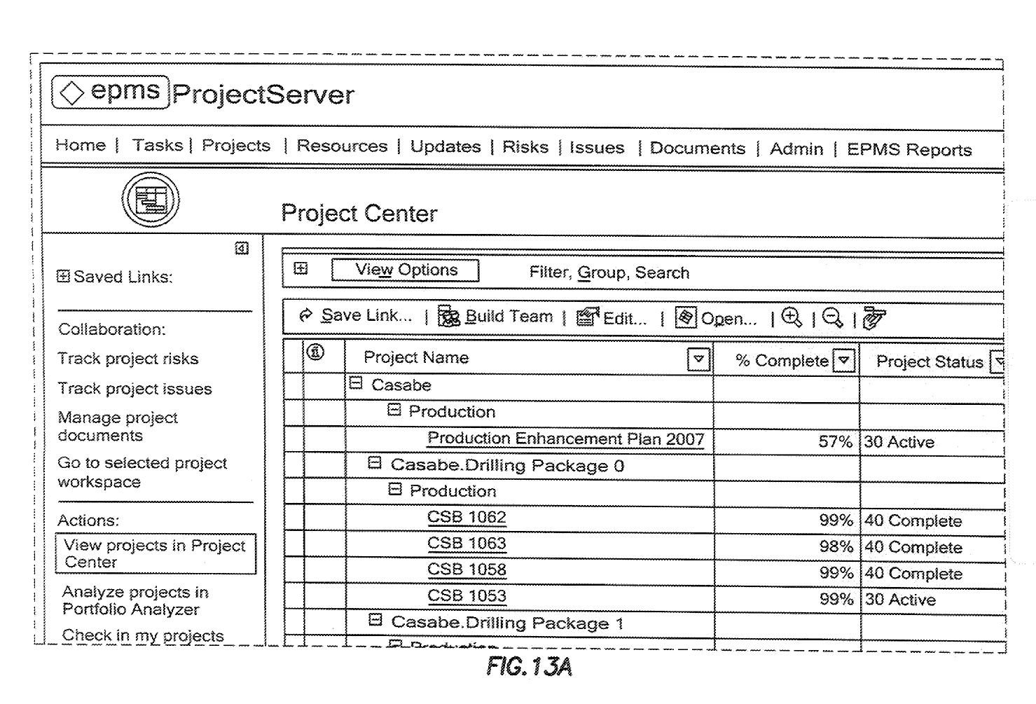

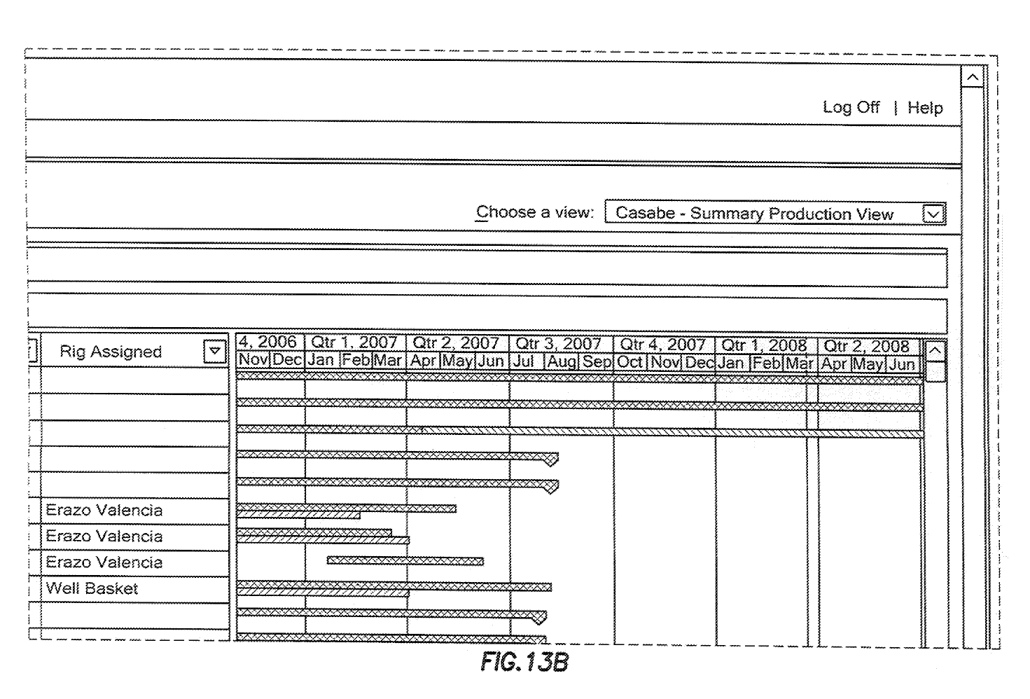

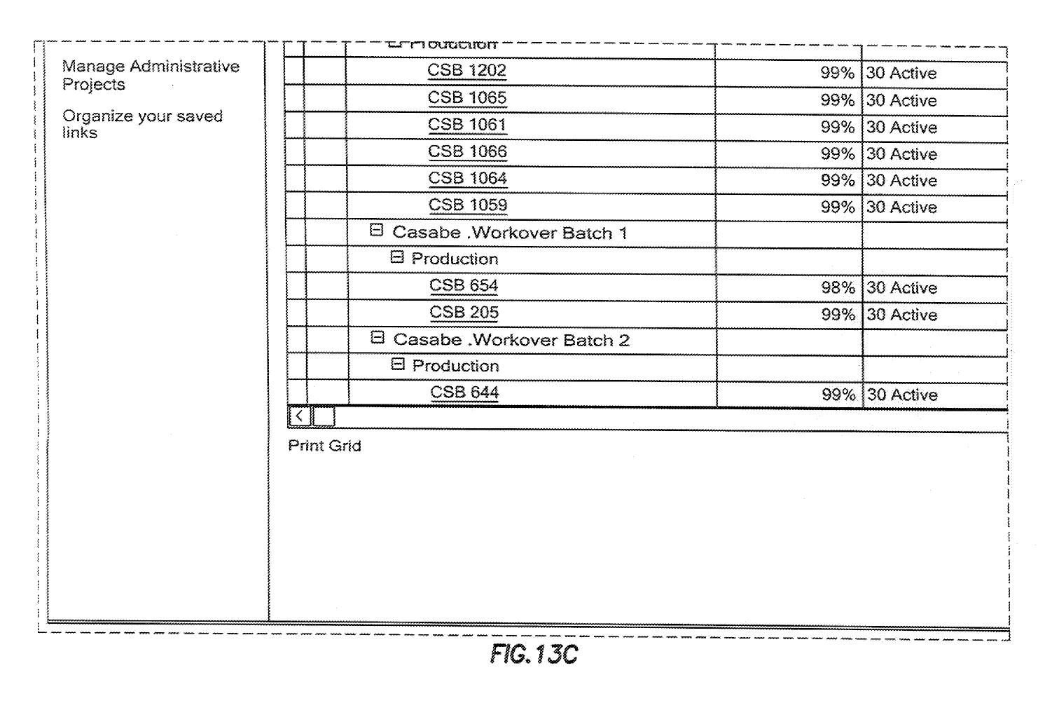

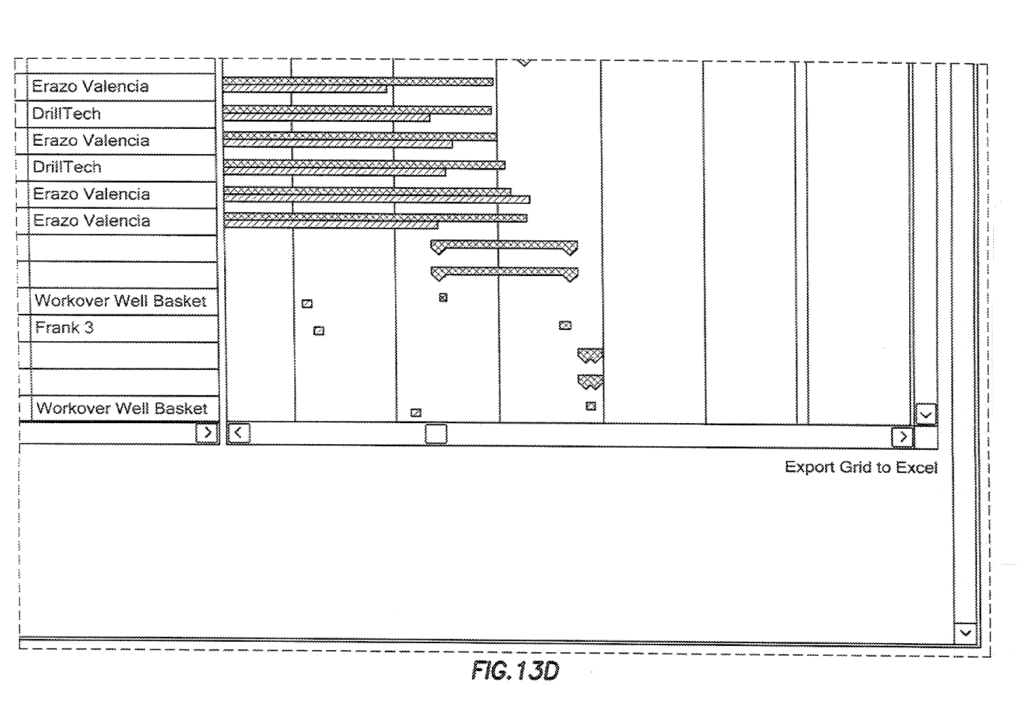

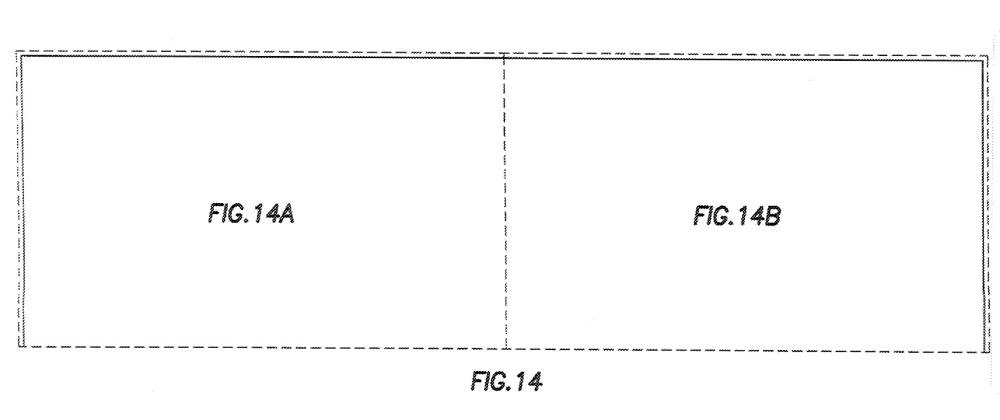

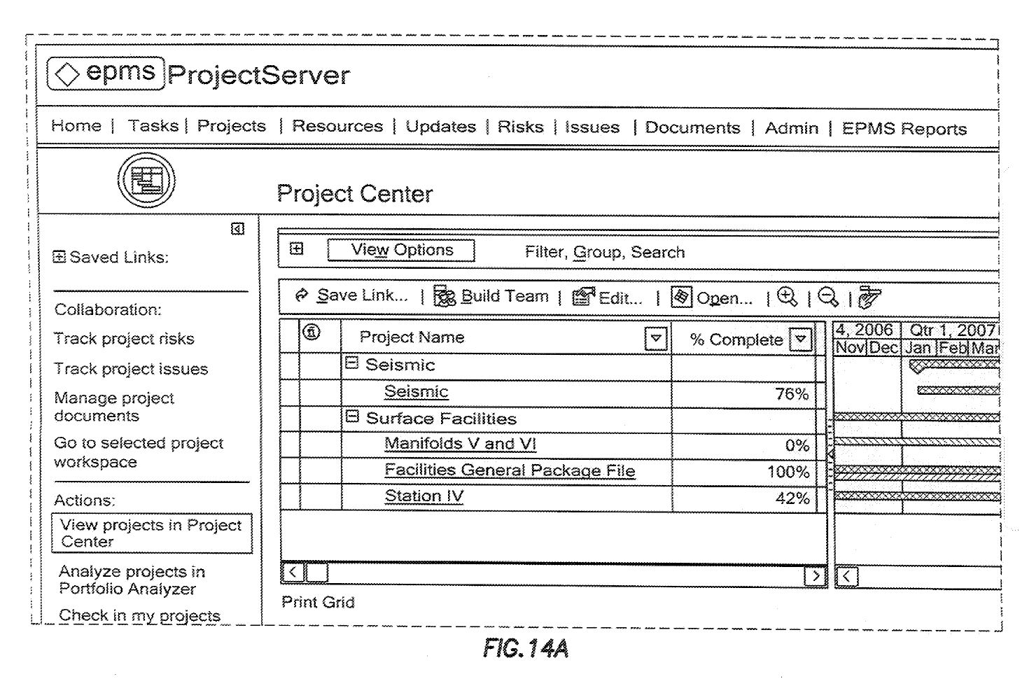

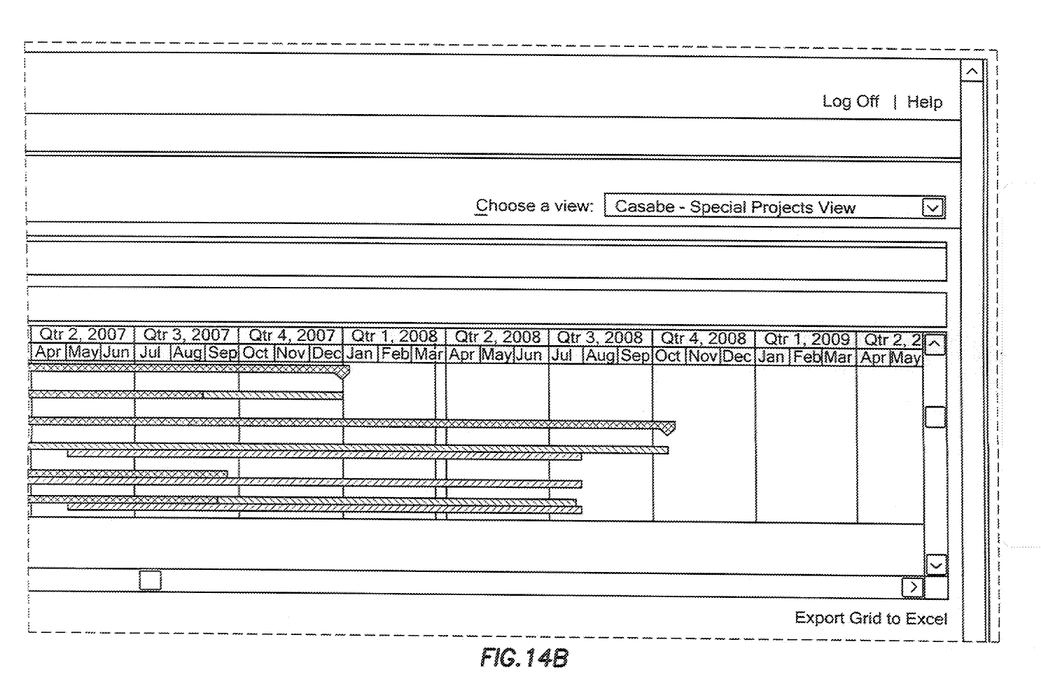

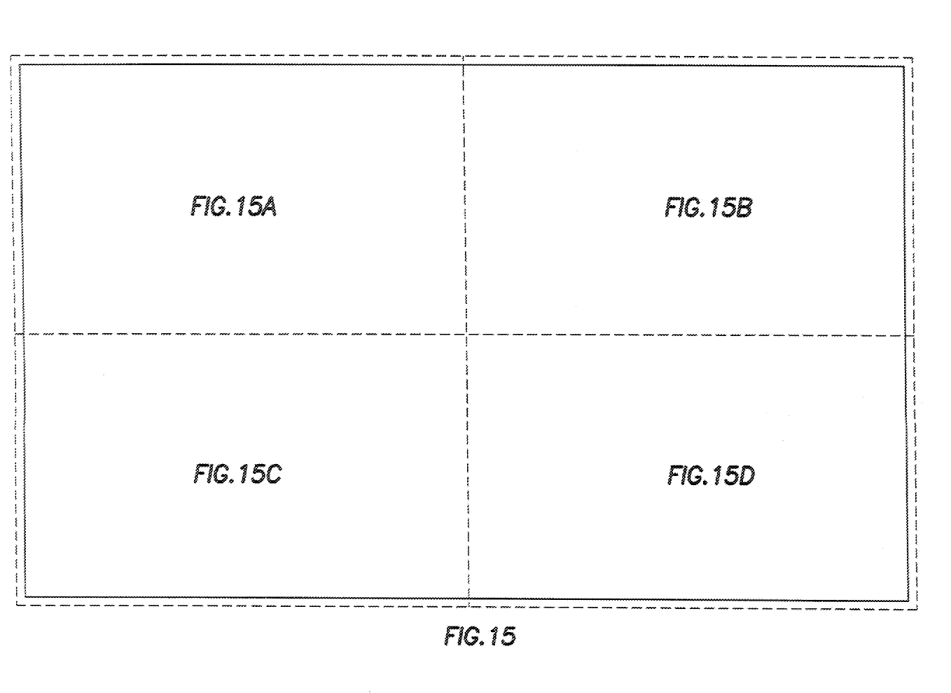

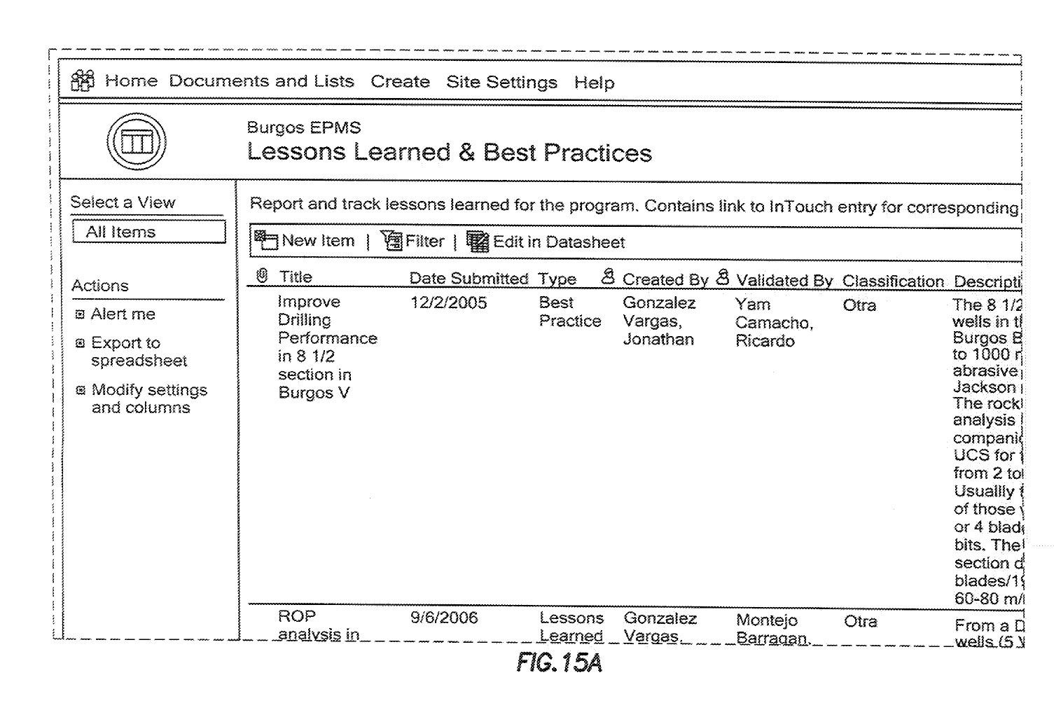

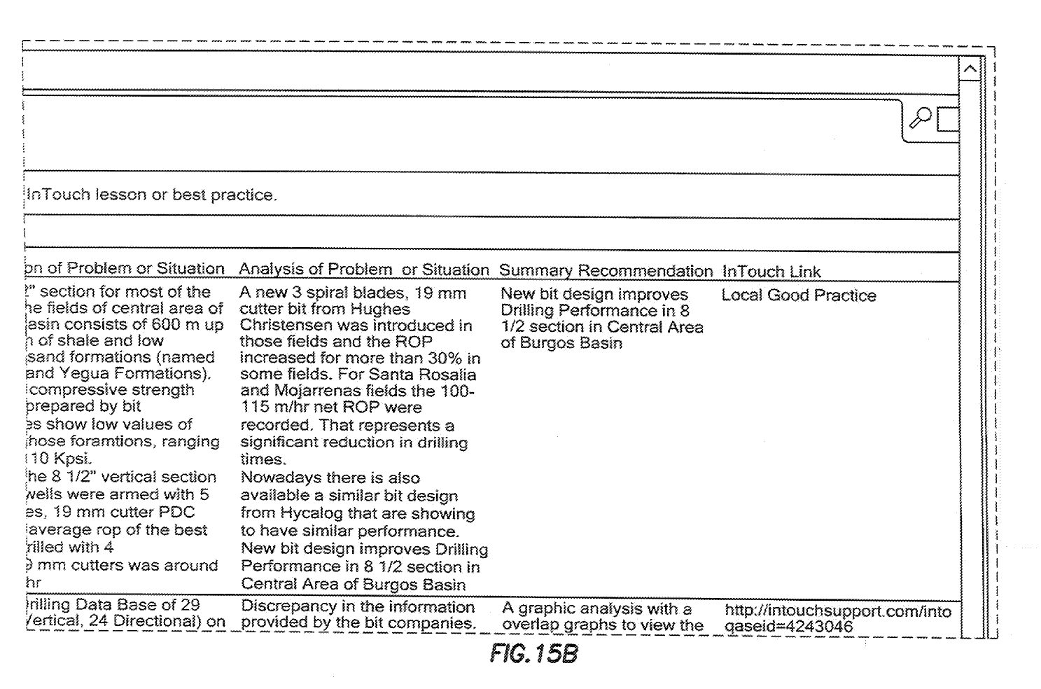

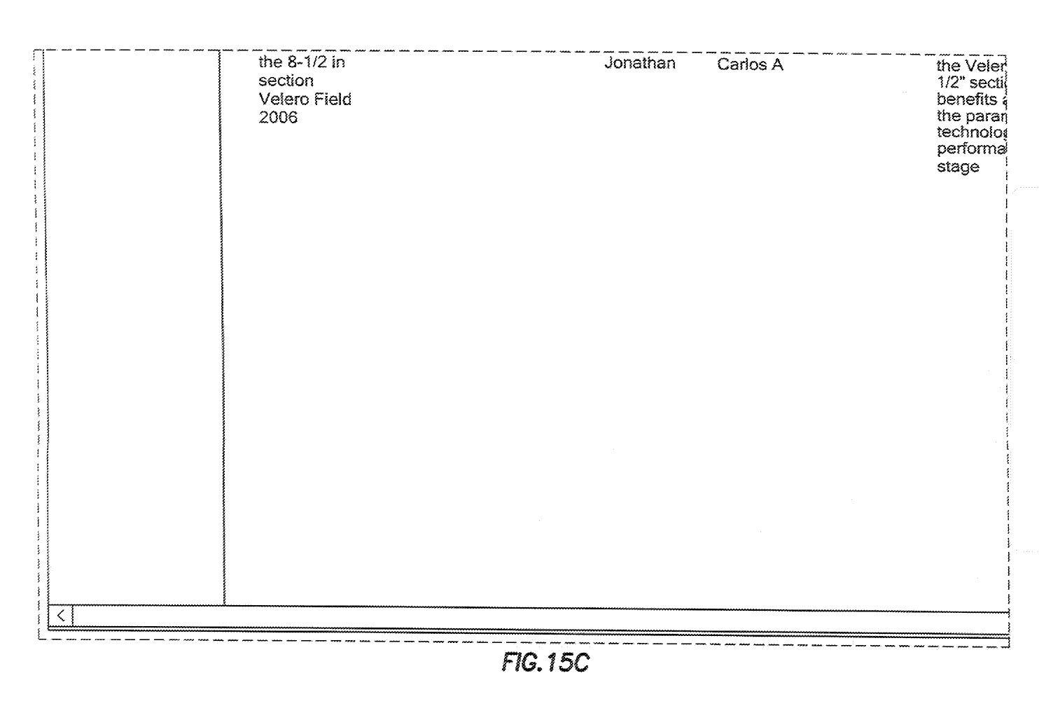

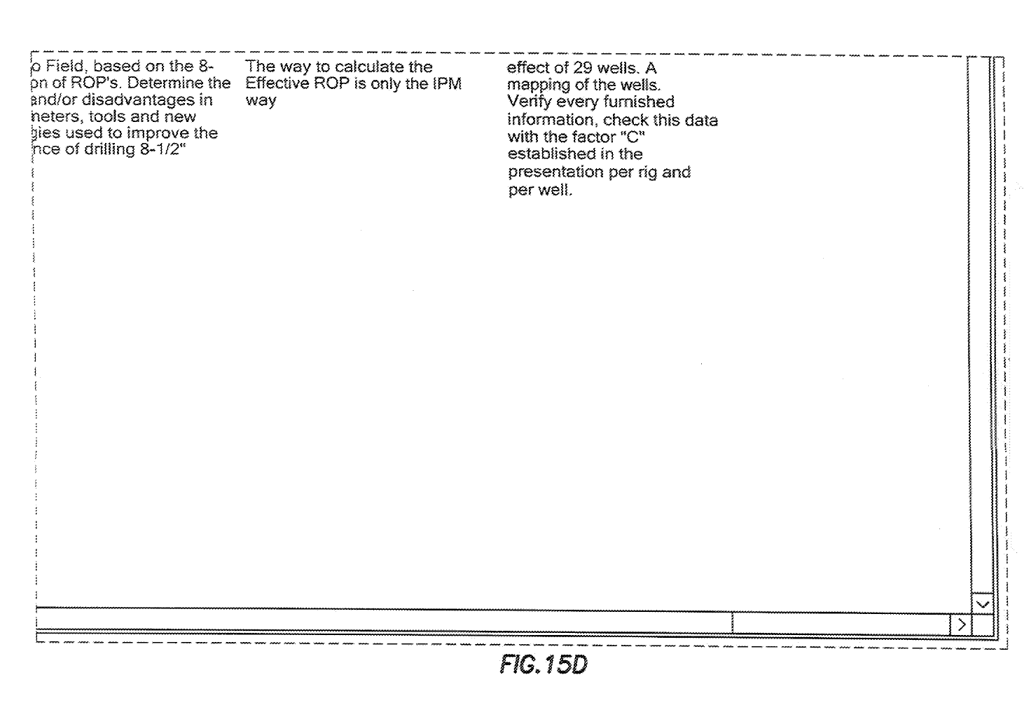

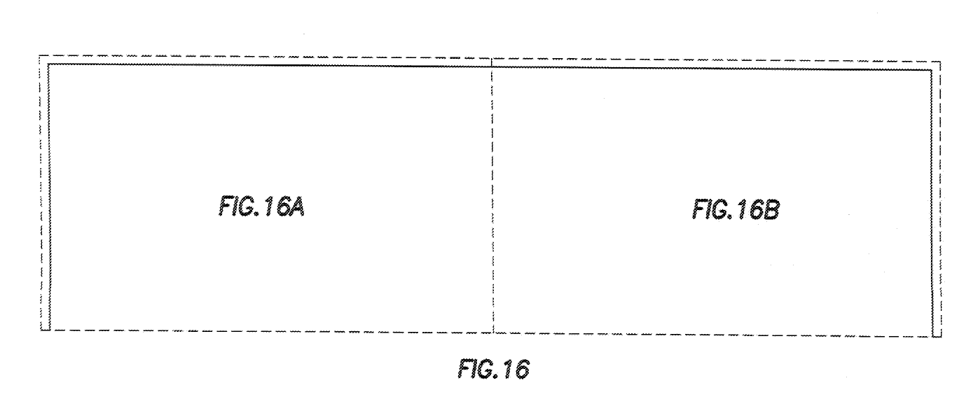

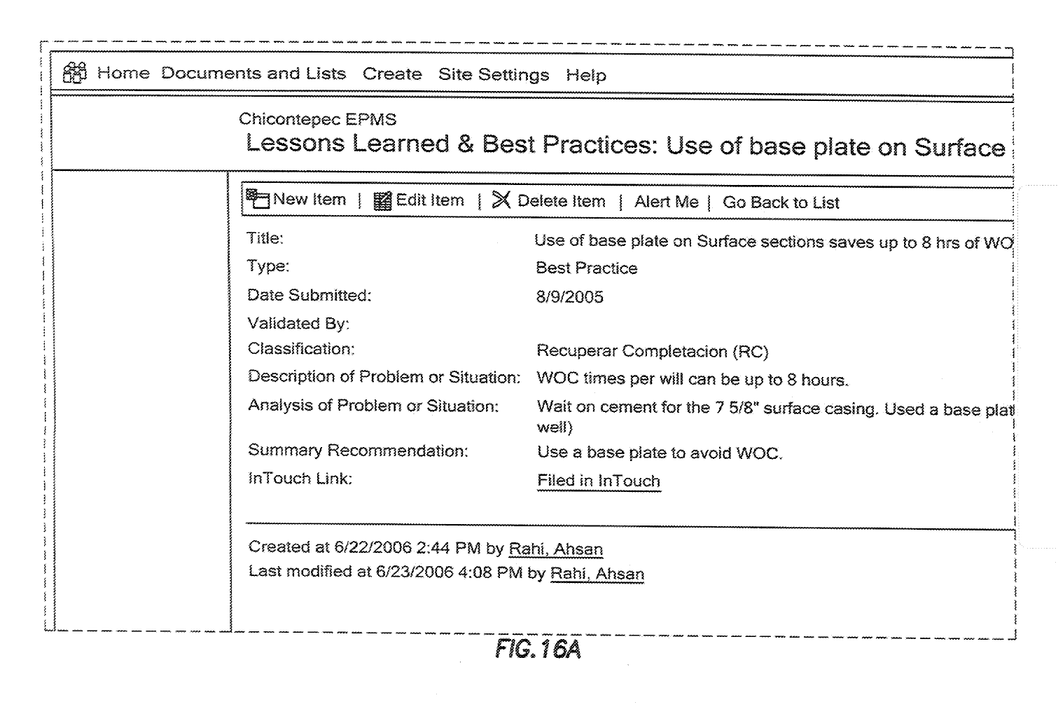

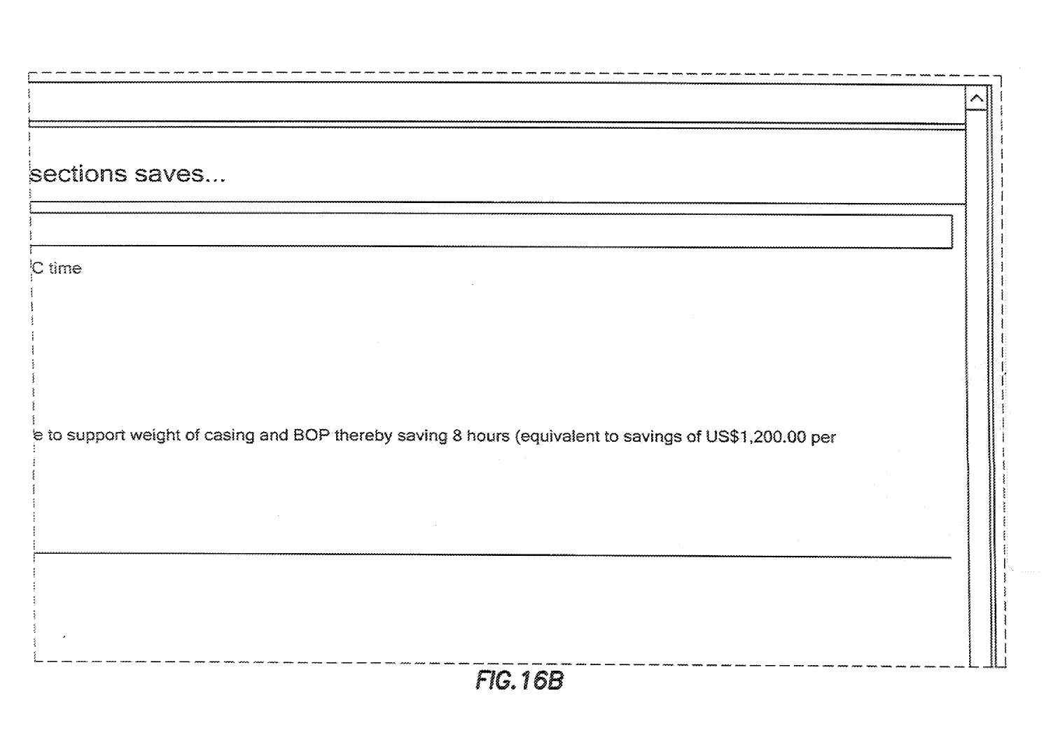

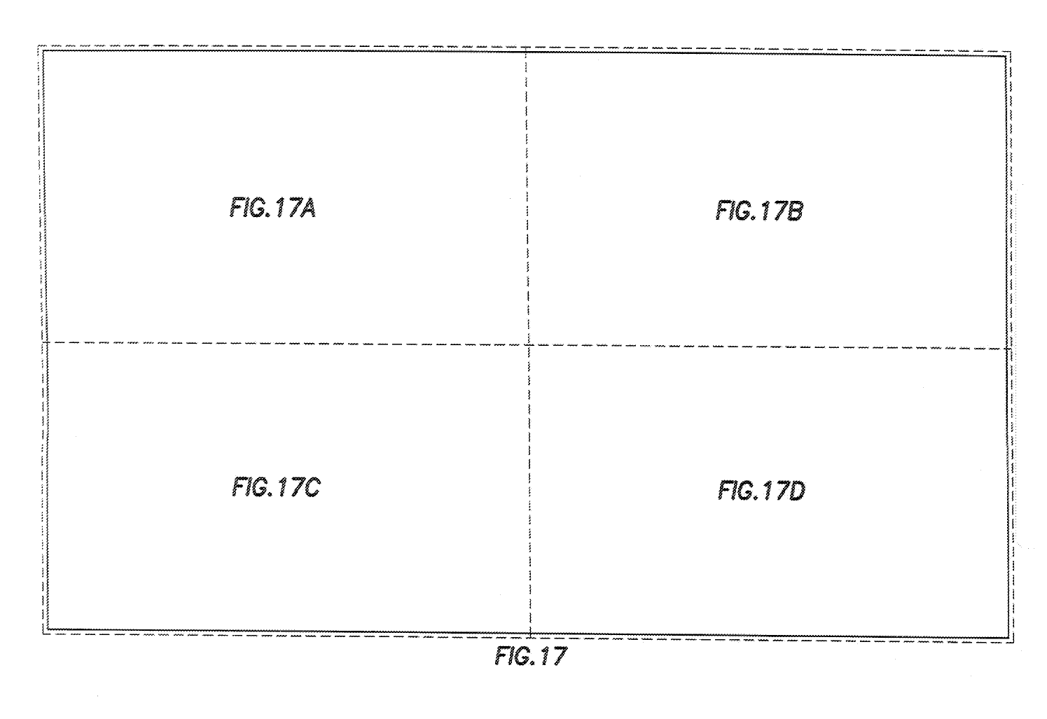

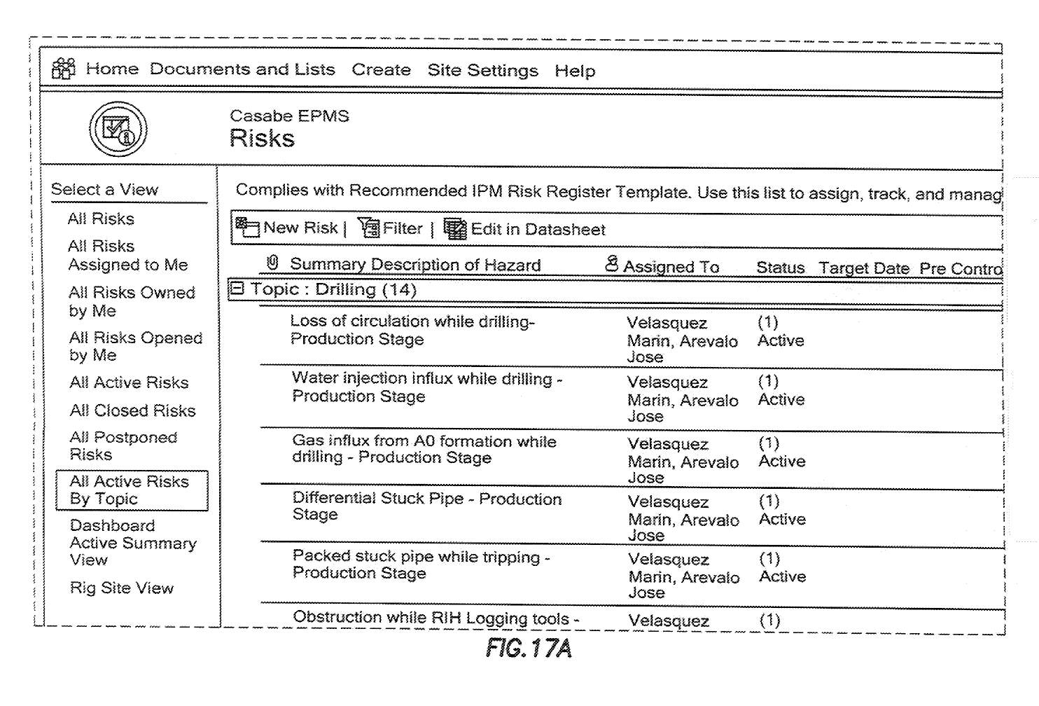

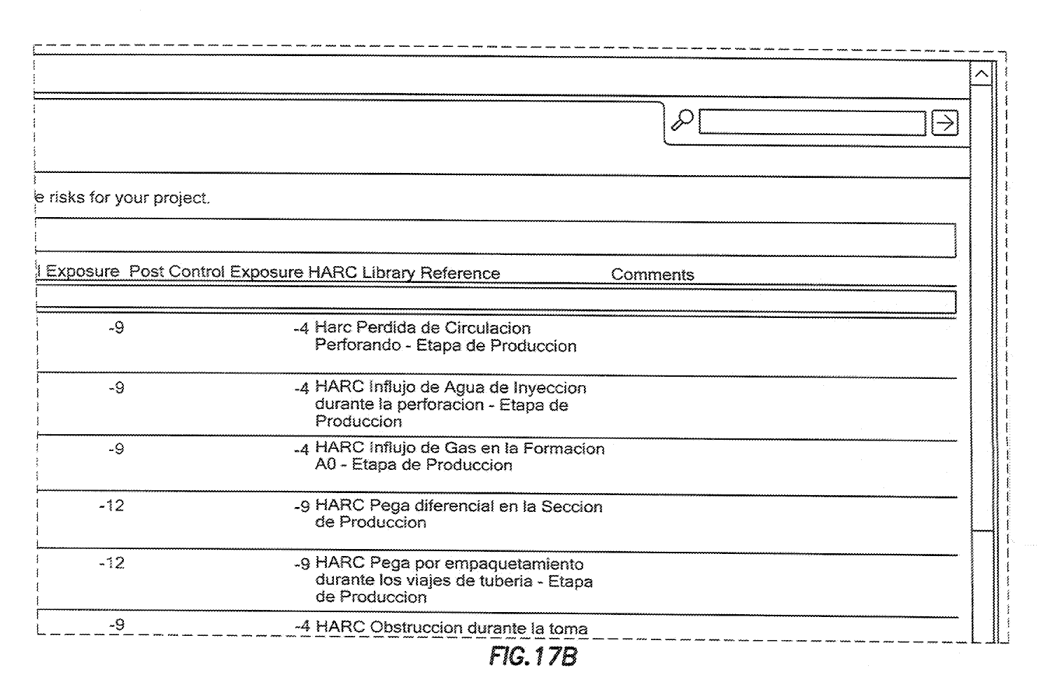

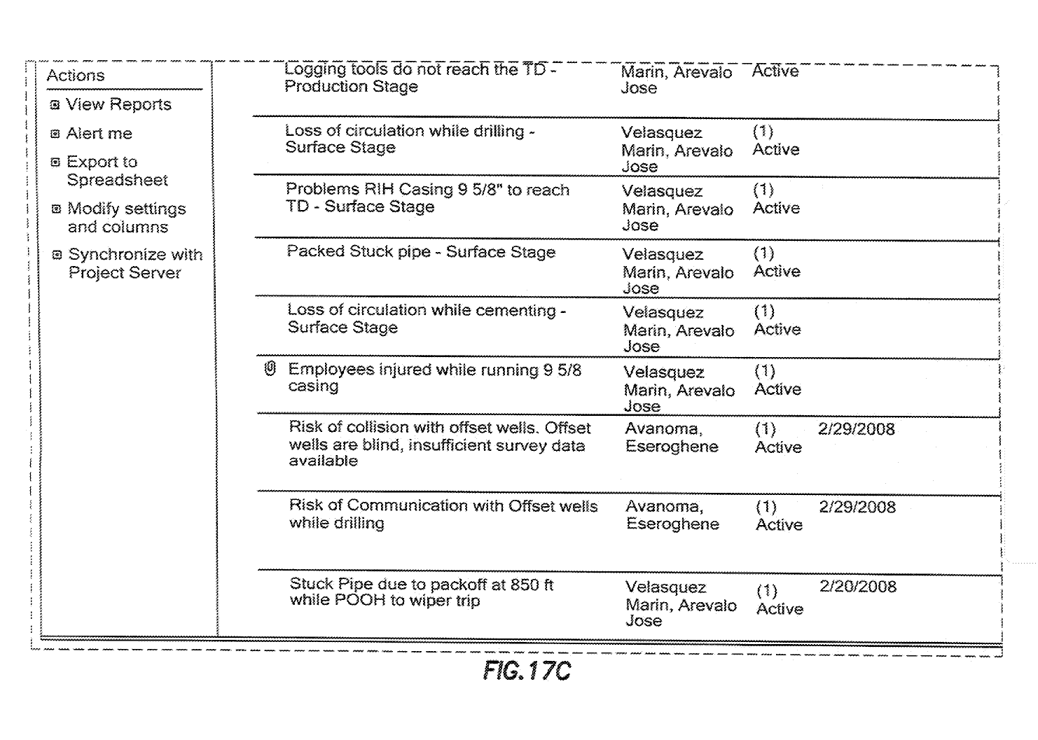

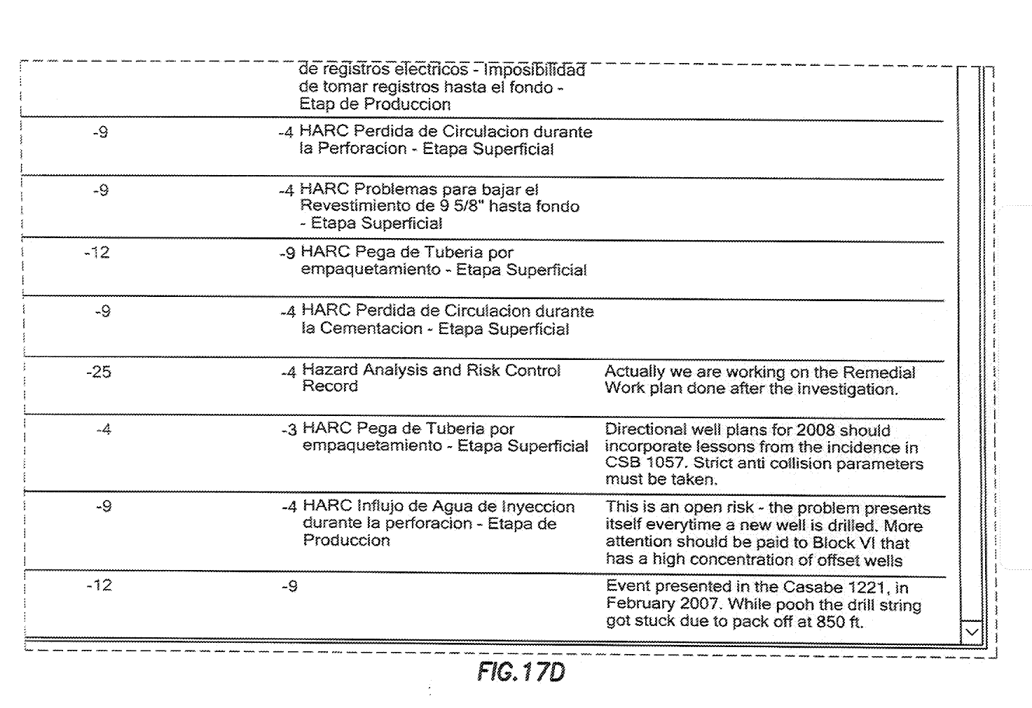

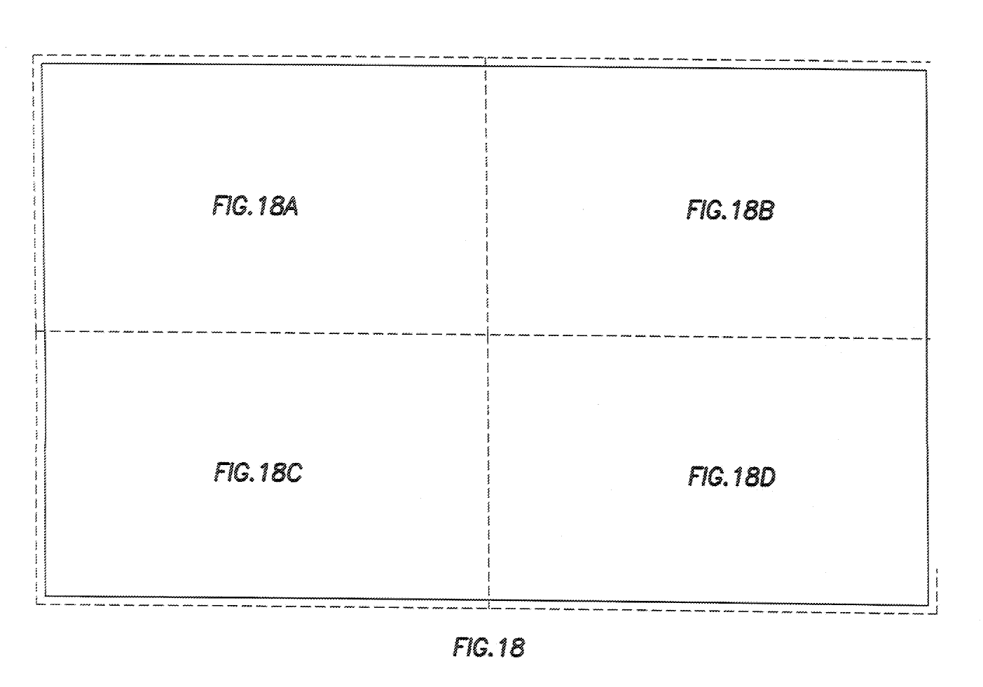

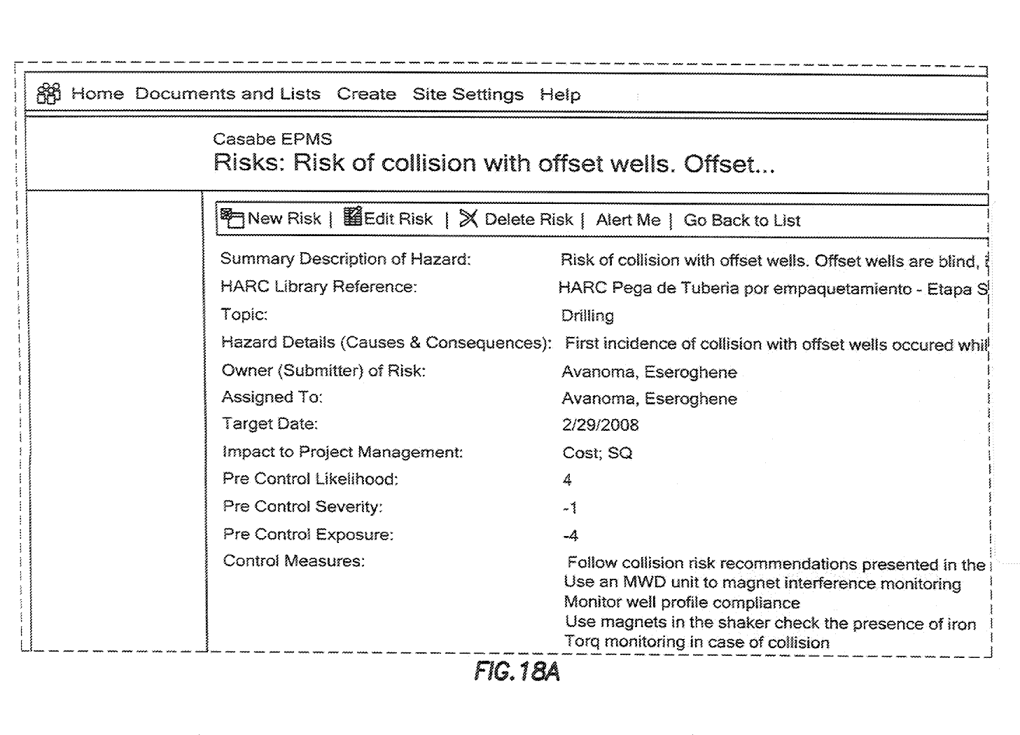

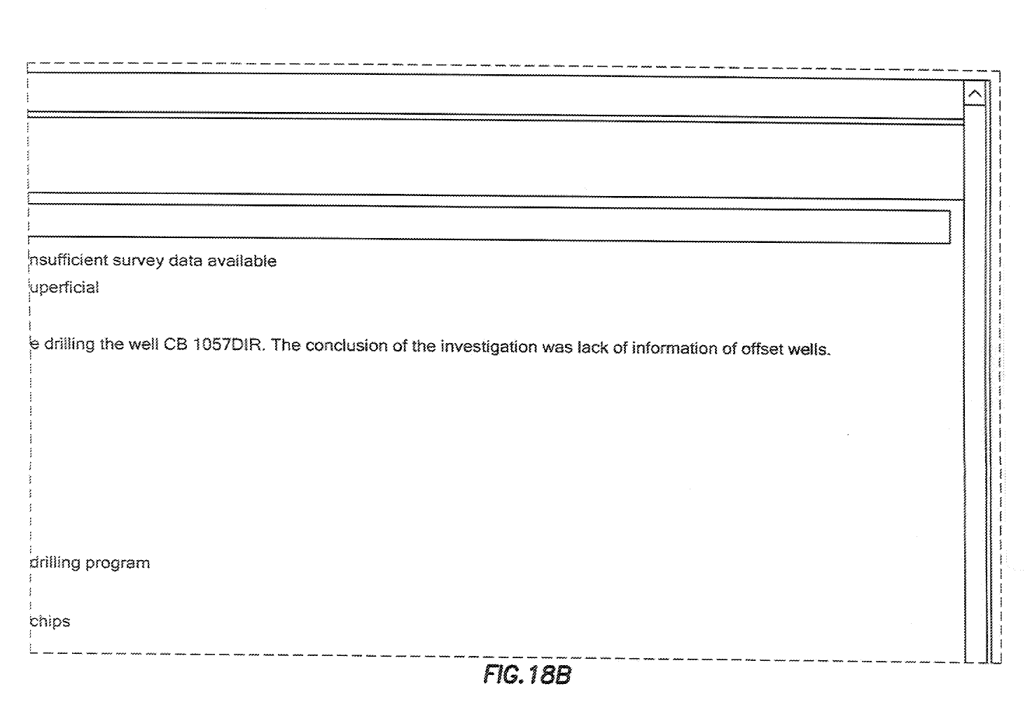

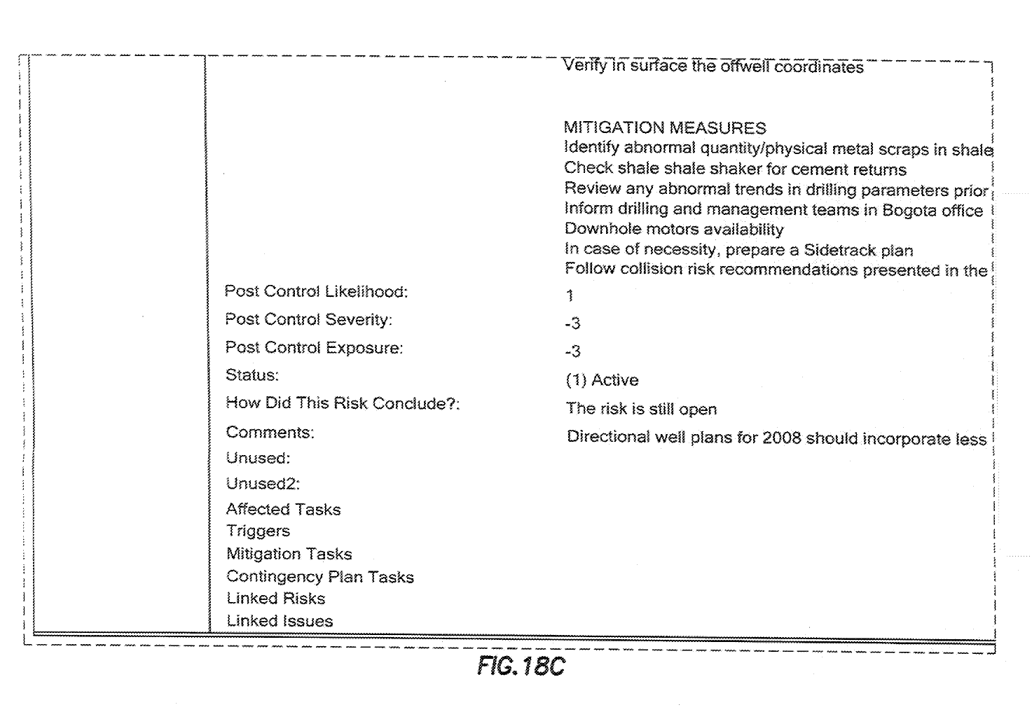

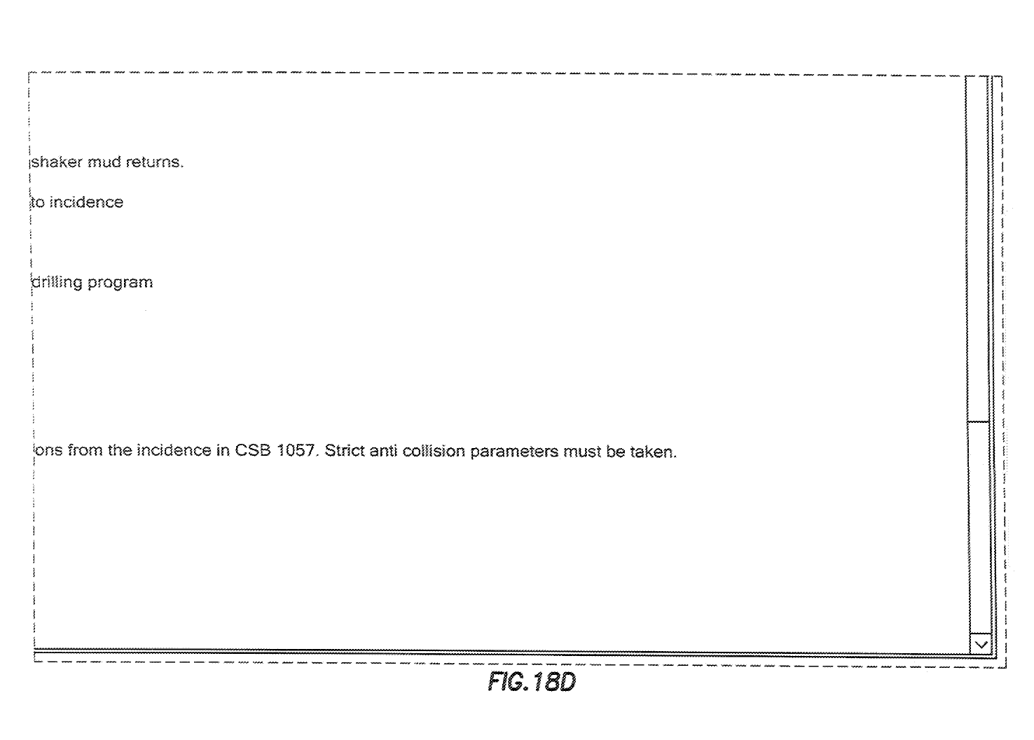

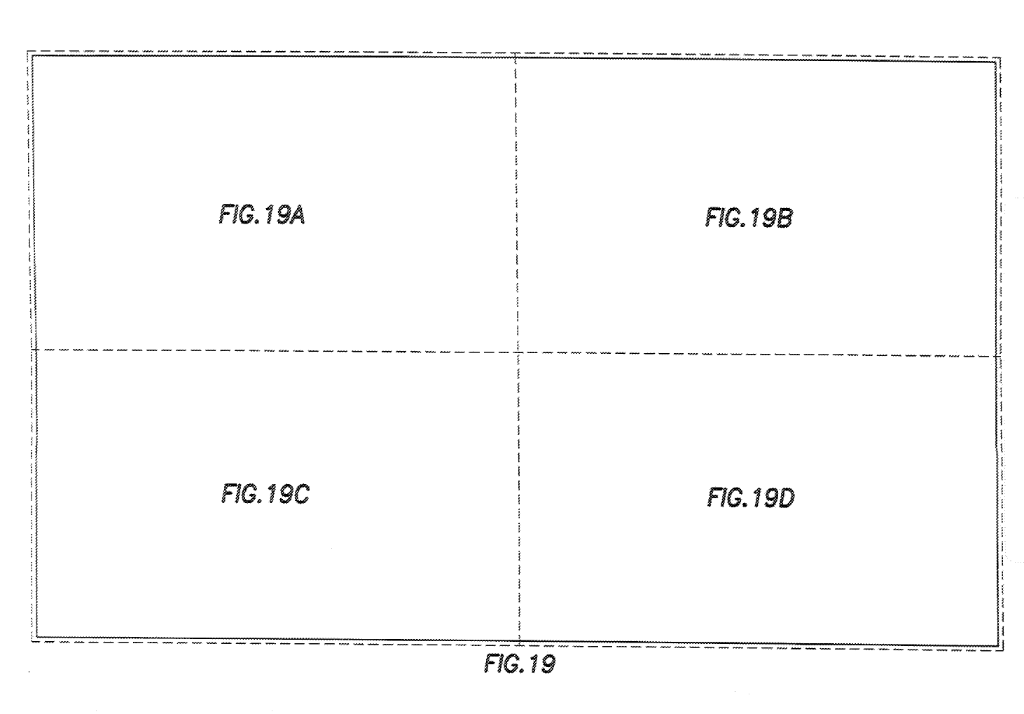

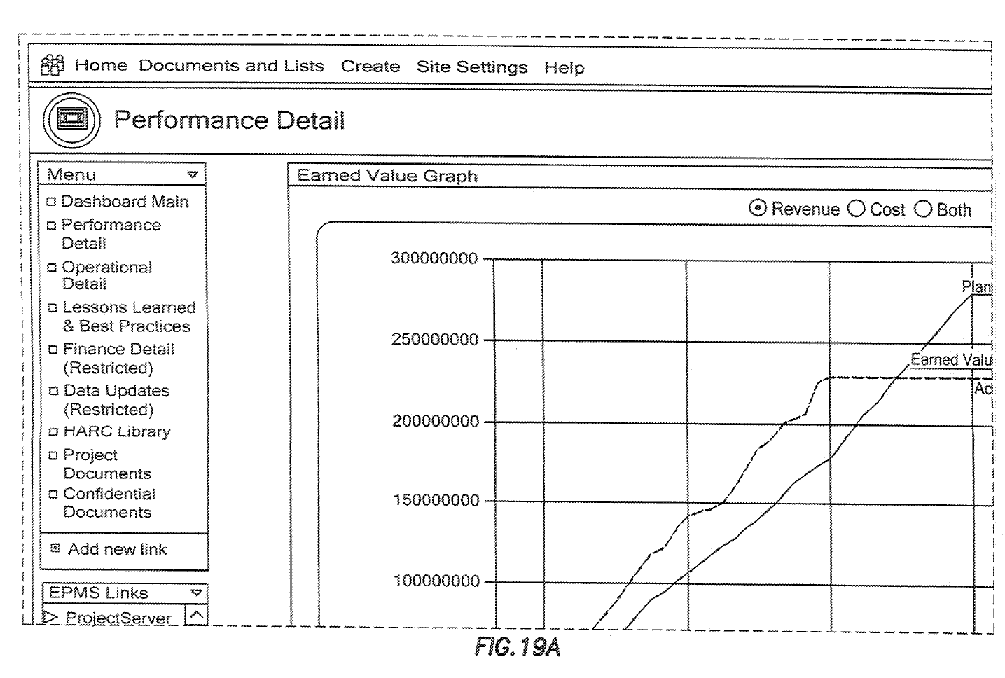

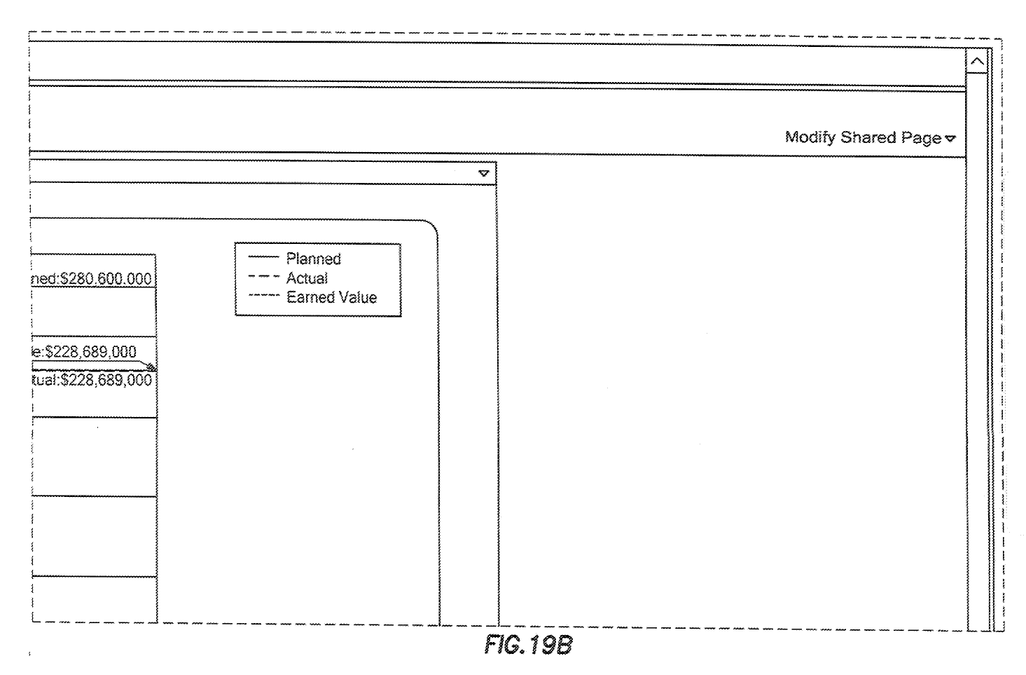

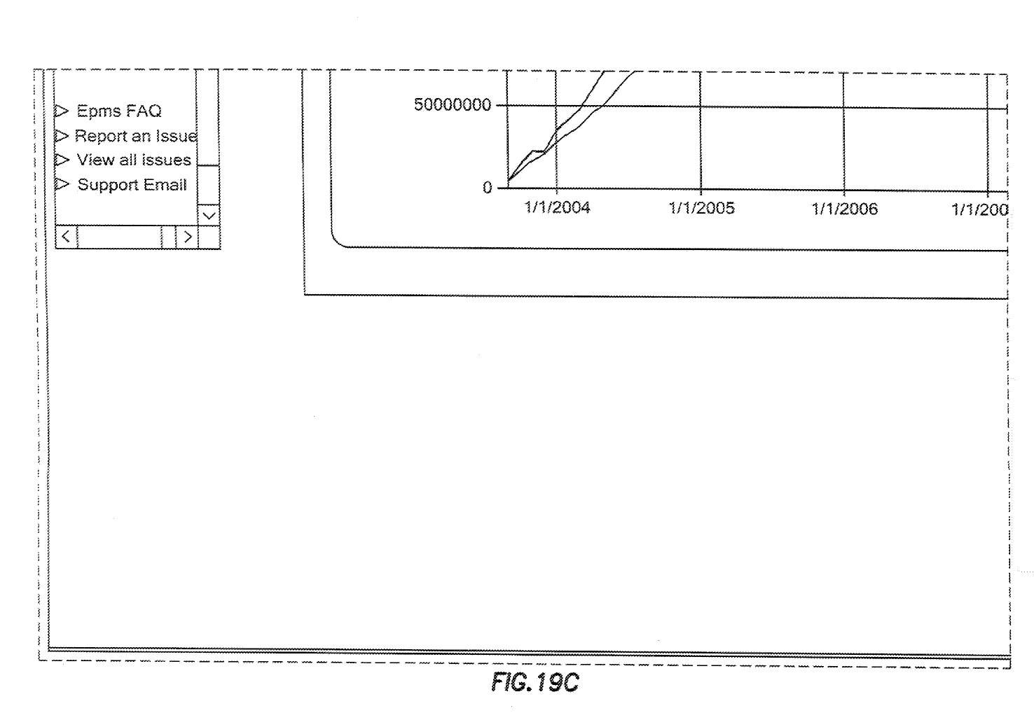

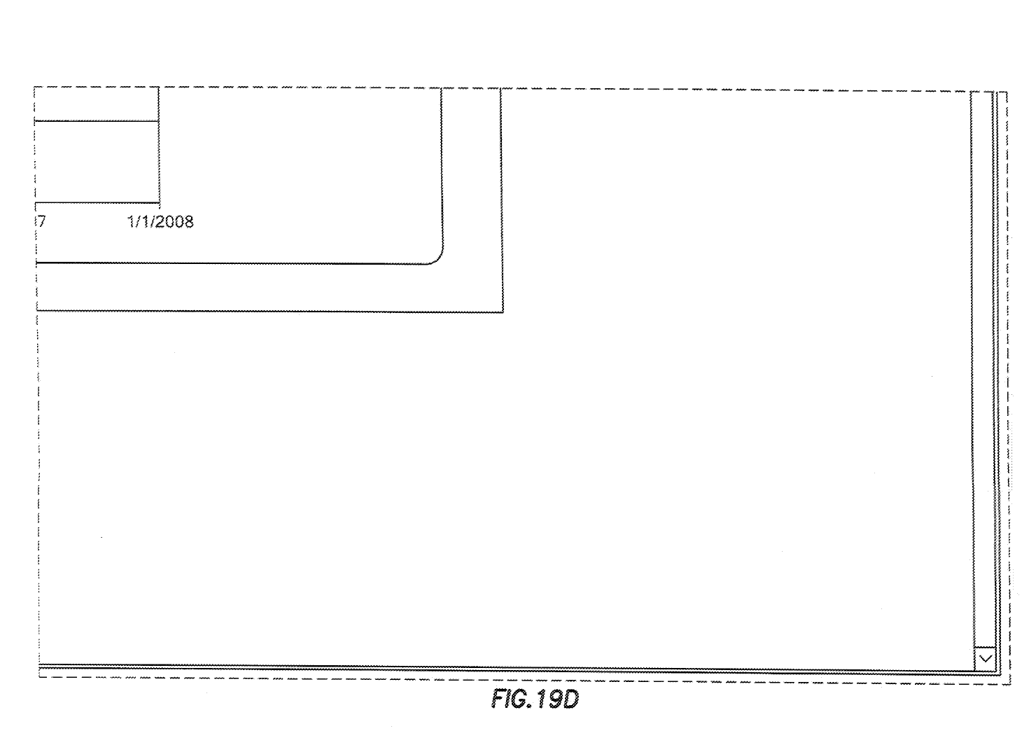

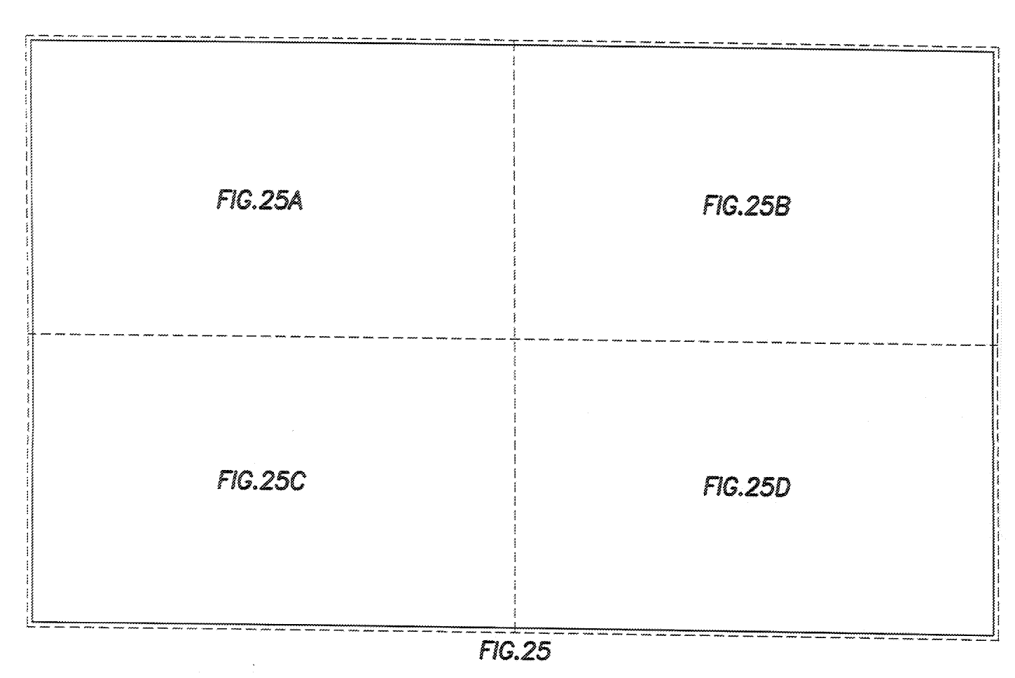

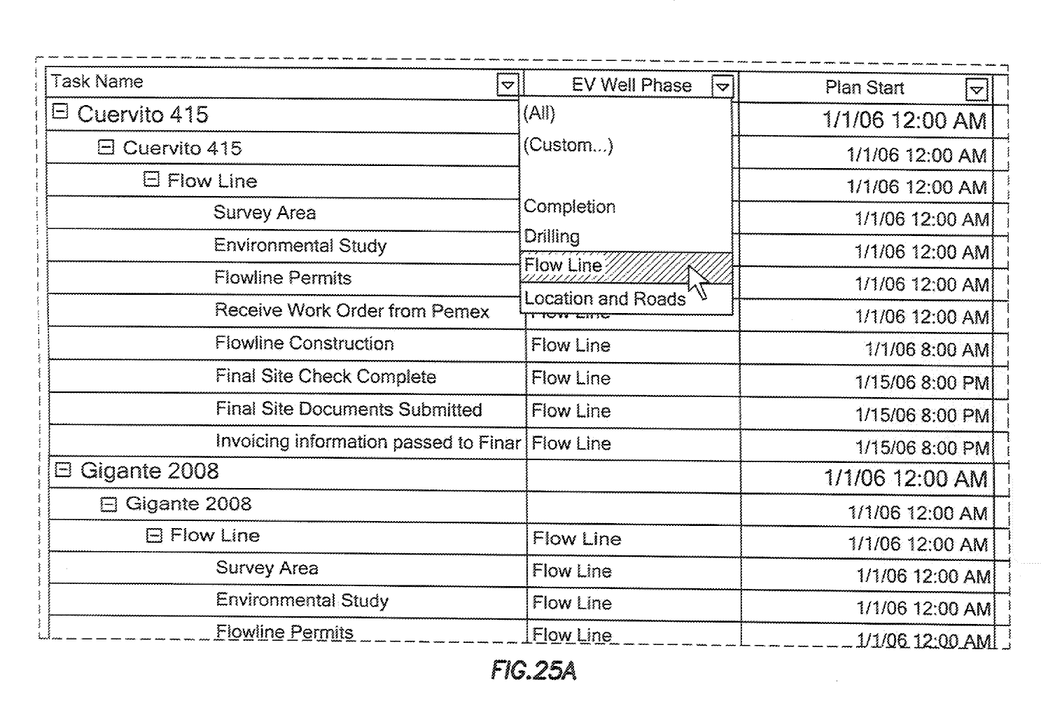

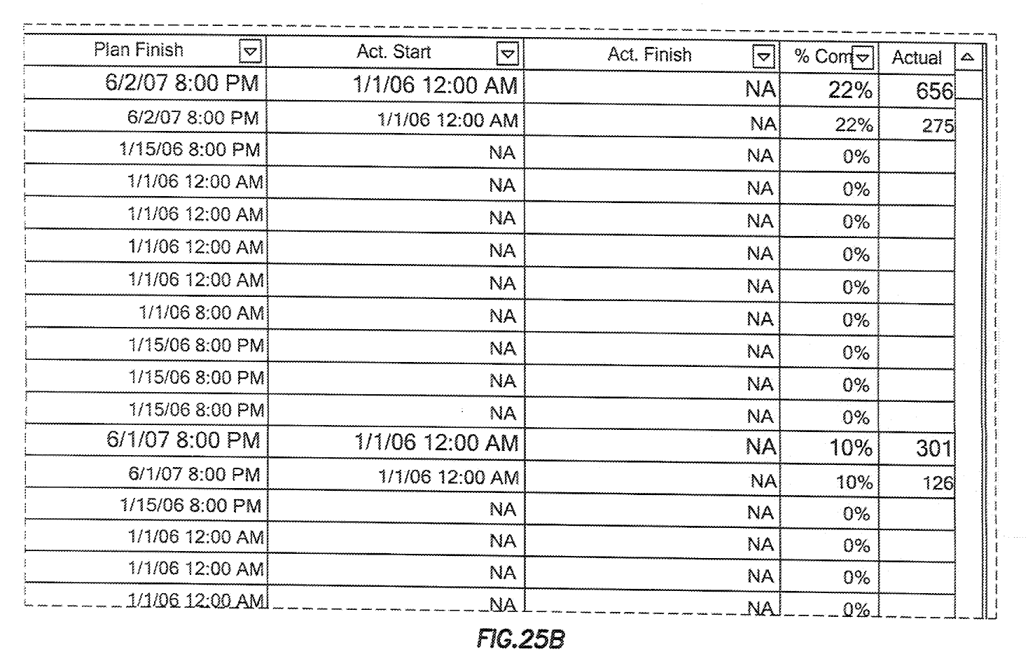

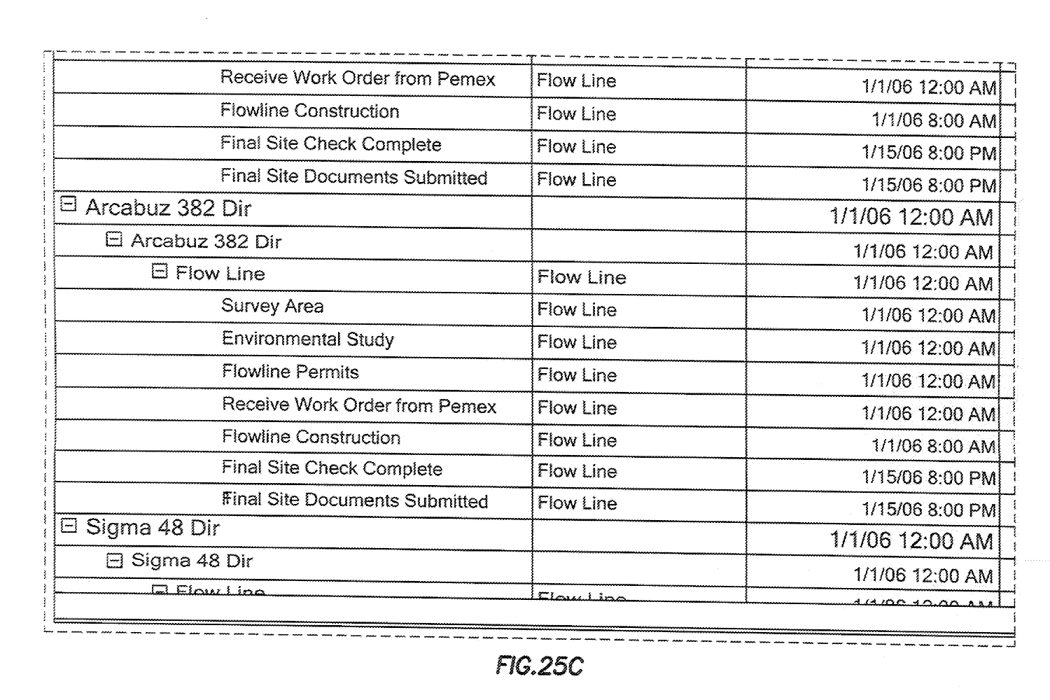

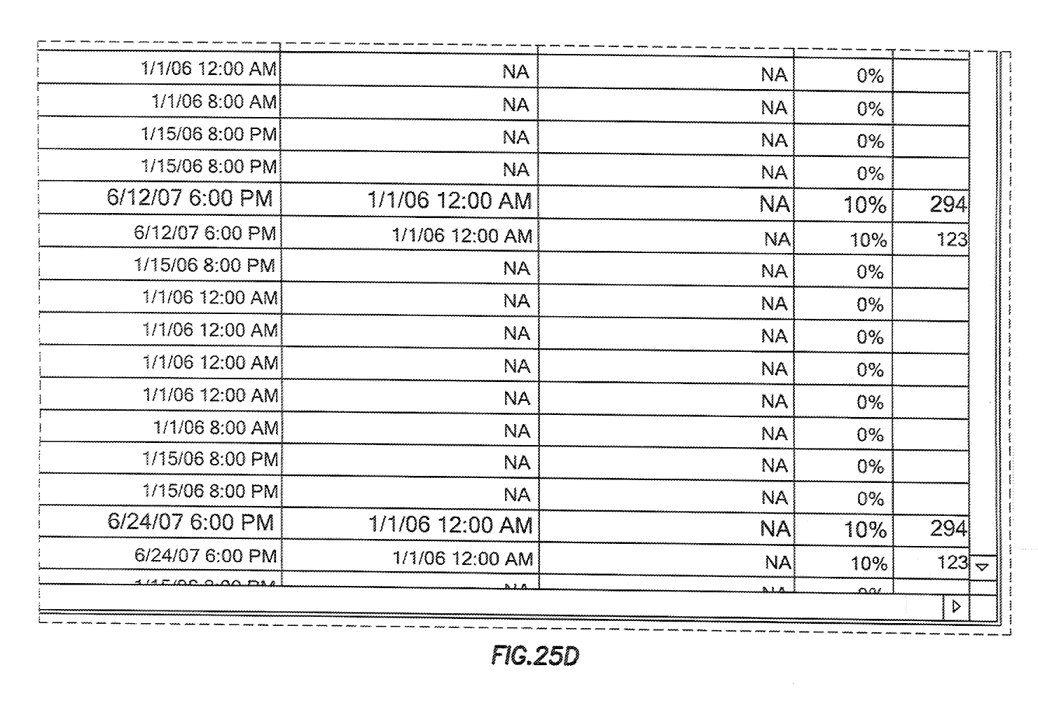

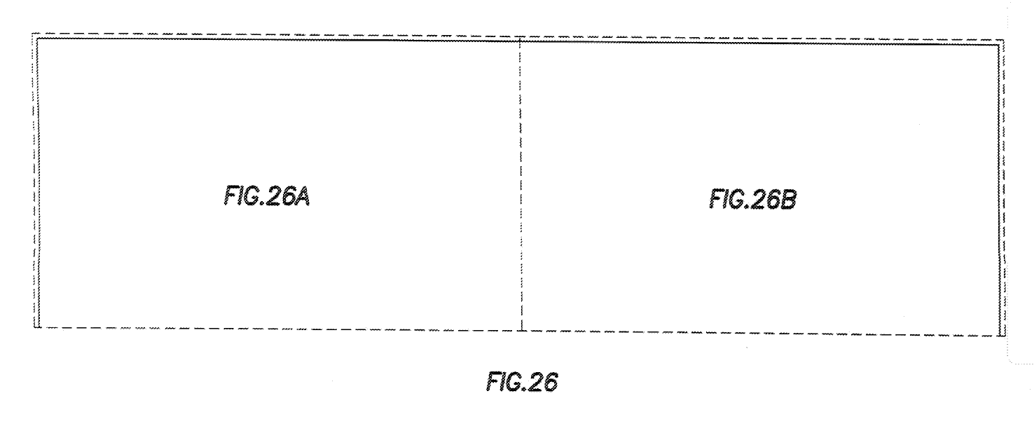

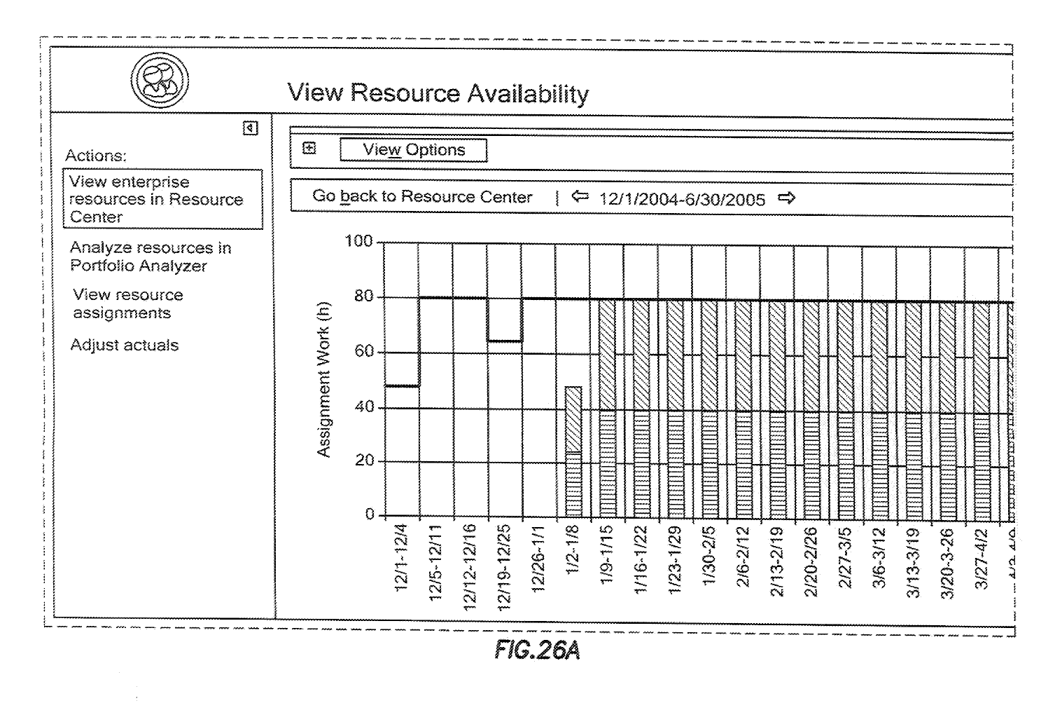

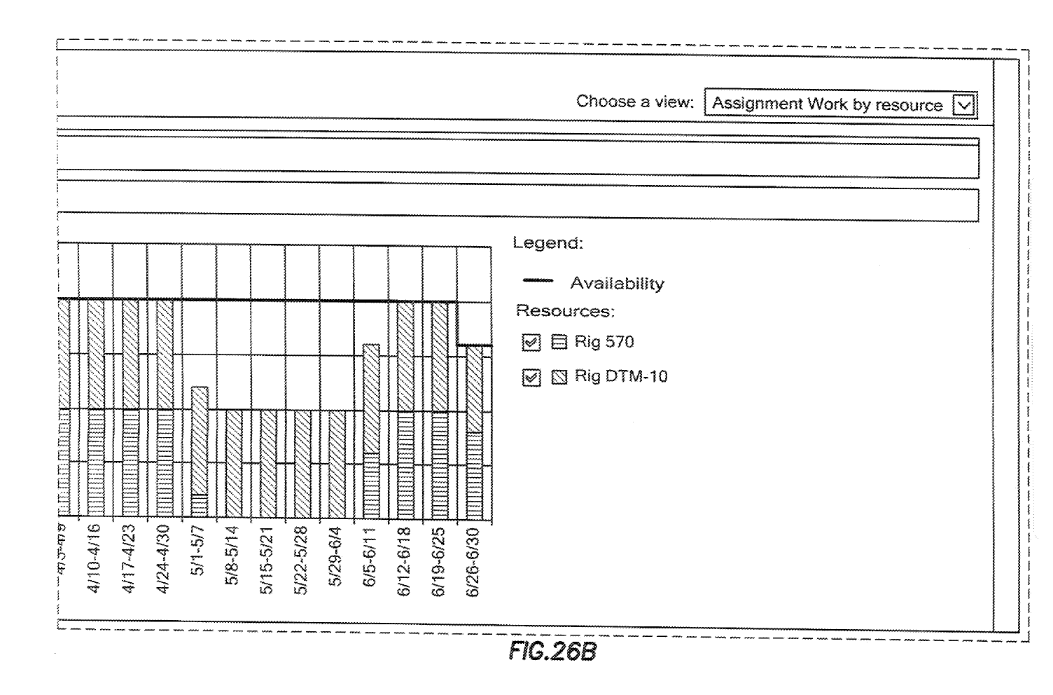

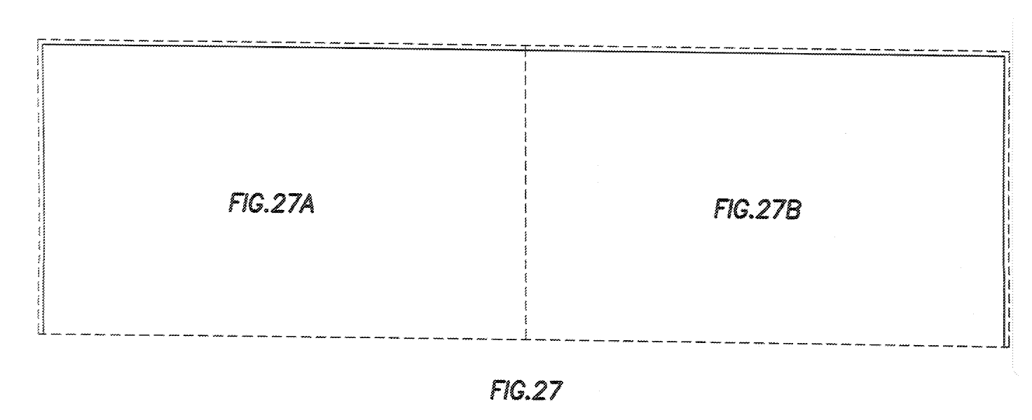

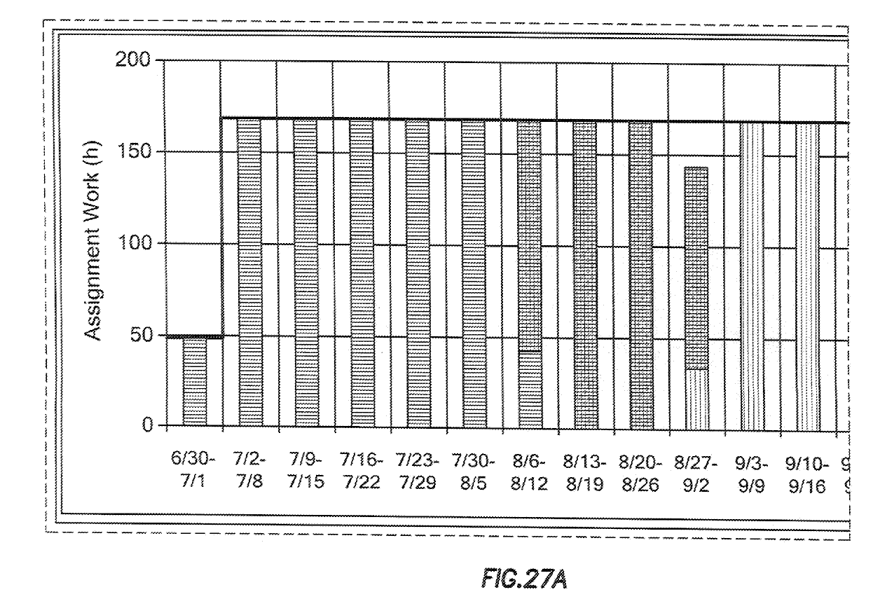

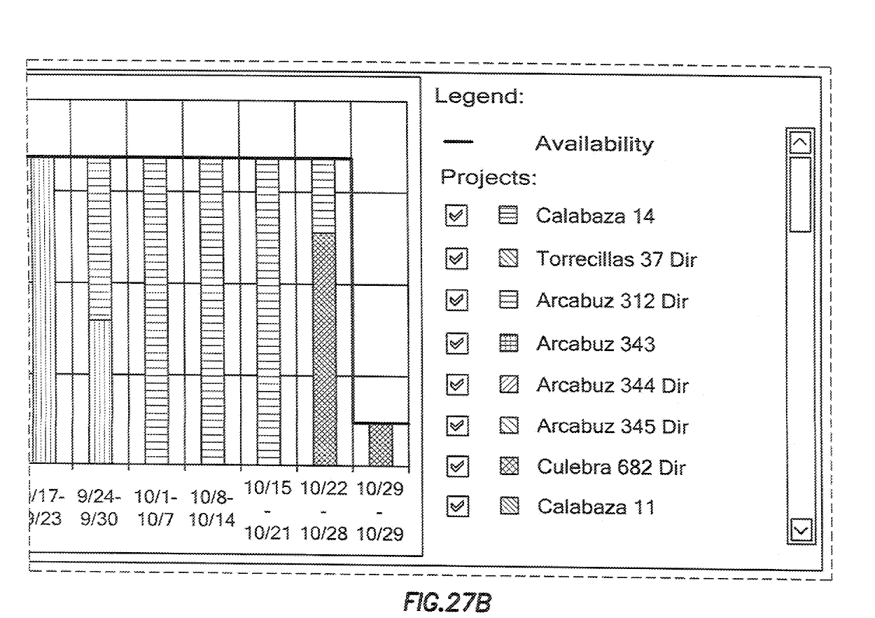

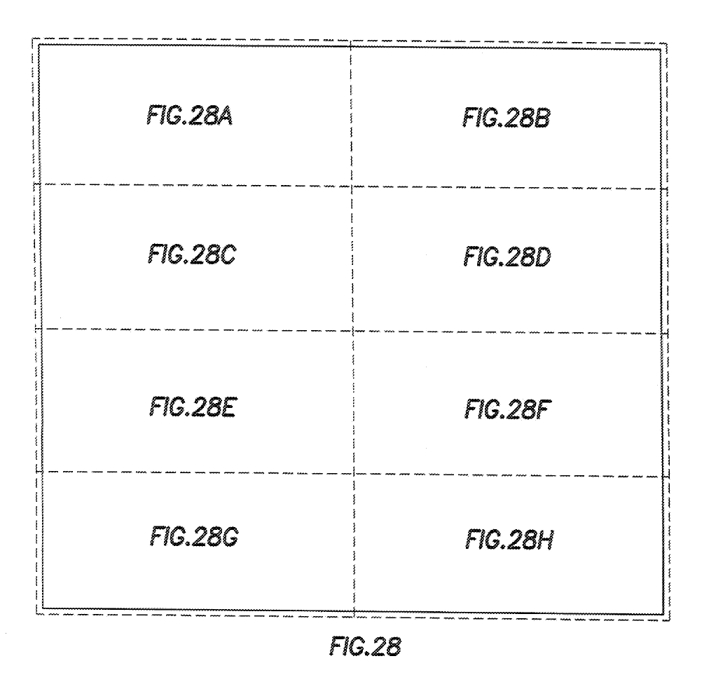

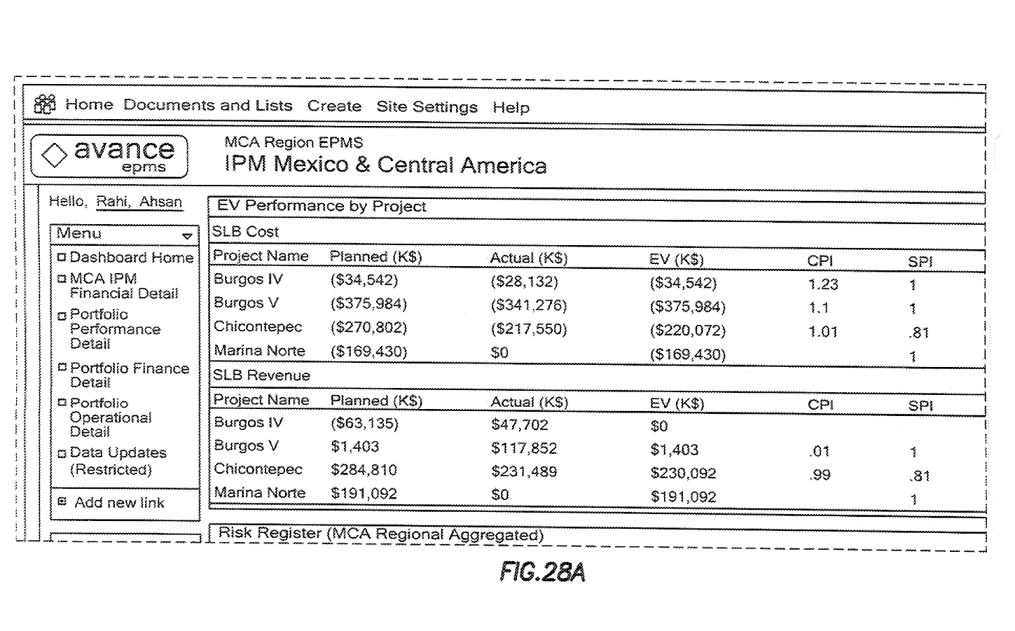

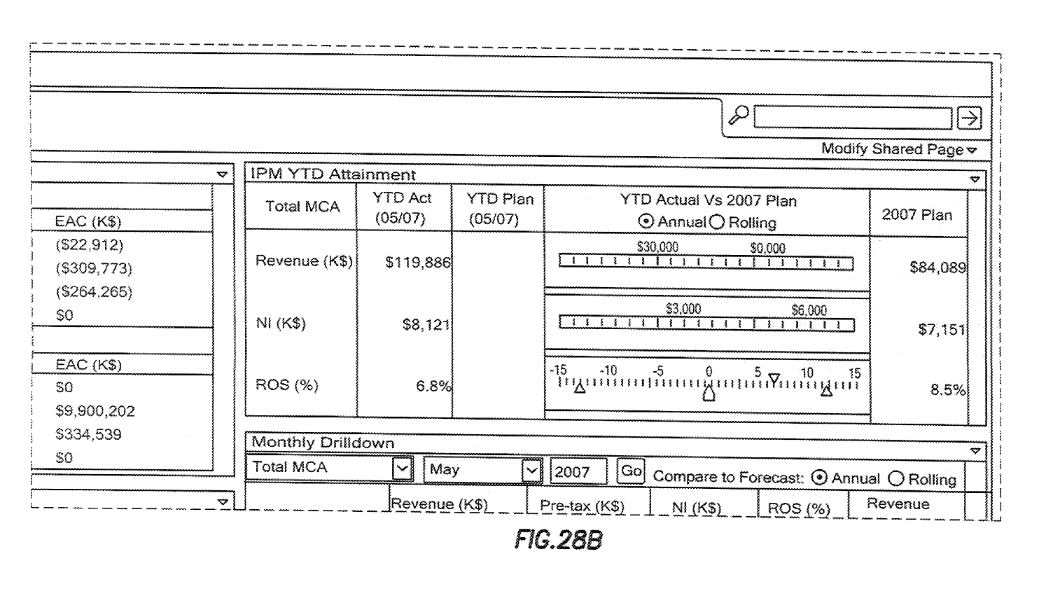

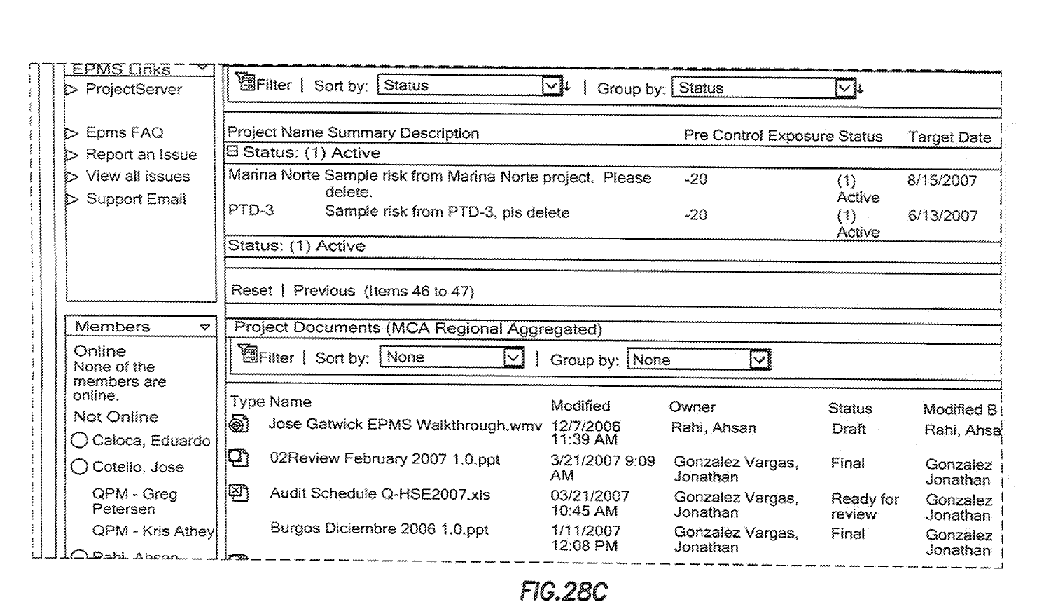

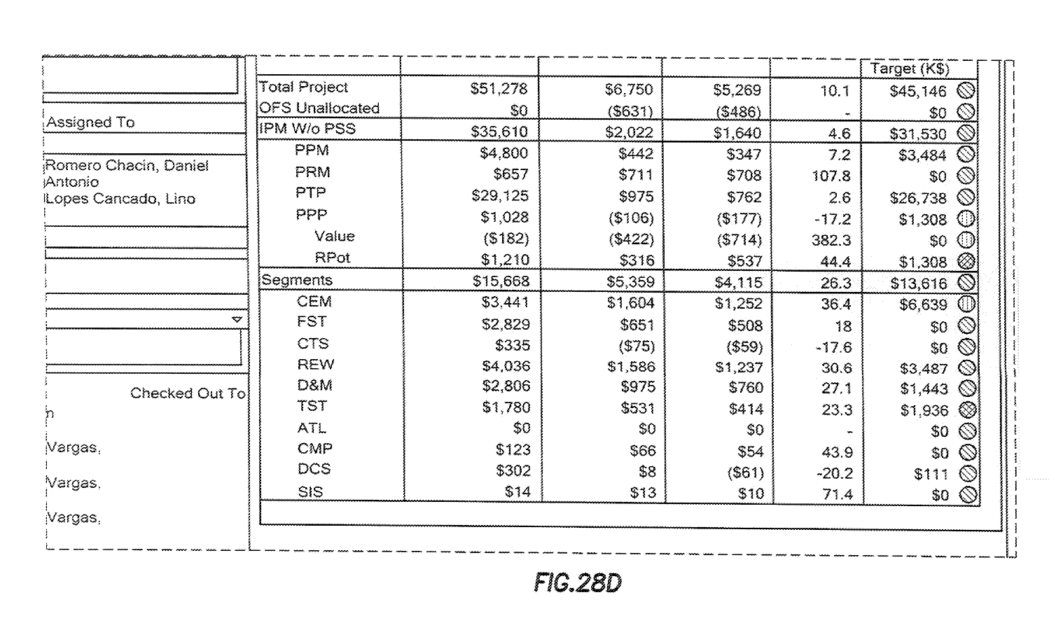

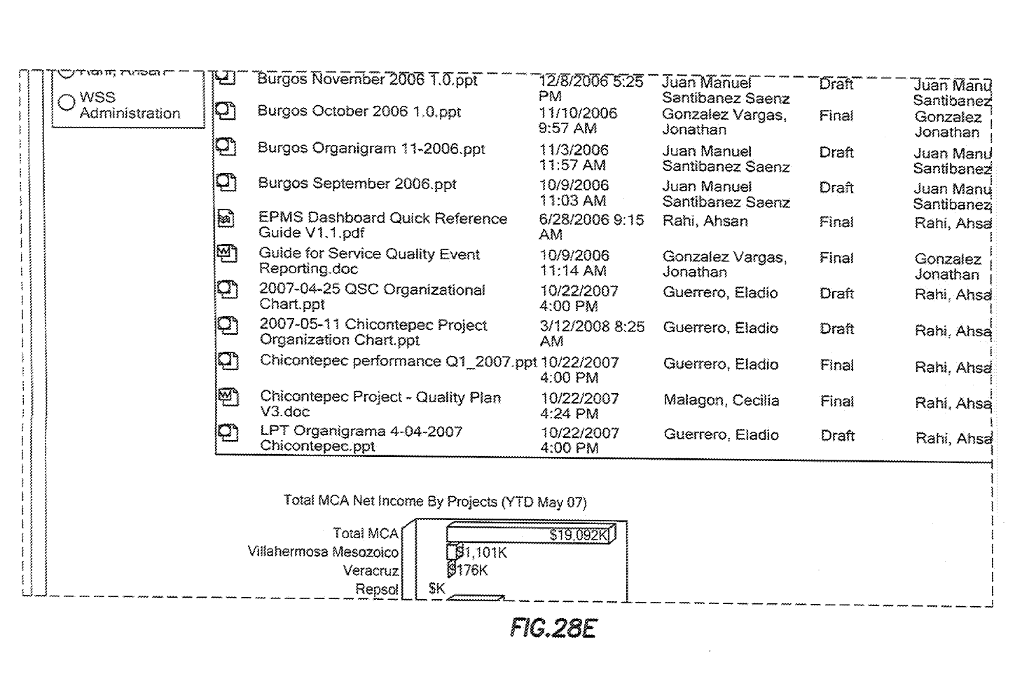

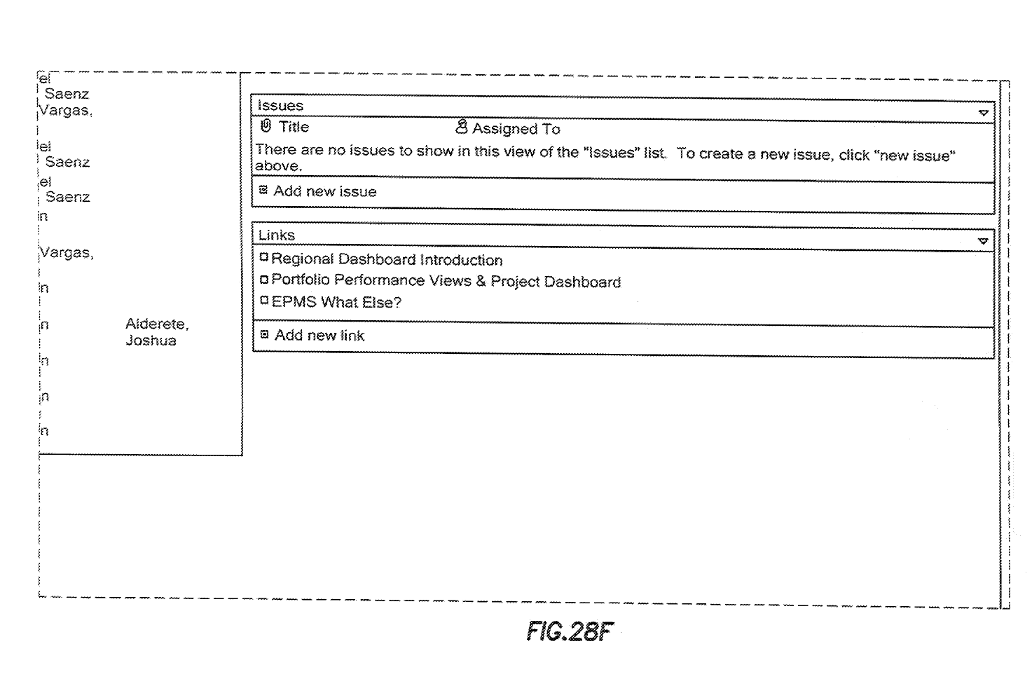

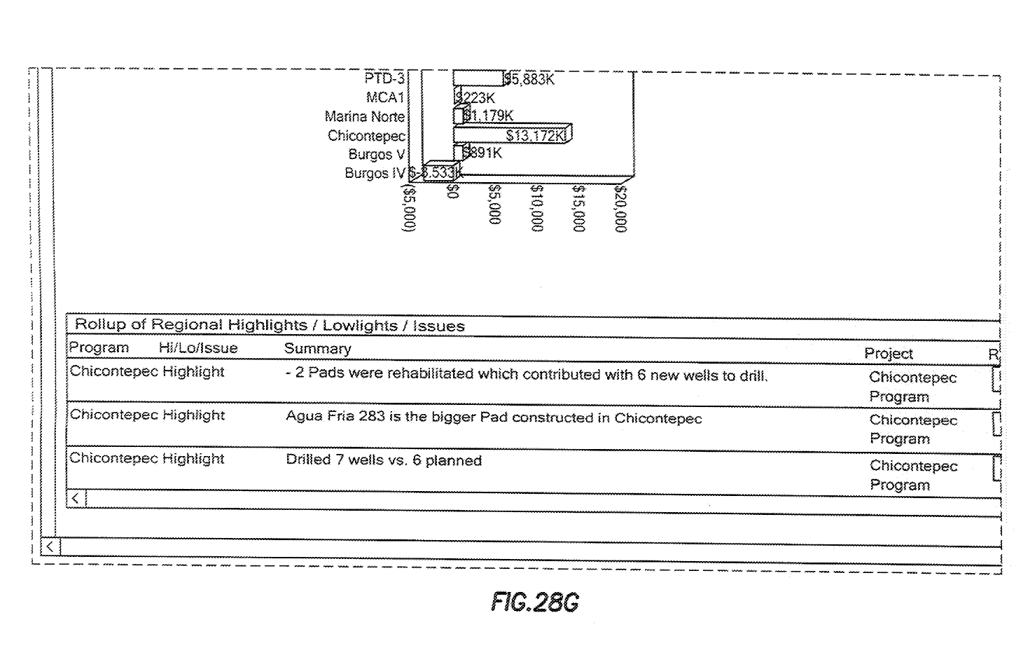

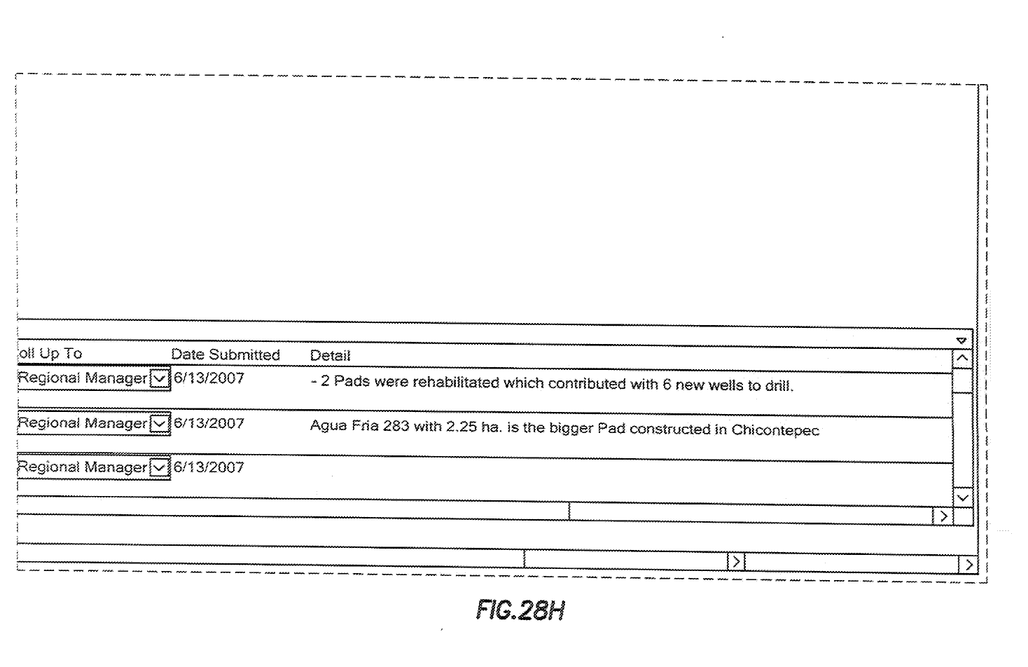

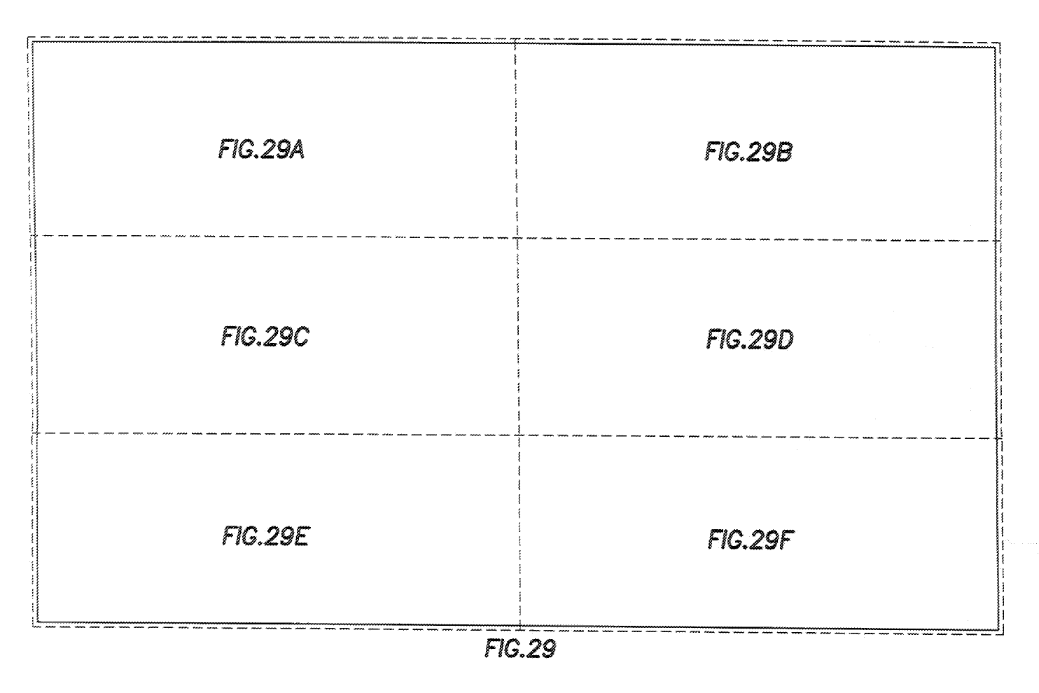

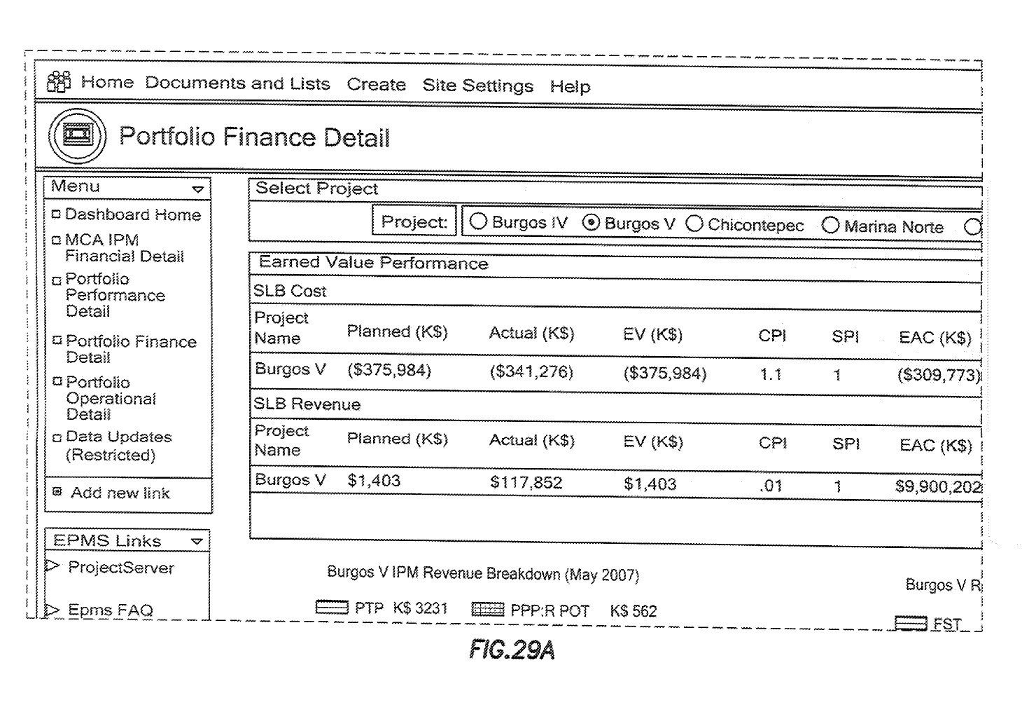

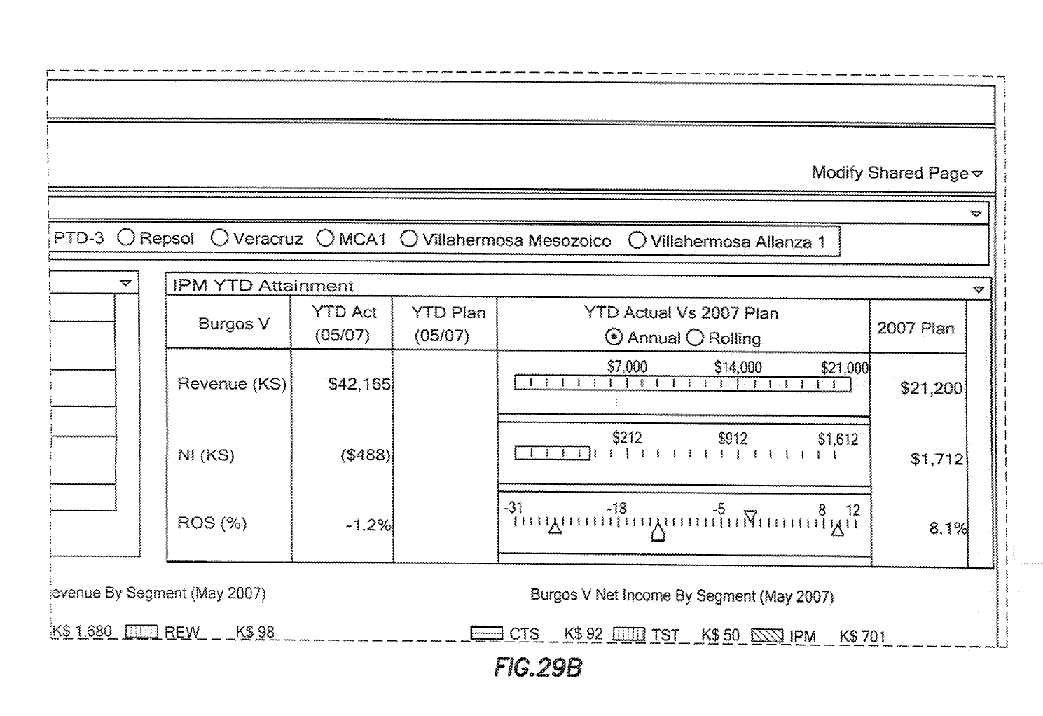

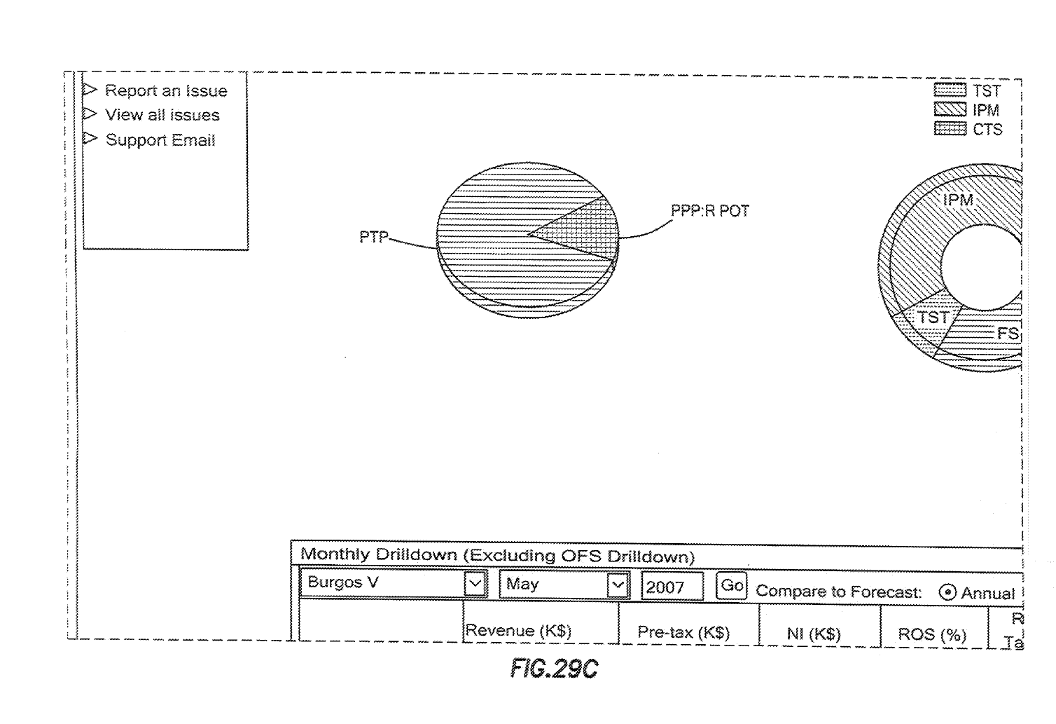

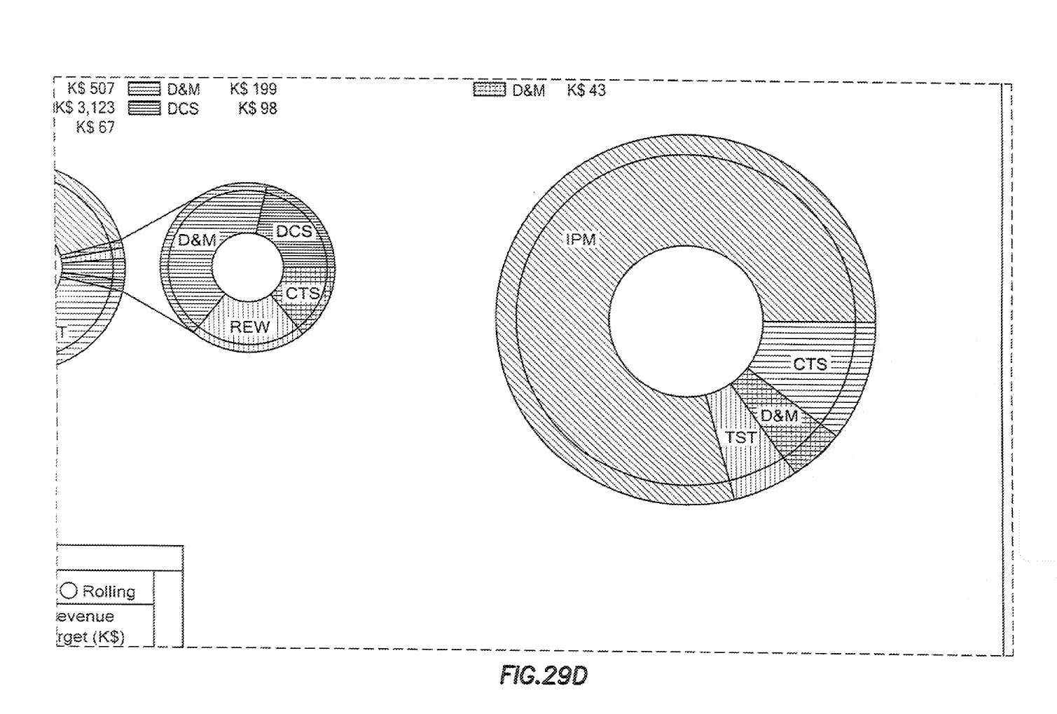

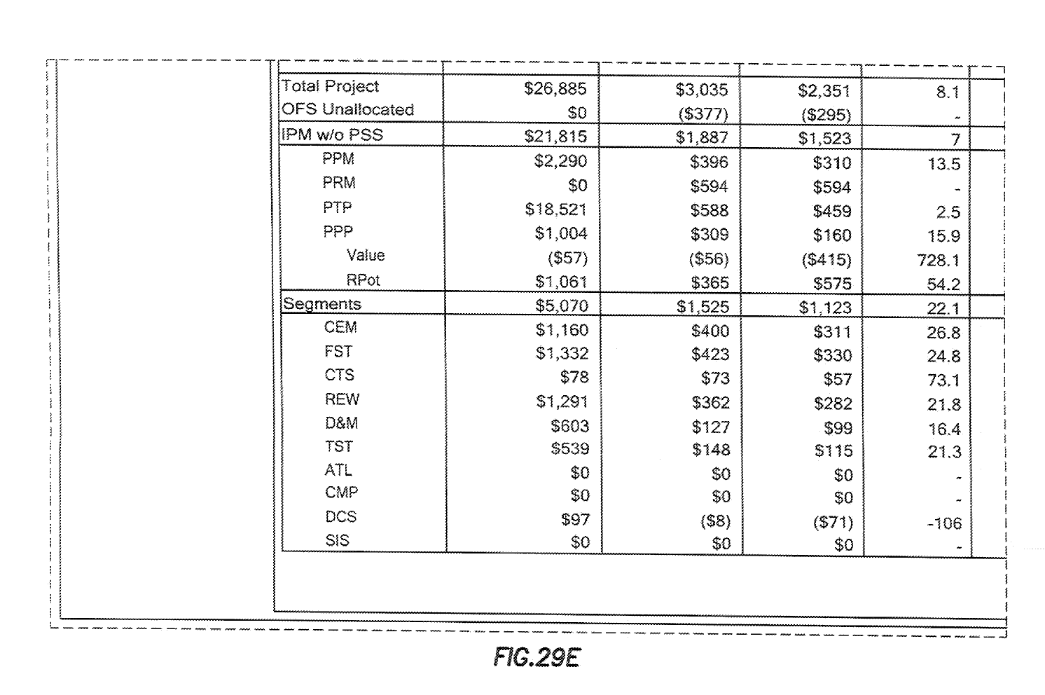

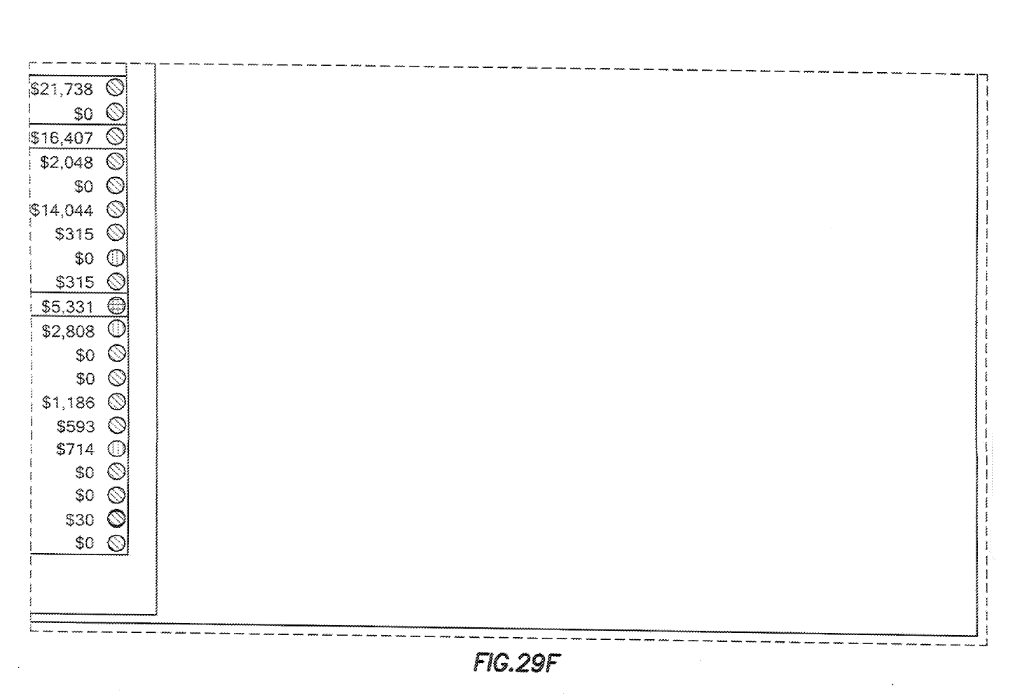

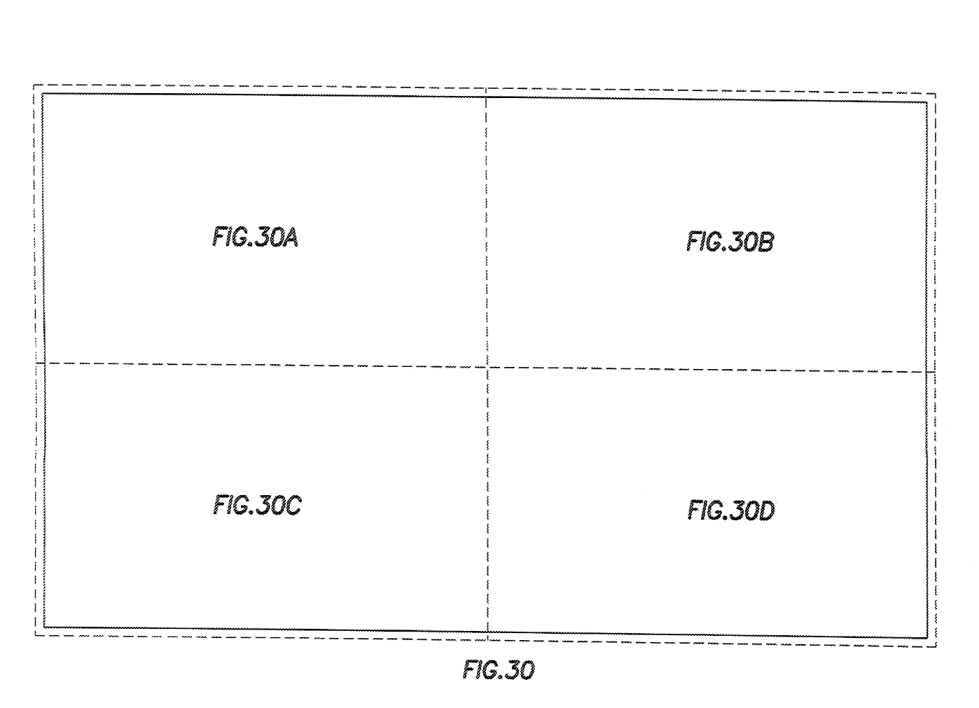

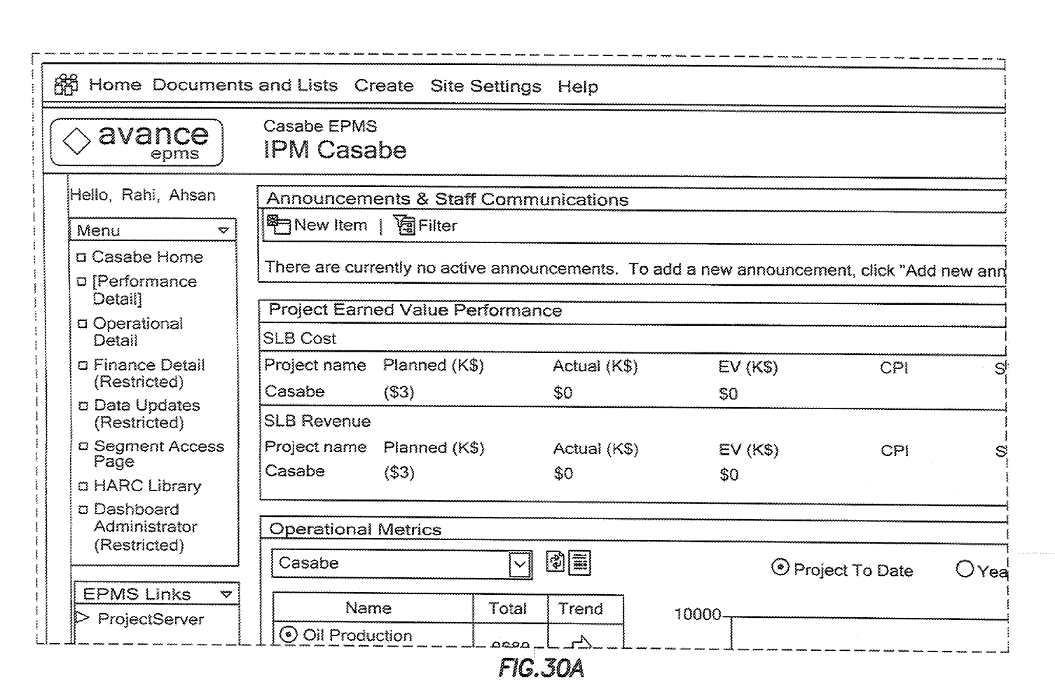

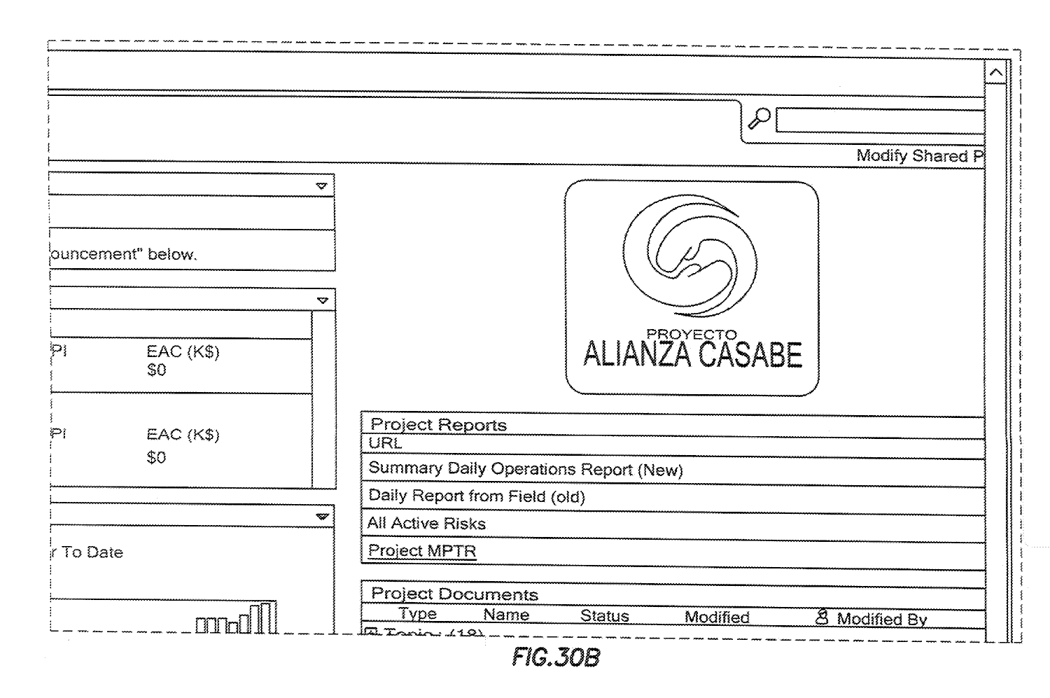

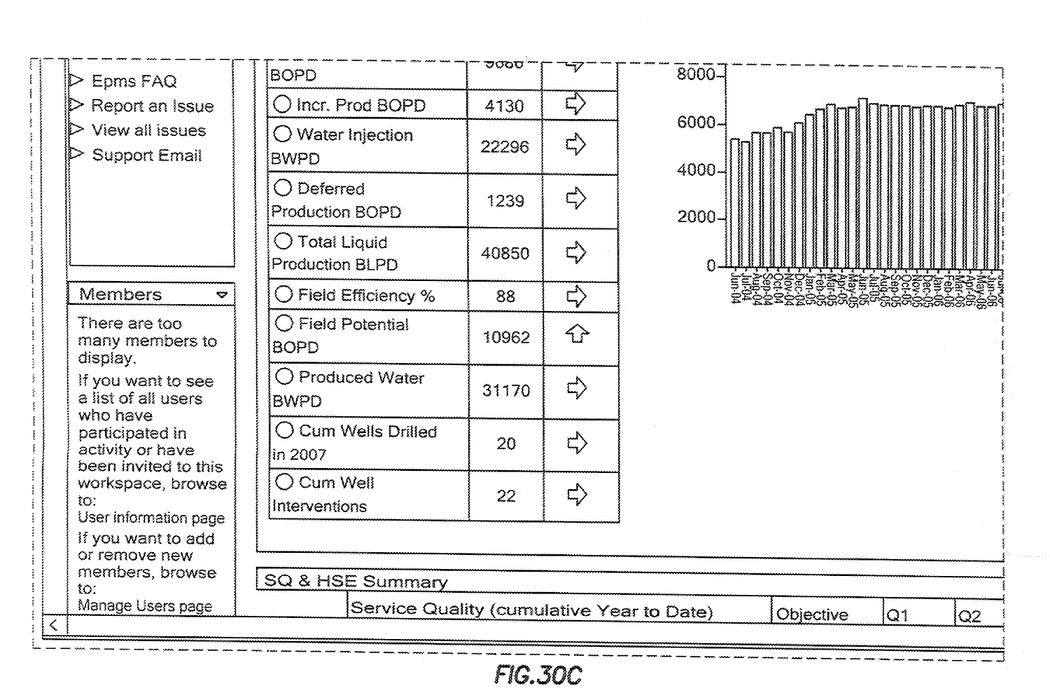

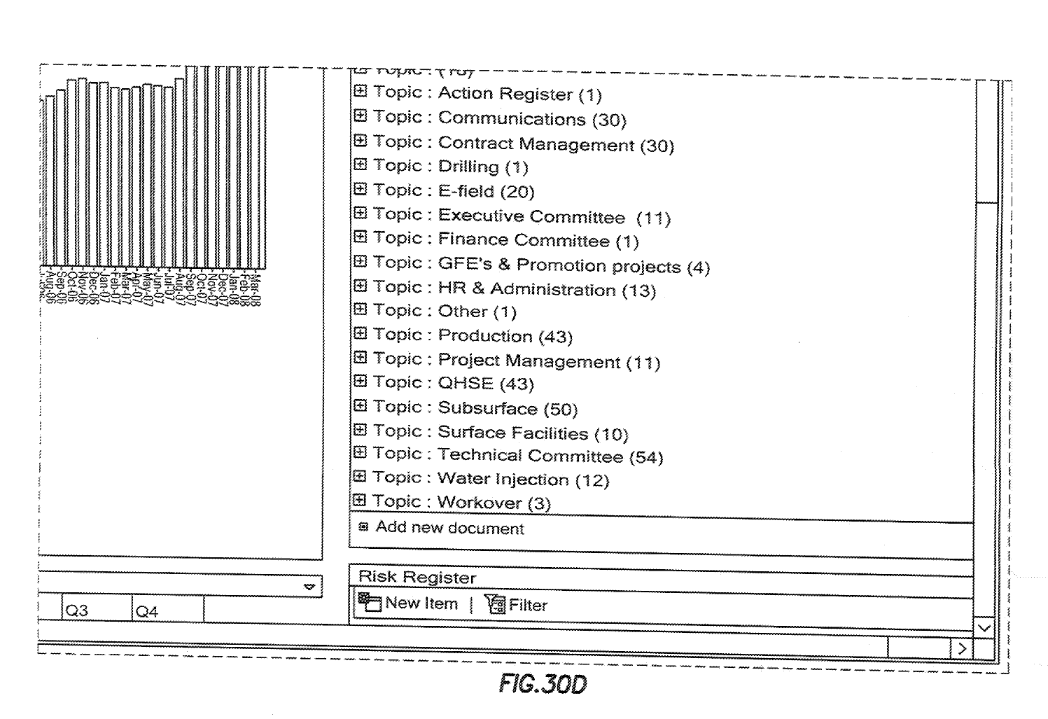

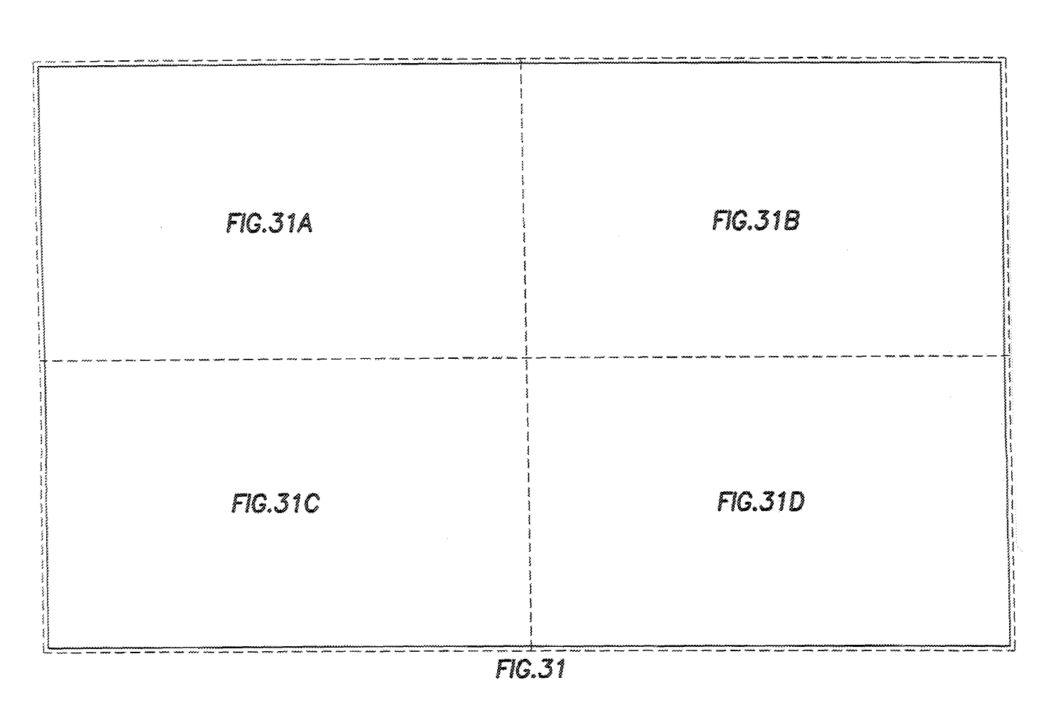

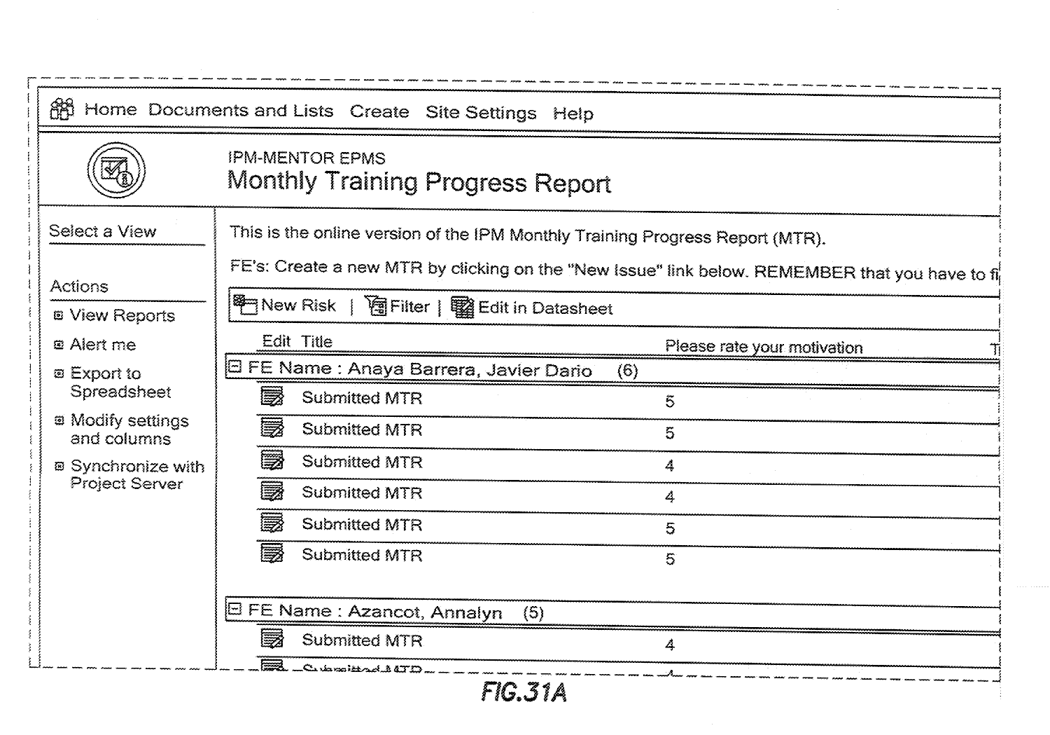

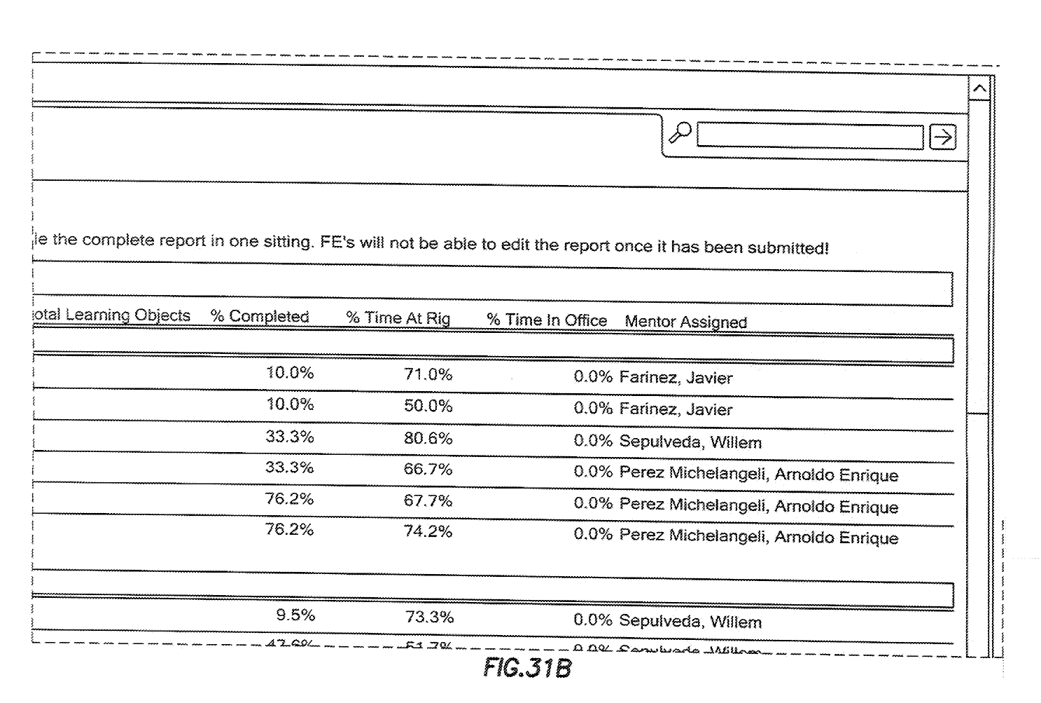

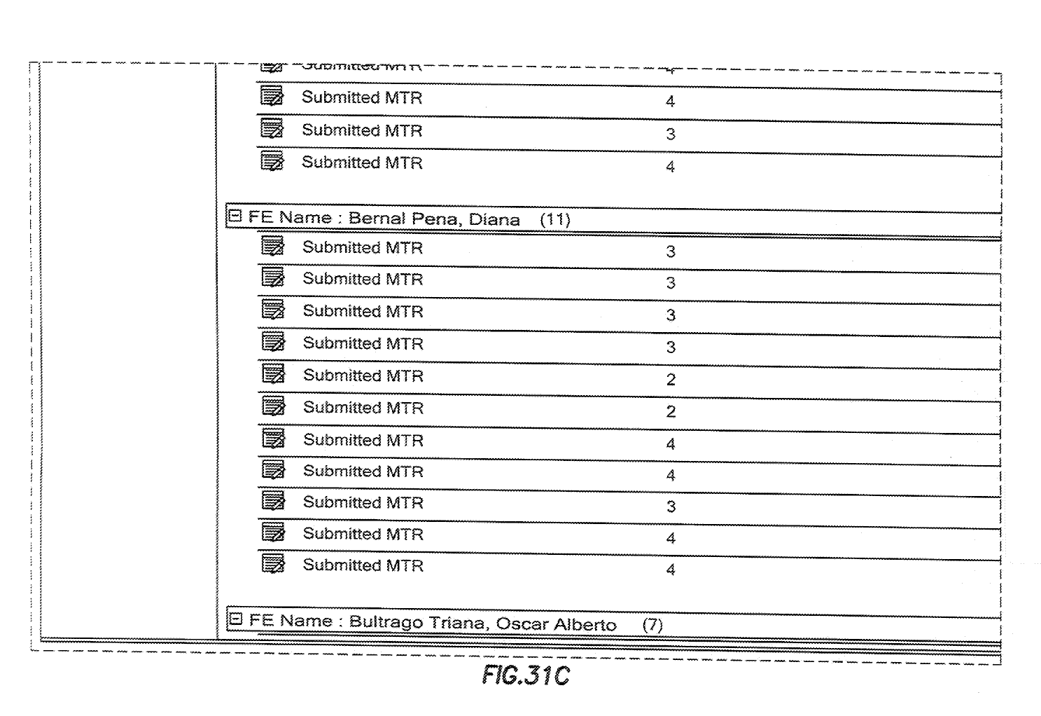

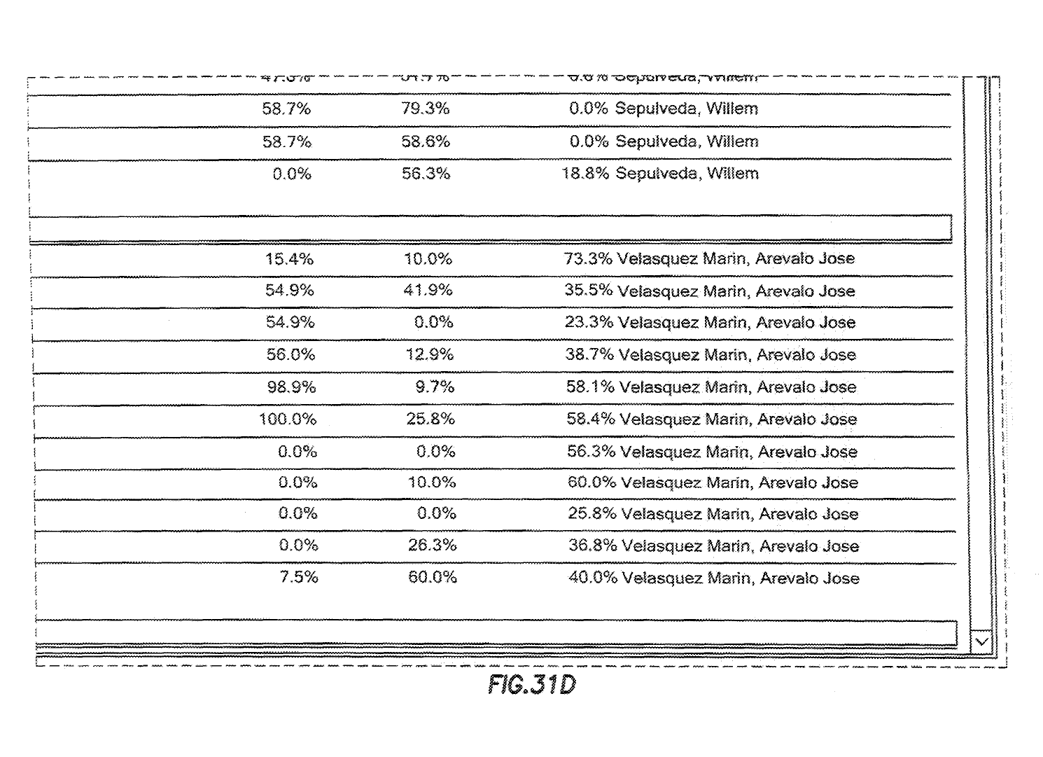

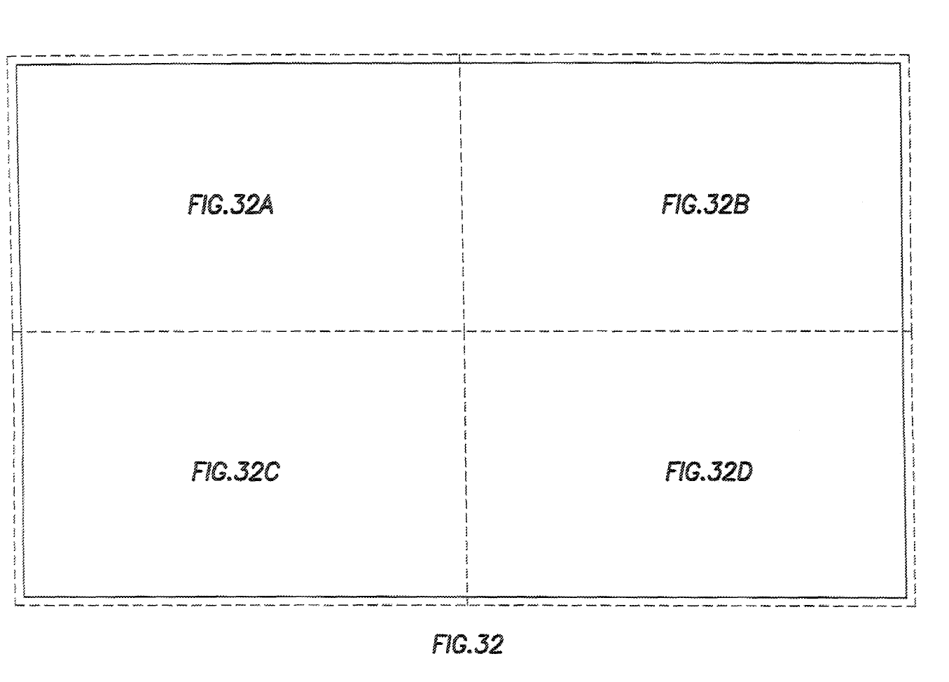

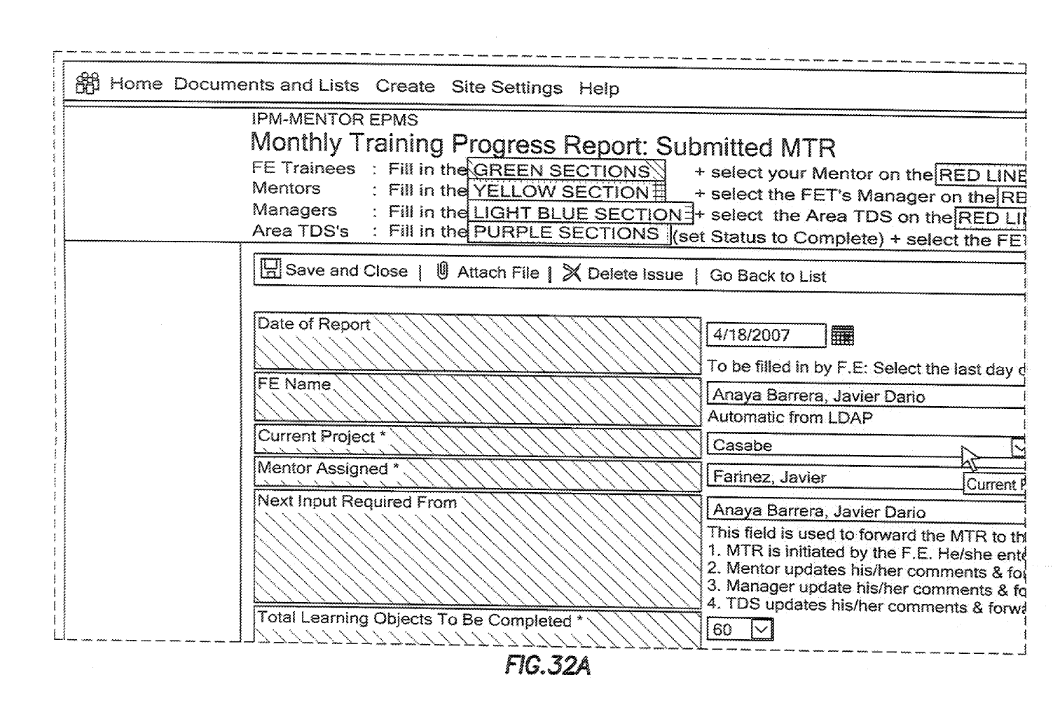

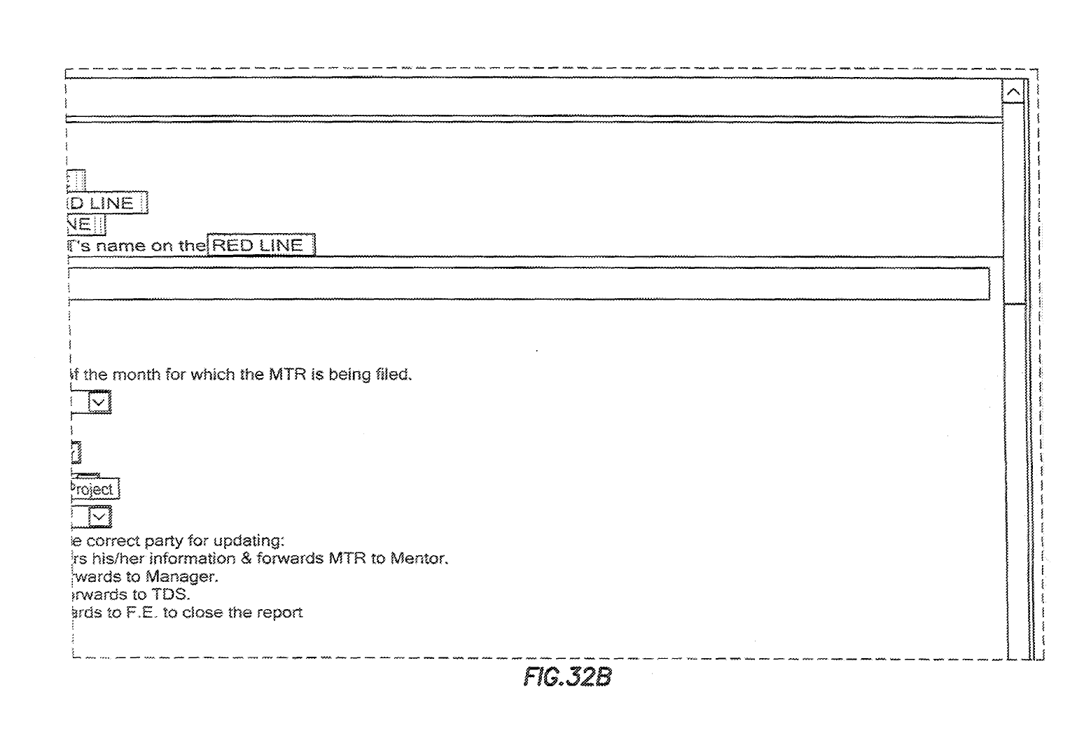

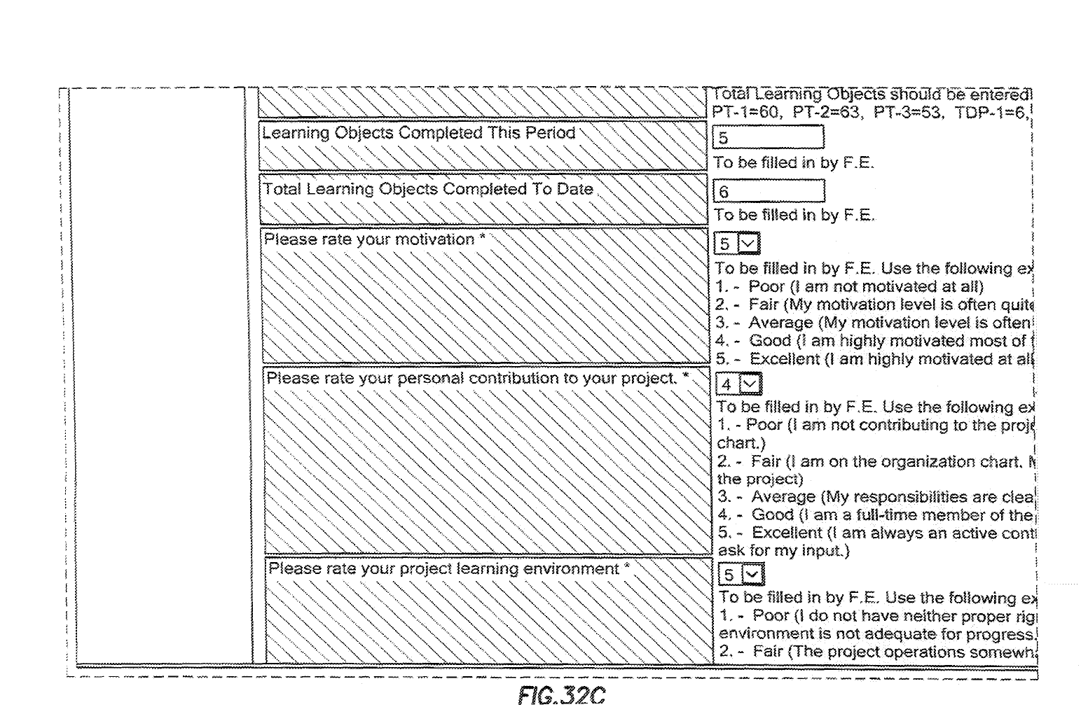

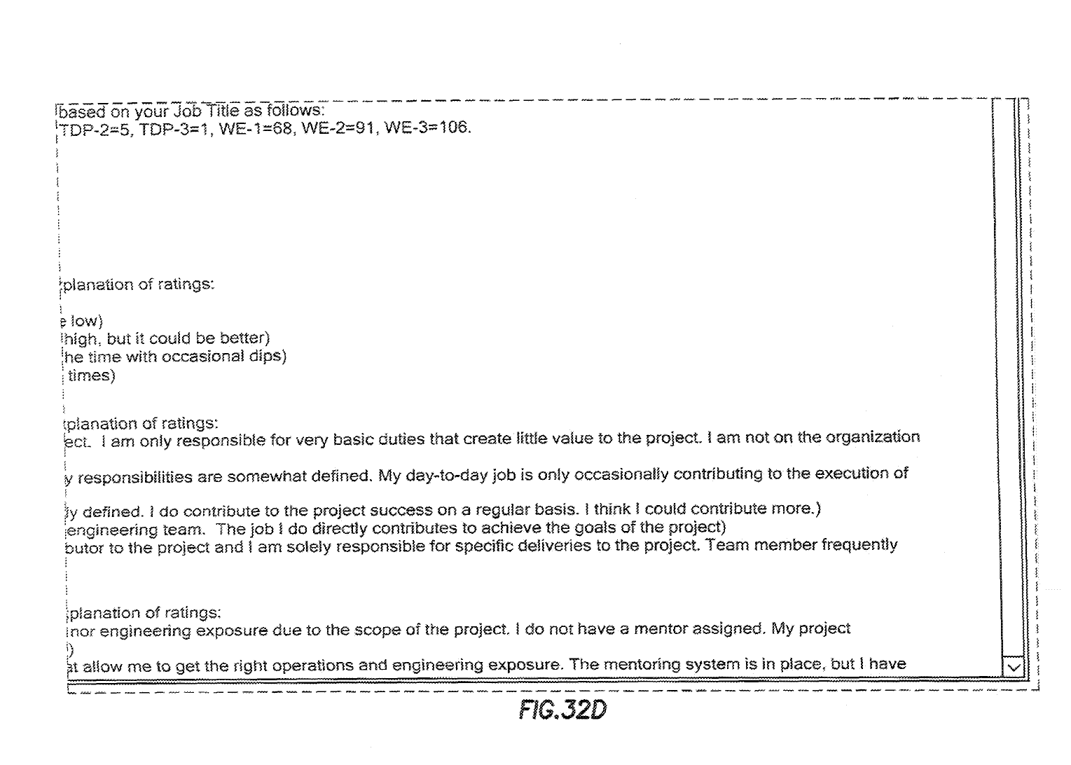

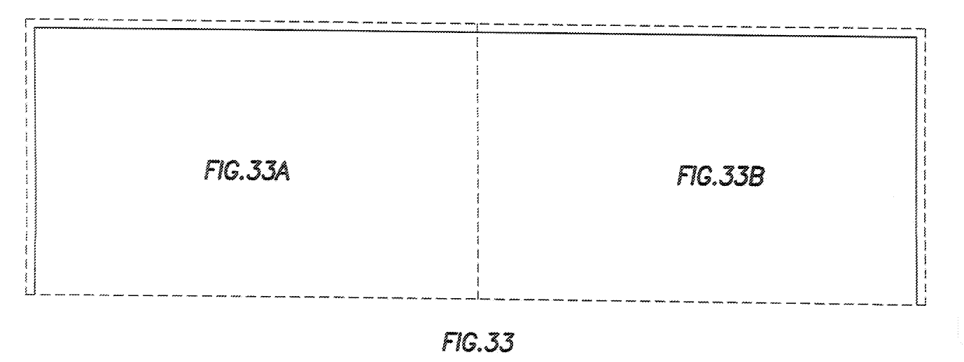

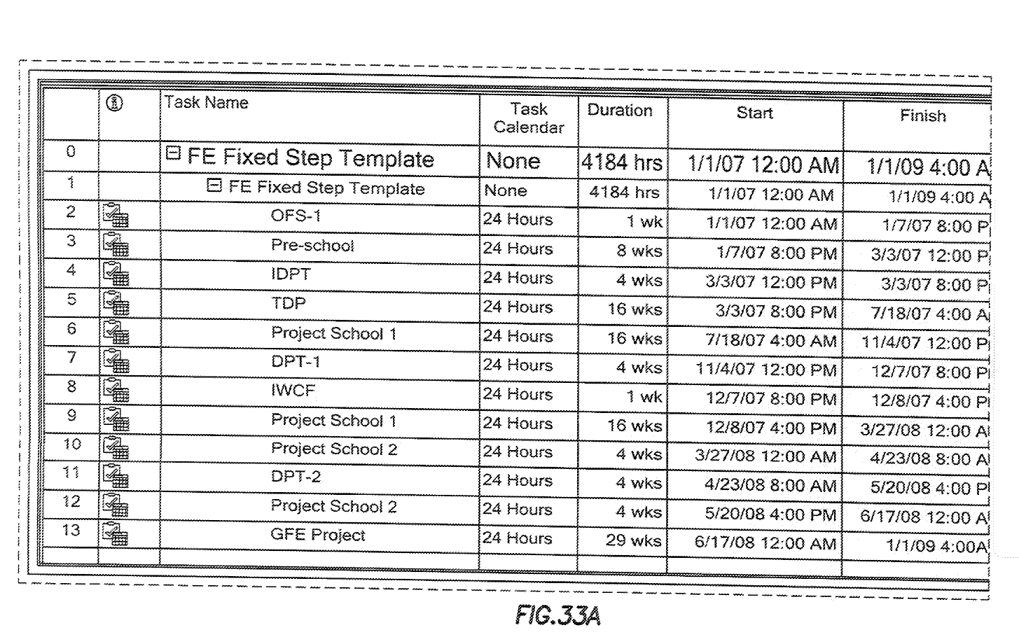

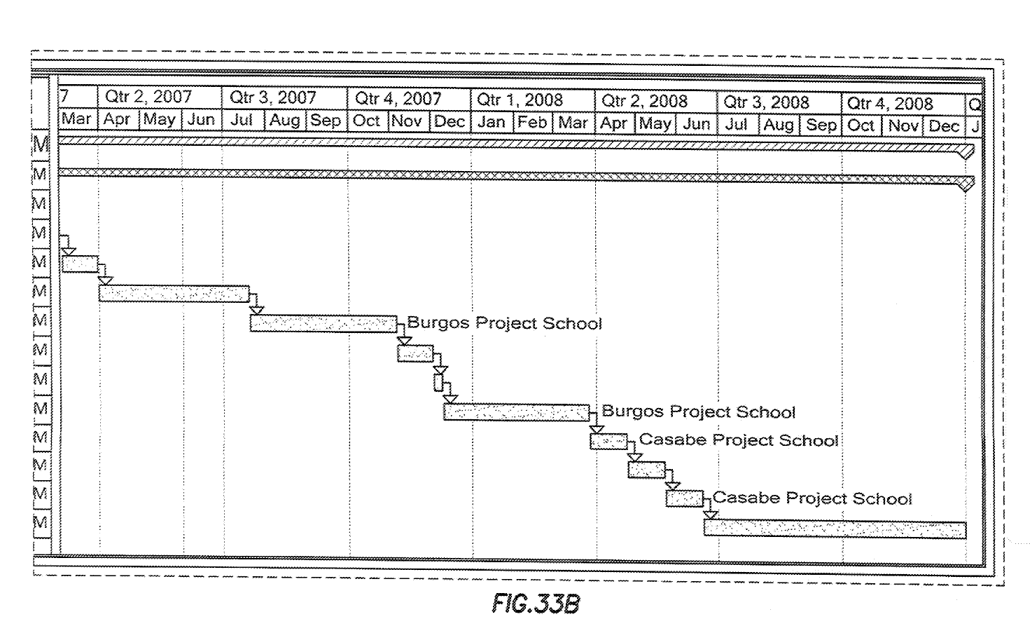

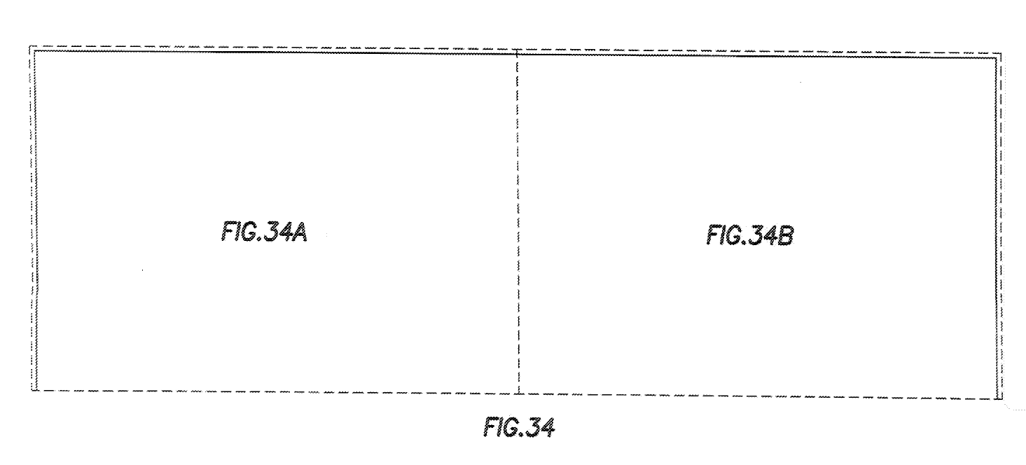

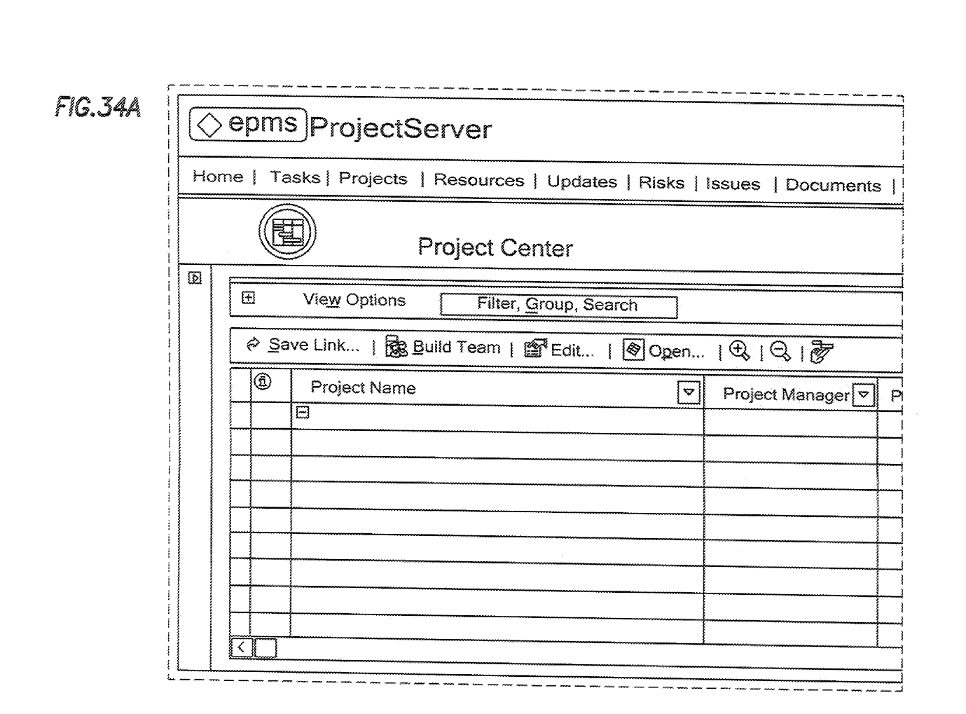

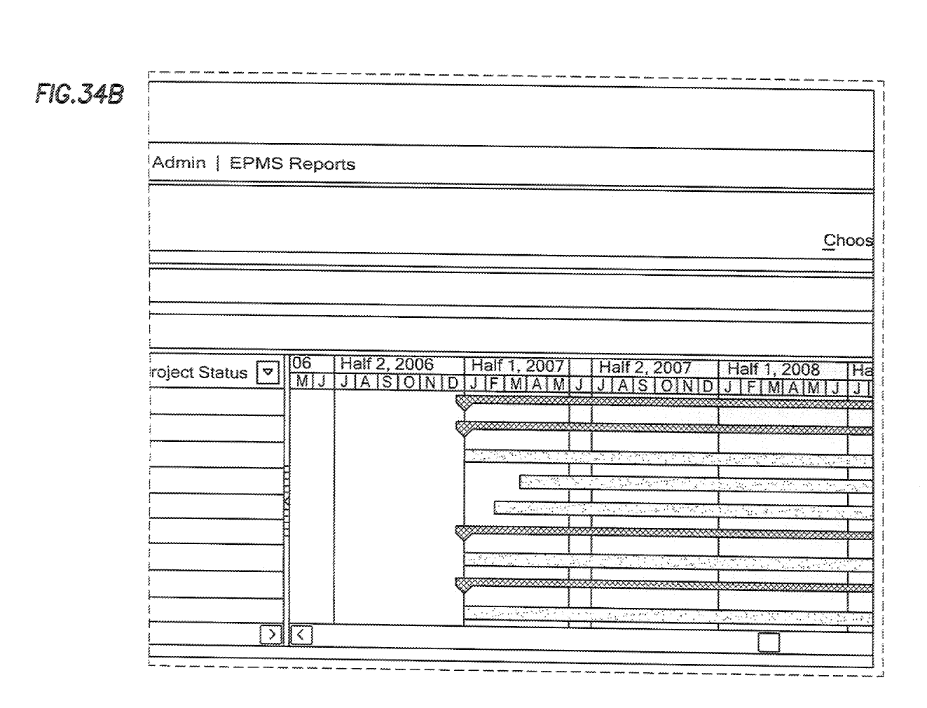

In the following discussion, it is understood that: (1) FIG. 6 includes FIGS. 6A, 6B, 6C, and 6D, (2) FIG. 7 includes FIGS. 7A, 7B, 7C, and 7D, (3) FIG. 8 includes FIGS. 8A, 8B, 8C, and 8D, (4) FIG. 9 includes FIGS. 9A, 9B, 9C, and 9D, (5) FIG. 10 includes FIGS. 10A, 10B, 10C, and 10D, (6) FIG. 11 includes FIGS. 11A, 11B, 11C, and 11D, (7) FIG. 12 includes FIGS. 12A and 12B, (8) FIG. 13 includes FIGS. 13A, 13B, 13C, and 13D, (9) FIG. 14 includes FIGS. 14A and 14B, (10) FIG. 15 includes FIGS. 15A, 15B, 15C, and 15D, (11) FIG. 16 includes FIGS. 16A and 16B, (12) FIG. 17 includes FIGS. 17A, 17B, 17C, and 17D, (13) FIG. 18 includes FIGS. 18A, 18B, 18C, and 18D, (14) FIG. 19 includes FIGS. 19A, 19B, 19C, and 19D, (15) FIG. 25 includes FIGS. 25A, 25B, 25C, and 25D, (16) FIG. 26 includes FIGS. 26A and 26B, (17) FIG. 27 includes FIGS. 27A and 27B, (18) FIG. 28 includes FIGS. 28A, 28B, 28C, 28D, 28E, 28F, 28G, and 28H, (19) FIG. 29 includes FIGS. 29A, 29B, 29C, 29D, 29E, and 29F, (20) FIG. 30 includes FIGS. 30A, 30B, 30C, and 30D, (21) FIG. 31 includes FIGS. 31A, 31B, 31C, and 31D, (22) FIG. 32 includes FIGS. 32A, 32B, 32C, and 32D, (23) FIG. 33 includes FIGS. 33A and 33B, and (24) FIG. 34 includes FIGS. 34A and 34B.

In the field, there are different functions involved in the delivery of oilfield projects, and, yet, management of the aforementioned projects was accomplished separately. During certain ‘coordination events’, coordination of these projects was accomplished verbally through the use of periodic meetings. The meetings were not necessarily held in real time. When any information was shared at these ‘coordination events’, the information was usually considered ‘out of date’ and, in addition, the different functions were operating on different time and schedule horizons. As a result, it would be desirable to provide ‘timely’ access to information that is ‘relevant’ to an individual's job or role in the project. The word ‘timely’ means that the information should be available to the team members of a project within a time frame that will ‘materially affect’ the outcome of the activity which is already underway. Given the different ‘disciplines’ involved in typical oilfield or other projects, an ‘integrated’ project planning approach would be very helpful. However, ‘integrated’ project plans usually entail a much higher project management burden and can create an overload of information. This, in turn, can create a situation where the project must rely on an individual team member's capabilities and experience in order to discern any relevant information and, responsive thereto, to take necessary actions. In addition, validating the information and understanding the inter-dependencies in such ‘integrated environments’ is often very problematic. Given the above mentioned reliance on the individual team member's capabilities and experience, inconsistent results were produced which limited how project teams could be ‘scaled up’ to handle bigger and more complex projects, and limited the ability to increase efficiency, where the term ‘efficiency’ is defined as the amount of time and cost necessary to successfully deliver a project.

In order to overcome these problems, a ‘Project Management System (PMS)’ is disclosed in this specification. The ‘Project Management System (PMS)’ supports the field personnel by: planning and managing projects of various sizes and types, in an integrated and intuitive manner; and facilitating collaboration among the project team as well as among a larger organization. The ‘Project Management System (PMS)’ disclosed in this specification is: (1) ‘Adaptable to a wide range of projects’, including turnkey drilling, gain-share production, completions segment tender development, and Engineer Trainee tracking applications, (2) ‘Scalable to fit every type of project’, wherein the PMS can be used in drilling projects ranging from 1-rig to 12-rig operations as well as in multi-year production projects (1 to 15 years), (3) ‘Has a very short learning curve’ where the framework and processes permit effective use of the system by new or junior field staff enabling them to be as proficient as more senior project managers is less time, and the system does not require specialized training in order to be used effectively, (4) ‘Supports consistent work practices’ through the use of ‘templates’ of various types which encapsulate knowledge and experience, the PMS disclosed herein enabling consistent, and therefore more reliable, project plans and communications/reporting mechanisms to be deployed and maintained in the field, and (5) ‘Provides better visibility into operations at all levels’, where Line-of-Sight (LOS) views provide ‘just the right’ kind of information to users in order to enable the users to plan, manage, and report their specific work effectively, the PMS, through the use of ‘templates’ and ‘supporting components’, keeping the overall project information ‘integrated’ and shielding the user from unnecessary information. The ‘Project Management System (PMS)’ disclosed in this specification will model project plans largely through the use of ‘templates’, where the ‘templates’ typically model ‘deliverables’ or ‘elements’ of the oil field projects, such as ‘candidate well selections’ or a ‘particular well to be drilled’. The ‘templates’ of the PMS disclosed herein include a built-in ‘intelligence’ which helps the users to manage more complex project plans with simplicity and greater consistency of results.

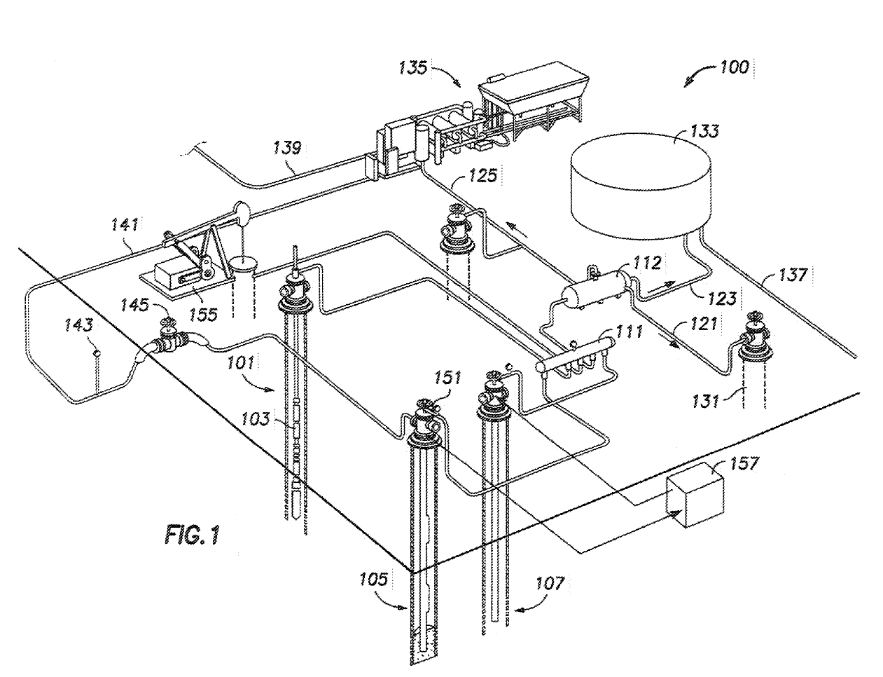

Referring now to FIG. 1, development of an oilfield 100 is depicted having machinery used to extract hydrocarbons (e.g., oil, gas, etc.) from downhole formations. An operations control center 157 may assist in collecting data and making decisions to enhance operations in the oilfield. Data, such as measurements of bottom hole pressure and tubing head pressure, may be gathered from the oilfield and analyzed.

In FIG. 1, the oilfield 100 includes a number of wells. Specifically, the oilfield 100 includes a first producing well 101 that uses an electric submersible pump 103 to produce a hydrocarbon (e.g., oil, gas, etc.), a second well 105 relies on a gas lift to produce a hydrocarbon, and a third well 107 that relies on natural flow to produce a hydrocarbon. First producing well 101, second well 105, and third well 107 deliver production fluids (e.g., hydrocarbon) produced from their respective wells to a production manifold 111. The production manifold 111 collects multiple streams and outputs the streams to a gas and oil separator 112.

Upon receipt of the production fluids by the gas and oil separator 112, the gas and oil separator 112 separates various components from the fluids, such as produced water 121, produced oil 123, and produced gas 125, respectively to water disposal well 131, oil storage 133, and a compressor station 135. Oil storage 133 may transfer oil via an oil export pipeline 137. Similarly, the compressor station 135 may use gas export pipeline 139 to transfer gas. Finally, the compressor station 135 may process gas as an injection gas 141. In order to adjust pressure on the injection gas, a meter and control system 143 may cooperate with an injection-gas manifold 145. The operation of the meter and control system 143 may regulate pressure of the injection gas as the injection gas is delivered to a wellhead tubing and casing 151. In addition to the injection gas, extracting efforts may rely upon a rod pump 155 to drive a downhole pump assembly via a reciprocating motion. In such cases, the rod pump 155 propels hydrocarbons to the production manifold 111.

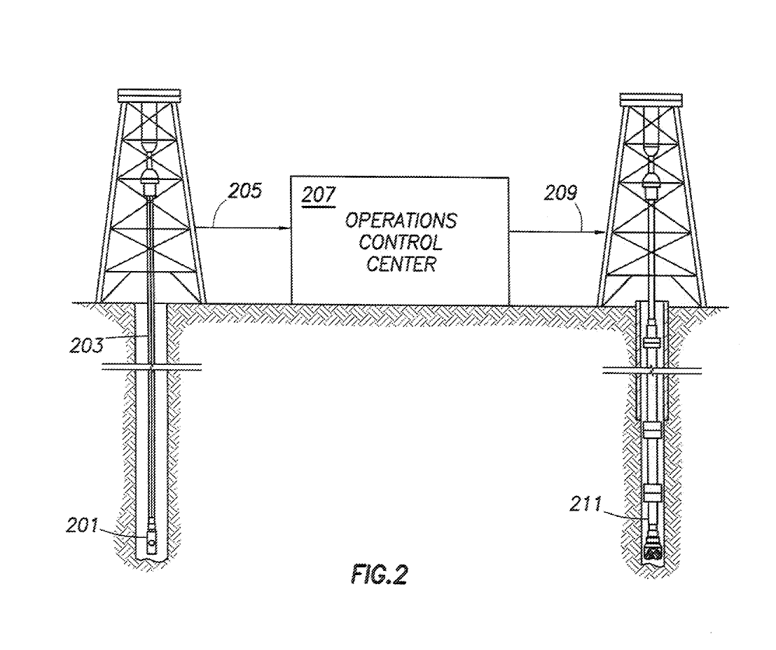

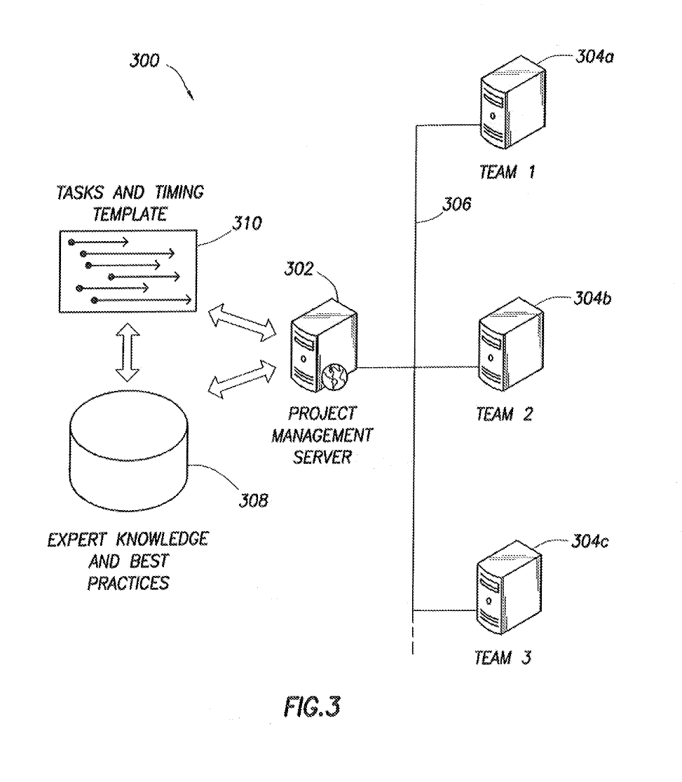

Referring to FIG. 2, in one example, the operations control center 157 may receive data from sensors positioned throughout the oilfield 100. Examples of sensors are depicted and described in further detail with respect to FIG. 2 and described further below. The operations control center 157 may also operate and/or control equipment in the third well 107. FIG. 2 shows a portion of a wellbore operation, such as the wellbore operation of FIG. 1, in greater detail. FIG. 2 depicts the cooperation of an operations control center 207 with at least two wells. As discussed above, one purpose of the operations control center 207 is to collect data and control a drilling operation. Down-hole sensors 201 and well-head sensors 203 provide data (i.e., data collected and/or otherwise obtained from the down-hole sensors 201 and/or the well-head sensors 203). Upon receipt of the data, a first communication link 205 transfers the aforementioned data to the operations control center 207. Data may also be collected from other sources, and/or sent to other sites not depicted. Such data may be historical, real time, or stored data. The operations control center 207 stores, and, in some cases, optionally processes and/or analyzes the data. In some cases, the operations control center 207 may also generate and transmit control signals via a second communication link 209 to a down-hole apparatus 211. For example, the operations control center 207 may automatically generate control signals using data obtained via the first communications link 205. In another example, the operations control center 207 may provide information to an operator that may consider the information, and then send control signals as desired. In addition, the operations control center 207 may also provide feedback to the down-hole sensors 201 and/or three well-head sensors 203 using data obtained via the first communications link 205.

As may be readily seen from the above, oilfield development projects are extremely complicated and complex endeavors that require a multi-discipline team to design and execute. Over time, a large body of expert knowledge and best practices has been developed from past successful completion of such oilfield development projects. It would be useful to be able to apply this body of expert knowledge and best practices to both new and existing oilfield development projects. Currently, the expert knowledge and best practices are captured in documents that are made available through databases and information-sharing portals. However, there is no way to systematically and deliver and facilitate implementation of selective, task-specific expert knowledge and best practices by project personnel. In addition, there is no reliable, integrated project management environment that may be used by the project personnel for managing the oilfield development projects.

This specification discloses a ‘Project Management System (PMS)’ that overcomes the drawbacks and shortcomings of existing solutions. The ‘Project Management System’ provides a framework for systematically delivering and implementing existing expert knowledge and best practices. Such an arrangement helps oilfield development project personnel produce a consistent oilfield development product. The expert knowledge and best practices that may be delivered include, for example, an array of task specific workflows that guide the users in detail from data input requirements through recommended software application usage and ultimately to task-specific deliverables. The ‘Project Management System’ may be used to carry out existing oilfield development planning and execution processes as well as new processes that are developed over time.

The ‘Project Management System’ disclosed herein may be used to guide a multi-discipline project team to successfully design and carry out an oilfield development project by integrating knowledge management and project execution. The ‘Project Management System’ provides a standardized project workflow template accessible for monitoring and updating purposes. In addition, the ‘Project Management System’ assists in project planning through scope management, task scheduling, cost analysis, resource allocation, risk assessment and contract finalization. Improved quality and effectiveness of peer reviews are achieved through use of the ‘Project Management System’, as well as automating and streamlining of internal and/or external procedures. The ‘Project Management System’ may also be used to support centralized database storage of all oilfield development projects, including making the databases available to assist with future oilfield development projects. Workflow support through every level of the oilfield development process may be provided, including detailed task recommendations via direct access to relevant process document material, lessons learned (preferably through knowledge-sharing portals), best practices (preferably via live links to databases), and oilfield development project tasks, captured database tips and history. Other benefits of the ‘Project Management System’ include a mechanism to track efficiencies and identify process improvements for users. The ‘Project Management System’ is designed to follow existing project approval procedures. The procedures may be refined and designed within the project planning and execution tool so as to be automatically adhered to by personnel for each project, thus ensuring consistency and accountability for all oilfield development planning projects performed. The combination of expert knowledge and best practices gained through previous endeavors plus the automated project management features, built specifically around the knowledge and best practices, provide significant advantages over existing solutions.

Furthermore, all technical peer review requirements and operational review requirements may be made available to all involved personnel throughout the life of the oilfield development project. This helps ensure that each project benefits from the knowledge gained from previous studies, and allows the ‘Project Management System’ to serve as a network for tracking efficiencies and process improvements.

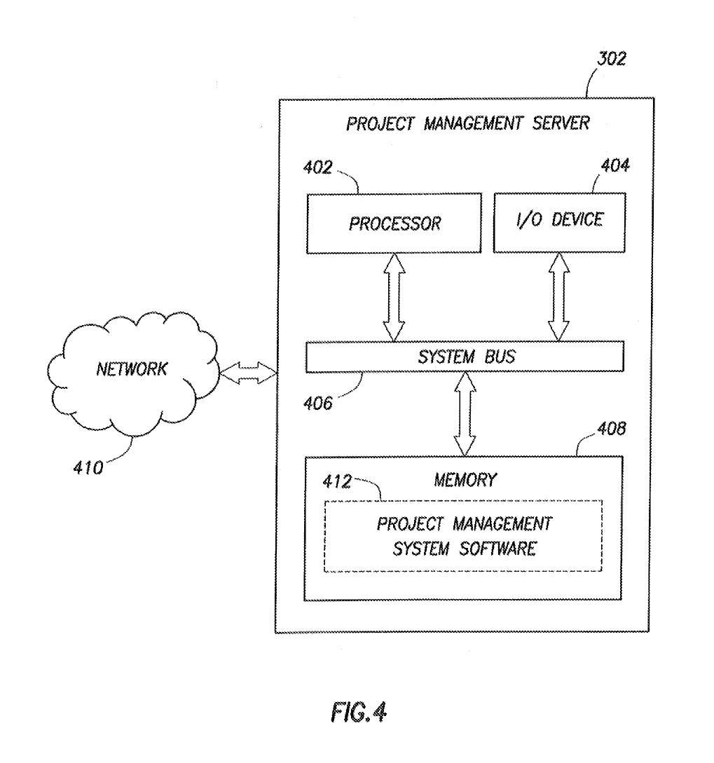

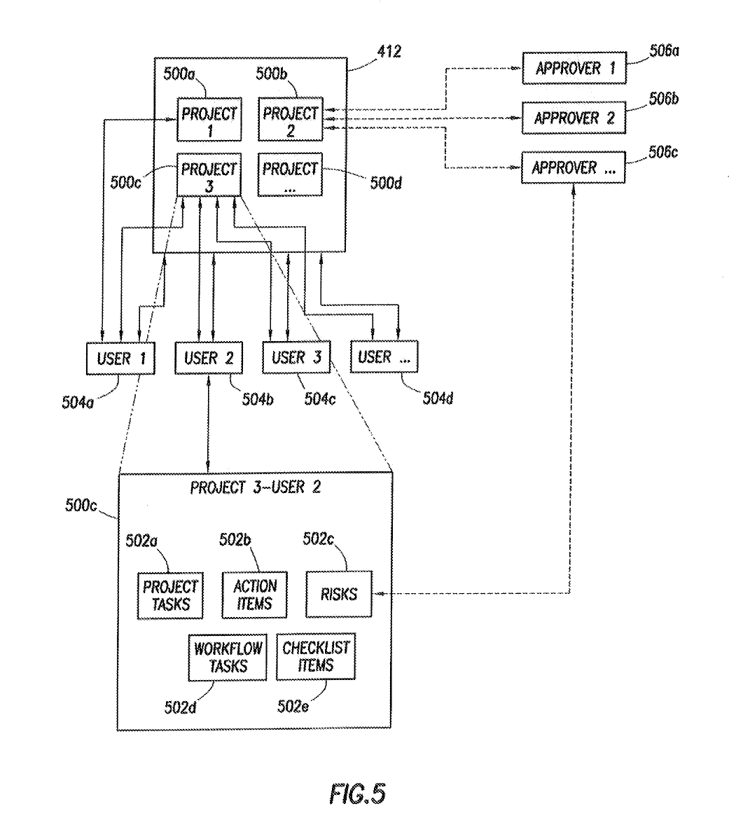

Referring to FIGS. 3 and 4, the ‘Project Management System (PMS)’ disclosed in this specification is illustrated.

In FIG. 3, an exemplary ‘Project Management System (PMS)’ 300 is illustrated. As may be seen, the ‘Project Management System’ 300 includes at least one project management server 302 from which one or more oilfield development projects may be planned and managed on a global basis. Oilfield development project teams 304a, 304b, and 304c (e.g., Teams 1-3, etc.) in different geographical locations and/or business units may then connect to the project management server 302 and access the various projects thereon. Members of the teams 304a-c may then view various tasks for a given project, access any expert knowledge and best practices associated with each task, update and/or complete the tasks, assign and/or create new tasks, request peer review and approval for certain tasks, and the like. The connection to the server 302 may be accomplished using any suitable wired and/or wireless connection 306 to a global network, such as the Internet and the World Wide Web (the “Web”). In the latter case, the project management server 302 may be a Web server that is capable of hosting one or more Web pages.

One or more repositories 308 of expert knowledge and best practices are connected to the project management server 302. Such repositories 308 may take any suitable form, including information databases, knowledge-sharing portals, industry association Web sites, and the like, and may be implemented using, for example, Microsoft SharePoint Server™, and the like. The repositories 308 contain expert knowledge and best practices that have been accumulated over time for numerous successfully completed oilfield development projects as well as lessons learned from less successful projects. Because the volume of information in these repositories 308 can be quite large (e.g., hundreds of pages), oilfield development project personnel may be reluctant to make use of the information. To this end, the project management server 302 organizes, arranges, and delivers selective, task-specific information in a form that is simple and convenient for the oilfield development personnel to use.

The expert knowledge and best practices may also be used to define a core set of tasks that needs to be performed in an oilfield development project and the timing for each task. Such tasks and timing may be defined, for example, using Microsoft Project Server™, and the like. These tasks and timing may then be stored as a sort of ‘template’ 310 that is provided to the project management server 302 for use with all subsequent oilfield development projects. As with the expert knowledge and best practices information, the project management server 302 organizes, arranges, and delivers the tasks and timing information in a form that is easy and convenient for the oilfield development personnel to use.

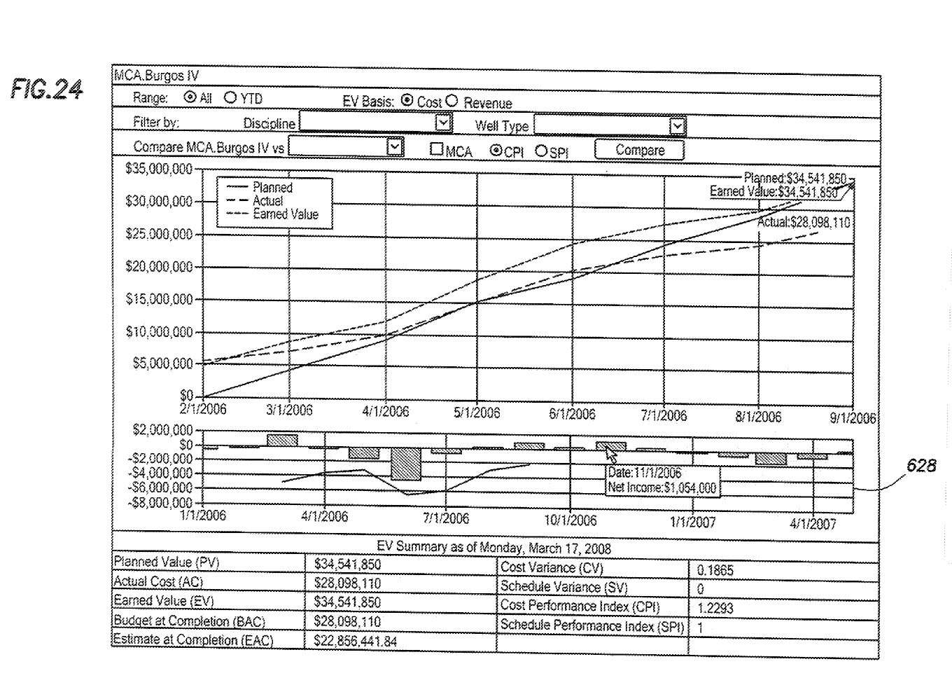

In FIG. 4, an example of the project management server 302 of FIG. 3 is illustrated in greater detail, wherein the server 302 stores a ‘Project Management System software’ 412. As may be seen, the project management server 302 of FIG. 4 may be, among other things, a personal computer (PC), a server (e.g., a Web server), a workstation (e.g., a Sun Microsystems workstation), two or more networked workstations, a mainframe computer, and the like. In the example shown, the project management server 302 has a number of functional components, including at least one processor 402, an input/output (I/O) unit 404, a system bus 406, and a computer-readable memory 408. The input/output (I/O) unit 404 may be, for example, a ‘recorder or display device’ adapted for recording or displaying an ‘output display’, such as the ‘output displays’ that are illustrated in FIGS. 6 through 34 of the drawings. A detailed discussion and description of the ‘output displays’ illustrated in FIGS. 6 through 34 will be provided later in this specification. A network 410 connects the project management server 302 to other networks, systems, databases, computers, and the like. These components of the project management server 302 are generally well known to those having ordinary skill in the art and therefore will not be described in great detail here. Furthermore, although multiple discrete components are shown in FIG. 4, those having ordinary skill in the art will understand that two or more of these components may be combined into a single component, and that a single component may be divided into several sub-components, as needed.

Briefly, in FIG. 4, the processor 402 is responsible for the overall operation of the project management server 302, including execution of the operating system software and any other software applications that may be present on the project management server 302. The I/O unit 404 controls the flow of data into and out of the project management server 302, for example, through various media reader devices and output devices. The system bus 406 allows the various functional components of the project management server 302 to communicate and exchange data with one another. The computer-readable memory 408, which may be a magnetic, optical, and/or semiconductor memory, provides temporary and long-term storage for any information or data needed by the operating system and applications running on the project management server 302. Finally, the network 410 may be an Ethernet-based wired and/or wireless network for connecting the project management server 302 to other networks, systems, databases, and the like.

In FIG. 4, a ‘project management system software’ 412 may be stored in the computer-readable memory 408. The ‘project management system software’ 412 may then be executed by the processor 402 and/or other components for delivering and implementing expert knowledge and best practices from the repositories 308 of FIG. 3 to the oilfield development project personnel. The ‘project management system software’ 412 associates or otherwise makes available specific expert knowledge and best practices with each task to be performed in an oilfield development project. In addition, the ‘project management system software’ 412 provides an integrated project management environment that may be used by such personnel for the overall planning and execution of the oilfield development projects, thereby ensuring consistent results from project to project. Indeed, in one sense, the ‘project management system software’ 412 itself is a manifestation or implementation of the expert knowledge and best practices accumulated over time such that by simply using the ‘project management system software’ 412, the oilfield development personnel are also using the expert knowledge and best practices.

Referring to FIG. 5, one operation of the ‘project management system software’ 412 of FIG. 4 is illustrated. As may be seen, the ‘project management system software’ 412 stores and maintains a plurality of oilfield development projects 500a, 500b, 500c, and 500d (i.e., Projects 1-3, etc.) on the project management server 302. Typically, each oilfield development project 500a-e comprises a number of project actions, including numerous project tasks 502a to be performed, various action items 502b to be completed, risks 502c to be assessed, workflow tasks 502d to be monitored, and checklist entries 502e to be signed off. In general, project tasks are technical tasks to be followed from developed procedures and best practices to perform a technically proper field development plan. Workflow tasks, on the other hand, are approval tasks required in the overall process to ensure technical tasks have been honored according to procedures and best practices. These project actions 502a-e are shown in the expanded view (dashed lines) of the third oilfield development project 500c (i.e., Project 3). In one preferred embodiment, the project actions 502a-e (or the detailed information therefor) may be generated and stored using, for example, Microsoft Project Server™ and/or Microsoft SharePoint Server™, then linked to or otherwise made accessible through the ‘project management system software’ 412.

In addition to the oilfield development project actions 502a-e, each oilfield development project 500a-d also may have a plurality of users 504a, 504b, 504c, and 504d (i.e., Users 1-3, etc.) and a plurality of reviewers and/or approvers 506a, 506b, and 506c (i.e., Approvers 1-3, etc.) assigned thereto. These users 504a-d and approvers 506a-c are usually assigned by the project owners, team leaders, and/or other users 504a-d and approvers 506a-c via the ‘project management system software’ 412. In some cases, the users 504a-d for some oilfield development projects 500a-d may also be approvers 506a-c (and vice versa) for the same oilfield development projects and/or for different oilfield development projects 500a-d. Once assigned, each user 504a-d and approver 506a-c may be given an appropriate level of authorization to access the ‘project management system software’ 412 and the projects 500a-d to which he/she has been assigned.

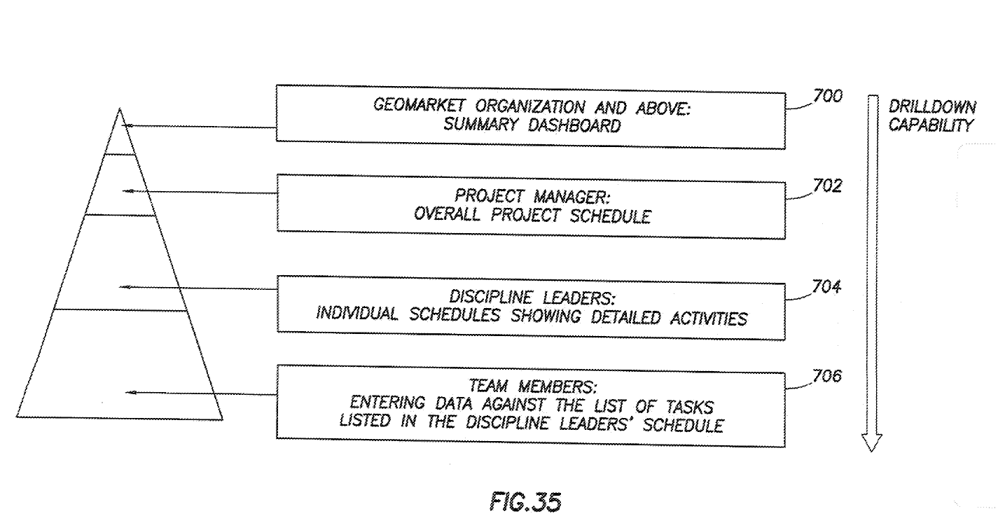

Referring to FIG. 35, a detailed definition of the term ‘Line-of-Sight (LOS)’ is illustrated. The term ‘Line-of-Sight’ or ‘LOS’ will be used frequently in the remaining paragraphs of this specification. In FIG. 35, a diagram illustrates a definition of a ‘Line-of-Sight (LOS)’ approach. The term ‘Line-of-Sight (LOS)’ is a term which refers to the act of viewing information at the level of details appropriate to one's role, or filtering-out certain information based on the discipline of the viewer. In FIG. 35, when managing the disclosure information to others “only at a level of detail required for one's role”, there exists four possible levels of information to which a person should have access: (1) a first level of information 700 which represents ‘summary information’ that would be given, for example, to a ‘geomarket organization’ and above; for example, a summary ‘dashboard’ of information and indicators would be given to the ‘geomarket organization’, (2) a second level of information 702 which represents ‘additional information in addition to the first level of information 700’ that could be given to a project manager; for example, a overall project schedule could be given to the project manager, (3) a third level of information 704 which represents ‘additional information in addition to the second level of information 702’ that could be given to discipline leaders; for example, individual schedules showing detailed activities could be given to the discipline leaders, and (4) a fourth level of information 706 which represents ‘additional information in addition to the third level of information 704’ that could be given to team members; for example, a list of tasks listed in a discipline leader's schedule would be given to team members and the team members would ‘enter data against the list of tasks listed in the discipline leader's schedule’.

### DETAILED DESCRIPTION

In FIGS. 3 and 4, the ‘Project Management System (PMS)’ of FIG. 3 includes the Project Management Server 302. The Project Management Server 302 includes the ‘Project Management System software’ 412 of FIG. 4, the processor 402, and the I/O device 404. In FIG. 4, when the processor 402 of the Project Management server 302 of FIG. 4 executes the ‘Project Management System software’ 412, one or more ‘output displays’ are generated and are either recorded or displayed on the ‘recorder or display device’ 404, which is represented by the I/O Device 404 illustrated in FIG. 4.

Referring to FIGS. 6 through 34, the ‘output displays’ that are generated and either recorded or displayed on the ‘recorder or display device’ associated with the I/O device 404 of FIG. 4 are illustrated in FIGS. 6 through 34 of the drawings.

In FIGS. 3, 4, and 6 through 34, the following terms are used throughout the following description of the ‘Project Management System’ of FIGS. 3, 4, and 6 through 34 and the ‘Project Management System software’ 412 of FIG. 4. A definition of each of the terms is set forth below, as follows:

The term ‘Project’ refers to a sequenced collection of tasks logically grouped together and which may span one or more disciplines required in the oil field;

The term ‘Discipline’ refers to a category of function or activity performed in the field; Examples of disciplines used in oil field projects include Drilling, Completions, Civil Works, Flowline Construction, Facilities, Seismic Studies, Reservoir Studies, etc;

The term ‘Function’ refers to the role of an individual or a team within a project or other group; Functional roles include Project Manager, Drilling Engineer, Operations (Project Portfolio) Manager, etc;

The term ‘Efficiency’ refers to the Amount of effort to successfully complete a project. Effort is measured in time and money;

The term ‘Line-of-Sight (LOS)’ refers to a limited or filtered view of project elements based on the viewers role or function in the project; The purpose of ‘line-of-sight’ views is to prevent the user from becoming overwhelmed by the vast information presented, to help the user focus on their particular role-related function, to present the data in a manner intuitive to typical users in that role; ‘Line-of-sight’ is also used for data entry to minimize the opportunities for error in data entry by limiting the data they can effect to only that relevant to their role; and

The term ‘Operational Earned Value (OpEV)’ refers to the Earned Value method as developed in this specification to meet oil field tracking, planning, & reporting needs.

Recall that, in the field, there are different functions involved in the delivery of oilfield projects, and, yet, management of the aforementioned projects was accomplished separately. During certain ‘coordination events’, coordination of these projects was accomplished verbally through the use of periodic meetings. The meetings were not necessarily held real time. When any information was shared at these ‘coordination events’, the information was usually considered ‘out of date’ and, in addition, the different functions were operating on different time and schedule horizons. It would be desirable to provide ‘timely’ access to information that is ‘relevant’ to an individual's job or role in the project. The word ‘timely’ means that the information should be available to the team members of a project within a time frame that will ‘materially affect’ the outcome of the activity which is already underway. Given the different ‘disciplines’ involved in typical oilfield or other projects, an ‘integrated’ project planning approach would be very helpful. However, ‘integrated’ project plans usually entail a much higher project management burden and can create an overload of information. This, in turn, can create a situation where the project must rely on an individual team member's capabilities and experience in order to discern any relevant information and, responsive thereto, to take necessary actions. In addition, validating the information and understanding the inter-dependencies in such ‘integrated environments’ is often very problematic. Given the above mentioned reliance on the individual team member's capabilities and experience, inconsistent results were produced which limited how project teams could be ‘scaled up’ to handle bigger and more complex projects, and limited the ability to increase efficiency, which is defined as the amount of time and cost necessary to successfully deliver a project.

‘Project Management tools’ (hereinafter, ‘PM tools’) have been focused on management of individual projects, and the extent of ‘rollups’ was very limited. Furthermore, these PM tools did not provide details at the right level. Most of these PM tools provided a narrow view of how to manage projects. In addition, the PM tools offered no concrete solutions in process, method, or tool in order to support an ‘integrated’ Project Management (PM) that does not also require centralized management. In addition, these PM tools existed to support large scale integrated development and required one or more dedicated resources (e.g., specialized project managers at a minimum) whose sole job was to manage the inputs and outputs to the PM tools. This was not extensible in the field. These PM tools also required a very high level of expertise to use effectively, which is a ‘show-stopper’ given the shortage of experienced staff and the younger, less experienced field personnel.

Accordingly, a ‘new and novel Project Management System’ is needed.

As a result, in FIGS. 3, 4, and 6 through 34, a ‘new and novel Project Management System (PMS)’ is disclosed in this specification. The ‘new and novel Project Management System (PMS)’ of FIG. 3 includes the ‘Project Management System software’ 412 of FIG. 4, and, when the ‘Project Management System software’ 412 is executed by processor 402 of FIG. 4, a set of novel ‘output displays’ are generated that are adapted to be utilized by the field personnel. The ‘Project Management System’ of FIGS. 3 and 4 will support the field personnel by: planning and managing projects of various sizes and types, in an integrated and intuitive manner, and facilitating collaboration among the project team as well as among a larger organization. The ‘Project Management System (PMS)’ disclosed in this specification is: (1) ‘Adaptable to a wide range of projects’, including turnkey drilling, gain-share production, completions segment tender development, and Engineer Trainee tracking applications, (2) ‘Scalable to fit every type of project’, wherein the PMS can be used in drilling projects ranging from 1-rig to 12-rig operations as well as in multi-year production projects (1 to 15 years), (3) ‘Has a very short learning curve’ where the framework and processes permit effective use of the system by new or junior field staff enabling them to be as proficient as more senior project managers is less time, and the system does not require specialized training in order to be used effectively, (4) ‘Supports consistent work practices’ through the use of ‘templates’ of various types which encapsulate knowledge and experience, the PMS disclosed herein enabling consistent, and therefore more reliable, project plans and communications/reporting mechanisms to be deployed and maintained in the field, and (5) ‘Provides better visibility into operations at all levels’, where ‘Line-of-Sight (LOS)’ views provide ‘just the right’ kind of information to users in order to enable the users to plan, manage, and report their specific work effectively. The PMS of FIGS. 3, 4, and 6 through 37 disclosed herein, through the use of ‘templates’ and ‘supporting components’, keeps the overall project information ‘integrated’ and shields the user from unnecessary information. The ‘Project Management System (PMS)’ disclosed in this specification will model project plans largely through the use of ‘templates’, where the ‘templates’ typically model ‘deliverables’ or ‘elements’ of the oil field projects, such as ‘candidate well selections’ or a ‘particular well to be drilled’. The ‘templates’ of the PMS disclosed herein include a built-in ‘intelligence’ which helps the users to manage more complex project plans with simplicity and greater consistency of results.

The ‘Project Management System (PMS)’ of FIGS. 3, 4, and 6 through 34 includes the following new and novel ‘features’ or ‘characteristics’:
(1) a Scalable Framework,
(2) Line-of-Sight (LOS) access to Information,
(3) Line-of-Sight (LOS) views of information and project status,
(4) Line-of-Sight (LOS) Visibility for Earned Value (a project performance metric),
(5) Line-of-Sight (LOS) filtered data entry/project statusing, and
(6) Line-of-Sight (LOS) Resource Management.

Each of the above referenced ‘features’ or ‘characteristics’ (1) through (6) of the ‘Project Management System (PMS)’ of FIGS. 3, 4, and 6 through 34 will be discussed individually below in the following paragraphs of this specification.

### (1) Scalable Framework

The ‘Project Management System (PMS)’ illustrated in FIGS. 3, 4, and 6 through 34 provides a ‘Scalable Framework’ for the planning and execution of multi-disciplinary projects. The framework is termed ‘scalable’ because: (a) it can be applied to different sizes of projects, (b) it gives the user ‘flexibility’ to track a ‘little data’ for ‘lots of projects’ or ‘lots of data’ for ‘one or a few project’, and (c) it can incorporate one or many disciplines into a project. This ‘scaling’ has been verified in scope of the project (for example Drilling, from 1-rig projects to 12 rig projects), as well as in successive planning cycles (for example yearly plans for multi-year Production projects). The ‘scalable framework’ has been shown to be applicable across different ‘oilfield project contract models’, such as turnkey/lump-sum, gain-share, and bundled services. Data indicates that this ‘scalability’ is ‘linear’ or ‘sub-linear’, that is, increasing complexity of the work to be managed results in a less than linear increase in time required to manage the work by using the ‘Project Management System (PMS)’ disclosed in this specification. Practically speaking, the PMS disclosed in this specification provides a reliable model for forecasting the Project Management effort required for any project. This ‘scalability’ is achieved in significant measure by building ‘intelligence’ into the system through the use of ‘templates’ and ‘meta-data information’ that is automatically applied to ‘project elements’ by the PMS system disclosed herein. As a result, by using the ‘Project Management System (PMS)’ disclosed in this specification with reference to FIGS. 3, 4, and 6 through 37, new or junior field staff personnel can become just as ‘productive’ in ‘management of a project’, relative to more senior personnel, in a shorter amount of time. This has particular value to a company in light of impending shortage of experienced workers (for example, in the oil & gas industry). In this instance, the ‘scalable framework’ of the PMS system disclosed herein, including its use of ‘templates’, can be applied to any projects, such as ‘oilfield projects’. The ‘templates’ used in connection with the PSM system disclosed herein has been developed largely in connection with the ‘oilfield projects’. However, the PMS system disclosed herein, and the use of ‘templates’, is certainly not limited to the oil and gas industry. Indeed, any cross-disciplinary cross-functional project that is managing significant resources (e.g., CapEx and/or human resources) can benefit from this approach.

### (2) Line-of-Sight (LOS) Visibility or Access to Information

The ‘Project Management System (PMS)’ illustrated in FIGS. 3, 4, and 6 through 34 provides (via the ‘output displays’ that are generated by the processor 402 of FIG. 4) a ‘Line-of-Sight (LOS) visibility’ or ‘Line-of-Sight (LOS) access to information’ into the business. ‘LOS’ depends on the user's functional role and interaction level with the PMS system disclosed herein. The ‘LOS visibility’ provides the user with a ‘view into the integrated project plan’ that is filtered based on: (1) his/her discipline or responsibility in the project, and (2) the level of detail appropriate for the role. The ‘LOS visibility’ or ‘LOS access to information’ feature of the ‘Project Management System’, illustrated in FIGS. 3, 4, and 6 through 34, will allow the processor 402 of FIG. 4 to generate ‘output displays’ that will present to the user only that information which is needed to make decisions relating to his/her job and to prevent him/her from becoming overwhelmed by the actual integrated information being managed in the ‘Project Management System (PMS)’.

Line-of-Sight (LOS) is applied in a variety of cases, as described below:

### (3) Line-of-Sight (LOS) Views of Information and Project Status

In FIGS. 6, 7, 8, 9, 10, 11, 12, and 13, as previously noted, when the processor 402 of FIG. 4 executes the ‘Project Management System software’ 412, one or more ‘output displays’ will be generated that will provide ‘Line-of-Sight (LOS) views of information and project status’. The ‘output displays’ that provide the ‘LOS views of information and project status’ are set forth below, as follows:
FIGS. 6 and 9 show project-wide views of a production project (PM role),
FIGS. 7 and 8 show the Finance view (or the Controller's view), and
FIGS. 10, 11, 12, and 13 show different discipline-based LOS views.

### (4) Line-of-Sight (LOS) Visibility for Earned Value (a Project Performance Metric)

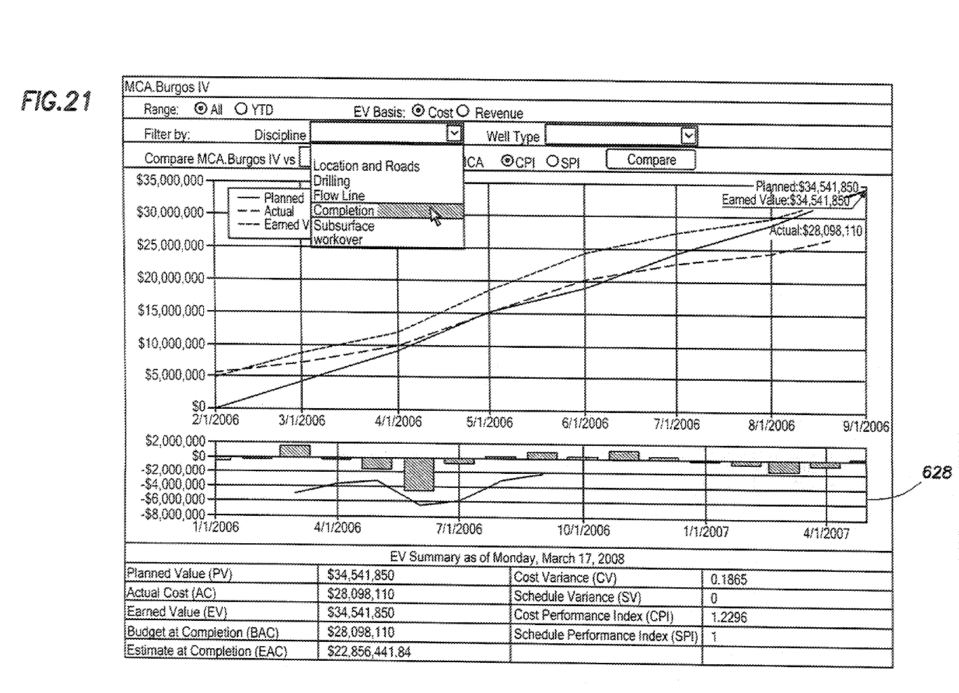

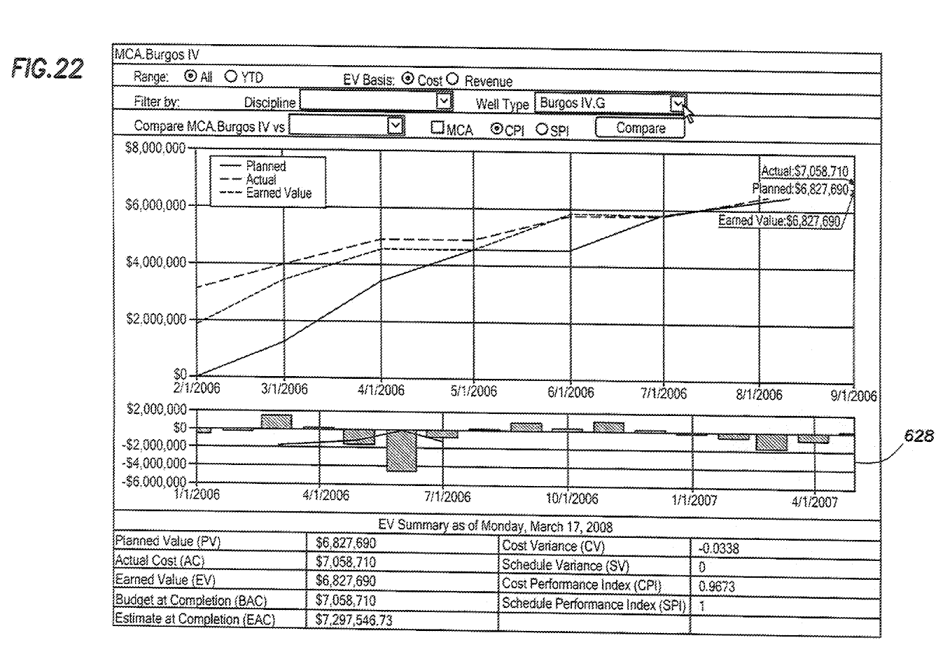

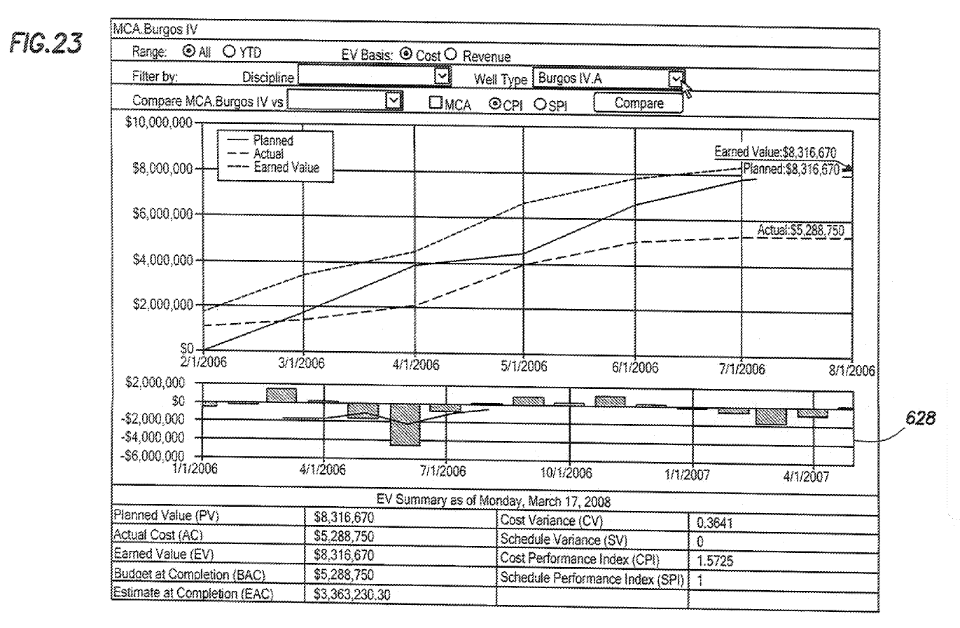

In FIGS. 21, 22, and 23, perhaps even more importantly, the ‘Line-of-Sight (LOS)’ feature associated with the ‘Project Management System’ of FIGS. 3, 4, and 6 through 37 is used to provide actionable feedback to individuals and teams in a project regarding their performance. This is accomplished through ‘LOS slice-and-dice views’ of ‘Earned Value data’ based on ‘discipline’ as well as ‘specific categories of activities within a function’, as illustrated in the following screenshots: (1) FIG. 21 shows ‘Earned Value (EV)’ for a full project. Note that the view is integrated with actual financials in the lower graph taken from the Finance system. The user is selecting a discipline to see Earned Value (EV) for that discipline, and (2) FIGS. 22 and 23 illustrate ‘Earned Value (EV)’ data for specific well types in a project shown across multiple wells drilled of that type.

### (5) Line-of-Sight (LOS) Filtered Data Entry/Project Statusing

In FIG. 25, the ‘Line-of-Sight (LOS)’ concept is also used for data input. For example, in FIG. 25, a user-filterable view is illustrated wherein the user can status only their discipline across multiple project elements, such as wells, road constructions, flowlines, etc.

### (6) Line-of-Sight (LOS) Resource Management

In FIGS. 26 and 27, a rig resource management view is illustrated.

In FIG. 26, although this would normally be of interest to a project manager or a drilling manager responsible for multiple rigs in a project, the view shown in FIG. 26 shows the ‘overall rig utilization’ thereby shielding the user from the ‘details of individual wells to which the rig may be assigned’ (the ‘details of individual wells to which the rig may be assigned’ being illustrated in FIG. 27).

In FIG. 27, the ‘details of individual wells to which the rig may be assigned’ is illustrated. In FIG. 27, a ‘rig resource availability view’ is illustrated for a single rig. FIG. 27 color-codes all of the well that the rig is scheduled to drill. FIG. 27 shows a potential under-utilization in the current plan and would normally be useful to the Well Site Supervisor or rig manager so that they can keep the rig fully utilized.

The ‘Project Management System (PMS)’ disclosed in this specification and illustrated in FIGS. 3, 4, and 6 through 37 also includes the following additional ‘features’ or ‘characteristics’ or ‘innovations’ (1), (2), (3), and (4), each of which is set forth below, as follows.
(1) Project and portfolio Performance measurements innovations:

In connection with ‘Earned Value (EV)’, (a) Earned Value (EV) was modified to meet the unique conditions of the oil field; that is, made EV an “actionable” indicator to highlight potential problem areas and where improvements can be made in field operations, (b) EV allows us to do better tracking and better planning and estimating, (c) EV was de-coupled from tasks, thereby allowing projects to select the level of granularity at which to track EV, and (d) Redefined the inputs to Earned Value (EV), as shown in the following ‘table’:

| | Operations | HQ | FIN |
|---|---|---|---|
| Rolling Plan Value | X | | X |
| Fixed Plan Value | | X | |
| Field Actuals | X | X | |
| Settled Actuals | | | X |

The above ‘table’ uses different sources for different applications of the same EV within the organization (it uses different sources of data to calculate EV to increase accuracy based on role). Estimated data comes in quicker and is thus useful for operations, but finance needs absolute values and is taken later (see ‘leading and trailing indicators’). For Earned Value (EV), we have modified how EV is defined, reported, tracked and used, to provide not just the typical benefit of better project tracking but also as a forward-looking leading indicator to help in better planning and estimating. This ‘Operational Earned Value (OpEV)’ identifies different sources of data to report to different levels of the organization. Referring to the ‘table’ above:
(2) Use ‘Rolling Plan and Field Actuals’ to provide the fastest ‘Operational Earned Value OpEV’ calculation; This provides an indicator which can be used to proactively plan upcoming field operations as it most closely mirrors field conditions; This is also the most coarse-grained indicator since ‘Field Actuals’ are not the final settled costs that are entered into the financial systems,
(3) Use ‘Fixed Plan and Field Actuals’ to provide central management with operational indicators of project performance; Here, ‘Fixed Plan values’ are used so that central management may compare with ‘overall strategy and plans’ for the project, and
(4) Use ‘Rolling Plan and Settled Actuals’ for Finance; This is the most accurate ‘Operational Earned Value (OpEV)’ number having been derived from the Rolling Plan reflecting field adjustments to yearly plans and Settled Actuals reflecting vendor discounts and other adjustments to costs made in the back-office.

‘Operational Earned Value (OpEV)’ is used to track performance within and across projects. We have de-coupled OpEV from specific tasks to permit flexibility in tracking OpEV at the level of granularity that is suitable to various oil field scenarios.

In FIGS. 33 and 34, the ‘users’ of the ‘Project Management System (PMS)’ disclosed herein and illustrated in FIGS. 3, 4, and 6 through 34 include the following individuals and personnel. The PMS system disclosed herein is primarily designed around an ‘oilfield project team’ in order to help it effectively plan, manage and report against its project. However, the application of the PMS system disclosed herein is not limited to the ‘oilfield’, as evidenced by FIGS. 33 and 34 wherein, in FIG. 33, a non-oilfield template is illustrated showing how engineer trainees may be tracked in the ‘Project Management System’ disclosed herein using the same framework, and, in FIG. 34, a Line-of-Sight (LOS) view is illustrated for a Human Resources training manager built from a trainee template. Indeed the PMS system disclosed herein is suitable for any type of environment in which multiple disciplines are required to come together to deliver a result. Currently, the ‘Project Management System (PMS)’ disclosed herein and illustrated in FIGS. 3, 4, and 6 through 34 has the following main types of users who actively use the system for the following indicated purposes:
Project Managers, Assistant Project Managers, QHSE staff:
   Create & extend project plans by using and creating new templates
   Track project schedules
   Status & track KPI's
   Distribute staff announcements
Drilling & Completions Engineers, Field Technicians, Civil Works personnel, other project staff:
   Maintain project plans using templates
   status project plans for their specific discipline
   report, track & respond to risks & issues
   Prepare and distribute Summary Daily Operations Reports
Operations management:
   Receive project risk & issues
   Receive Summary Daily Operations Reports
   Access project-specific documents, KPI's, and other information
HR Managers & personnel:
   Create & track project requisitions
   Manage key project staff and at-risk individuals
   Track all Field Engineer Trainees world-wide via the online MTPR (Monthly Training Progress Report) system in EPMS called IPM-MENTOR.
Project Support Staff, Schlumberger partners & Third Party Suppliers (Vendors):
   Receive project progress information to coordinate activities & resources with IPM projects.
Field Engineer Trainees (FE's):
   File & maintain monthly progress reports.
   Route reports for input from manager & HR.

In FIGS. 6 through 34, a discussion of each of the FIGS. 6 through 34 will be set forth below in the following paragraphs.

FIGS. 6 through 34 illustrate a series of ‘screenshots’ that are generated by the ‘Recorder or Display device’ 404 represented by the ‘I/O Device’ 404 of the Project Management Server 302 of FIG. 4 associated with the ‘Project Management System’ of FIGS. 3 and 4 disclosed in this specification. Each of these ‘screenshots’ are described below, in detail, as follows:

In FIG. 6, locate element numerals 600, 602, 604, 606, 608, 610, and 612. In the following paragraphs, each element numeral 600 through 612 is set forth below, which is followed by a description of FIG. 6 that corresponds to that element numeral.

In FIG. 6, a typical ‘dashboard’ (which is used for a ‘turnkey drilling program’) shows the following various components:

FIG. 6, numeral 600: A series of ‘Project Announcements’ are illustrated. Project staff communications posted here are kept as part of the project record and are also emailed to project members and others interested in receiving these communications;

FIG. 6, numeral 602: ‘Project Earned Value Performance’ is illustrated. Projects have the options of tracking Earned Value (EV) on a ‘cost-or-revenue’ basis. EV is tracked and reported automatically for a project plan maintained in the ‘Project Management System’ that provides the cost information.

FIG. 6, numeral 604: A high-level ‘revenue breakdown graph’ is illustrated. The purpose of the ‘revenue breakdown graph’ is to communicate relative portions of revenue for all company segments in order to emphasize the “integrated” nature of certain particular projects.

FIG. 6, numeral 606: A ‘Project Operational KPI's section’ is illustrated. This part of FIG. 6 shows the KPI name, the instantaneous value, the trend (see the arrow), and the historical graph for the KPI. Any KPI related to project schedule or resource may be computed automatically from the stored integrated project plans.

FIG. 6, numeral 608: A ‘Project SQ & HSE summary’ is illustrated. This information is taken from the safety Line of Business system (Quest).

FIG. 6, numeral 610: A ‘Project Risk Register’ is illustrated. This allows the tracking and assignment of risks. Personnel assigned risks are sent an email notification and reminders for follow-ups.

FIG. 6, numeral 612: A ‘Project Document Repository’ is illustrated, including online folders for managing and sharing project documents. All access is controlled through easy to manage administrative interfaces that the project can manage.

In FIG. 7, locate element numerals 614, 616, 618, 620. In the following paragraphs, each element numeral 614 through 620 is set forth below, which is followed by a description of FIG. 7 that corresponds to that element numeral.

In FIG. 7, a ‘financial page’ of a typical project dashboard is illustrated.

FIG. 7, numeral 614: A set of ‘Key financial indicators’ are illustrated, which are mandated by the organization to be tracked by Project Managers and controllers. The indicators compare ‘actuals’ (year-to-date) against a ‘rolling’ or ‘annual’ plan and display the lines as green/yellow/red depending on deviation from plan. The length of the graph line indicates percentage of annual target met to date. The ‘ROS’ (or ‘Return On Services’) shows a rolling 3-month min/man/average in addition to a green/yellow/red indicator of current ‘ROS %’.

FIG. 7, numerals 616, 618, and 620: A set of ‘detailed financial graphs’ is illustrated showing ‘current latest month performance’.

In FIG. 8, locate element numerals 622, 624, and 626. In the following paragraphs, each element numeral 622 through 626 is set forth below, which is followed by a description of FIG. 8 that corresponds to that element numeral.

In FIG. 8, a ‘Financial page of typical project dashboard’ is illustrated.

FIG. 8, numeral 622: A detailed ‘drilldown of graph data’ is illustrated.

FIG. 8, numeral 624: Here, the user can select any monthly period for drilldown as well as a comparison to an Annual or a Rolling plan.

FIG. 8, numeral 626: This portion of FIG. 8 illustrates red/yellow/green ‘traffic lights’ indicating deviation from the plan.

In FIG. 9, a detailed ‘integrated project plan view’ is illustrated. In this view which is illustrated in FIG. 9, the work to be done is categorized by the platform where the drilling or completion activity is taking place. The Line-of-Sight (LOS) views will permit or allow projects the ‘flexibility’ to organize and present their data in a manner that is intuitive to the people performing the work. In this case shown in FIG. 9, the LOS view is presented through a web interface.

In FIG. 10, a ‘Project Management System’ Line-of-Sight (LOS) view is illustrated which is based on ‘function’ (e.g., ‘drilling rig operations’). In FIG. 10, a LOS view for ‘Drilling operations’ is illustrated. For the rig “DTM 10”, we can see the sequence of wells that have been drilled and where ‘DTM 10’ is currently (the last well). Also, for rig “DTM 12”, note that the current schedule indicates underutilization between the two wells, as shown. This can represent a potentially significant cost to the company and corrective action would normally be taken.

In FIG. 11, a discipline-based Line-of-Sight (LOS) view for ‘Workover activities’ is illustrated. This is a more detailed view and would normally be accessed by engineers engaged in operational activities in workovers. This view provides a visual cue as to when available resources could be stressed because of multiple concurrent workover activities. This provides a heads-up to the team to allocate additional resources or reschedule some tasks.

In FIGS. 12 and 13, additional LOS views of the same project but for different functions and disciplines is illustrated. FIG. 12 illustrates a project discipline based LOS view for drilling, and FIG. 13 illustrates a project discipline based LOS view for production.

In FIG. 14, a view of ‘ad-hoc’ projects is illustrated. The ‘ad-hoc’ projects are meant to include: activities within a project that are unusual, exceptional or otherwise rare or unplanned. The ‘Project Management System’ disclosed herein allows users to “hand-craft” such projects and attach them to the integrated plans.

In FIGS. 15 and 16, a ‘Lessons Learned view’ is illustrated which is linked to the ‘overall project context’ and other information. This contains a contextual link to an external knowledge management system in order to direct the user to further details pertaining to this lessons learned entry.

In FIGS. 17 and 18, the project ‘Risk Register’ is illustrated, which illustrates data necessary to ‘classify’ and ‘report’ the project. FIGS. 17 and 18 provide an option to assign risks for follow-up (with email notifications). This ‘Risk Register’ also provides a contextual link to a safety investigation conducted for that risk and stored in the project HARC Repository.

In FIG. 19, a ‘General Project Earned Value graph’ is illustrated which shows the project operational Earned Value (EV) for the project or program.

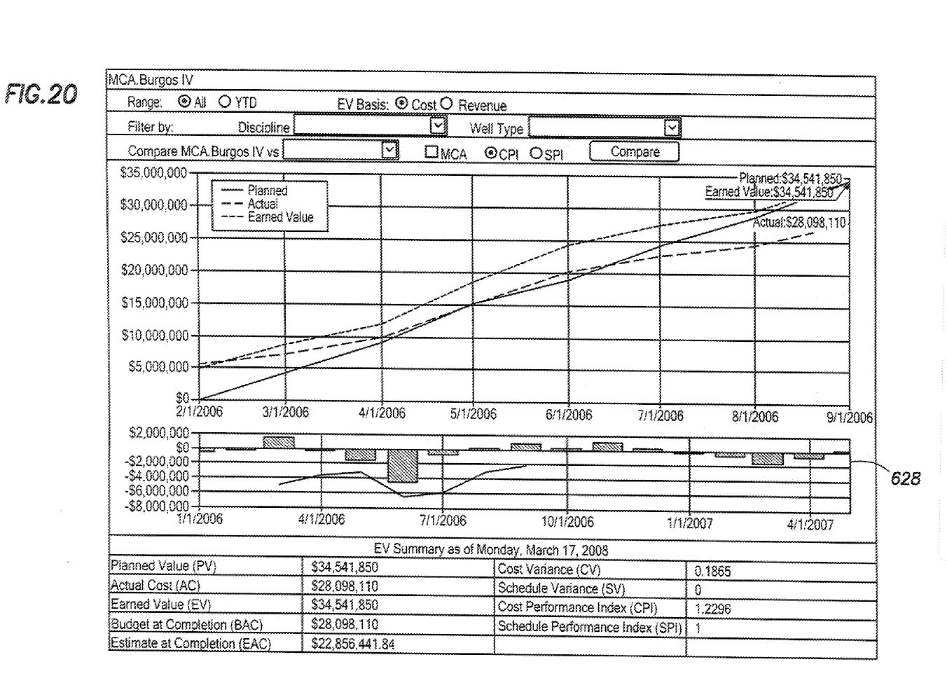

In FIGS. 20, 21, 22, 23 and 24, ‘Project Operational Earned Value’ is illustrated. FIGS. 20 through 24 show Earned Value (EV) in an ‘analysis window’ along with financial information from the Finance system. Users and teams are able to filter and view performance information only for their particular activity or discipline. In FIGS. 20 through 24, refer to numeral 628, which identifies a ‘bottom graph’ 628. Regarding the finance information in the ‘bottom graph’ 628, recall that ‘Operational Earned Value (EV)’ is calculated using ‘Field Actuals’ and ‘Rolling Plan values’ which is more timely but ultimately not as accurate as the Finance data which is more accurate but generally lags operations by 30 days or so.

In FIG. 25, a ‘Line-of-Sight’ based ‘Data Update View’ is illustrated. This particular view shown in FIG. 25 is being accessed through MS Project and allows an engineer from a particular discipline to filter and see only his/her assigned activities (across multiple project elements if desired). This minimizes the information displayed to show only relevant lines and reduces the likelihood of incorrect data entry or accidental overwrite of another discipline's data.

In FIGS. 26 and 27, these figures illustrate how ‘Line-of-Sight (LOS)’ is used in resource utilization/management views. For example, FIG. 26 shows a LOS resource availability view for a drilling manager, this view showing underutilization of a drilling rig, and FIG. 27 shows a LOS resource availability view for a well site supervisor, this view showing underutilization of the drilling rig during a certain time period (8/27 to 9/2). Rigs are often the most expensive resource in an oilfield project and FIG. 26 shows the overall and individual utilization for multiple rigs in a field. The graph shows that, per the current plan, rig ‘DTM 570’ will be idle for the period circled. This enables the team to adjust the plan to avoid this down time. This view is useful for Rig Management to assess if rigs are being utilized optimally. FIG. 27, on the other hand, shows the resource utilization of an individual rig. We can see that the rig has some apparent downtime during the drilling of well “Arcabuz 343”. The system visually points the drilling engineer or Well Site Supervisor to this potential issue and they can then investigate to understand the nature of this deviation.

In FIGS. 28 and 29, an ‘Operations portfolio view’ of multiple projects is illustrated. FIG. 28 shows an LOS view for operational portfolio managers showing consolidated views of projects in portfolio (1), and FIG. 29 shows an LOS view of operations portfolio managers showing consolidated views of projects in the portfolio showing finance detail. Key data (such as risks, documents, reports, and KPI's) are aggregated upwards into portfolio views such as this. This aggregation is built into the various components and then occurs automatically for projects within that portfolio definition.

In FIG. 30, another typical project dashboard is illustrated; however, this time, a production project for Brownfield rehabilitation is illustrated. Note the link to the Human Resource (HR) functionality (e.g., monthly training progress report for engineer trainees) for authorized project staff to access Trainee status.

In FIGS. 31 and 32, FIG. 31 shows the summary of Trainee information for a particular project. Only authorized staff may view this HR information. Project managers and assigned mentors in the project need to access this information in order to monitor and provide feedback regarding trainee progress. FIG. 32 shows one MPTR progress training report that is submitted by trainees and which gets routed through a simple workflow to collect the feedback of their mentor, manager, and Human Resource (HR) manager every month.

In FIGS. 33 and 34, trainee tracking views in the ‘Project Management System (PMS)’ disclosed herein are illustrated. FIG. 33 illustrates a non-oilfield template showing how engineer trainees may be tracked in the PMS system disclosed herein using the same framework, and FIG. 34 illustrates a LOS view for a Human Resources (HR) training manager built from the trainee template of FIG. 33. In FIG. 33, each trainee's development plan is represented in ‘templates’ which can aggregate into various ‘Line-of-Sight (LOS)’ views for Human Resources (HR). FIG. 34 shows one such ‘Line-of-Sight (LOS)’ view.

Referring to FIG. 35, a detailed definition of the term ‘Line-of-Sight (LOS)’ is illustrated. In FIG. 35, a diagram illustrates a definition of a ‘Line-of-Sight (LOS)’ approach. The term ‘Line-of-Sight (LOS)’ is a term which refers to the act of viewing information at the level of details appropriate to one's role, or filtering-out certain information based on the discipline of the viewer. In FIG. 35, when managing the disclosure information to others “only at a level of detail required for one's role”, there exists four possible levels of information to which a person should have access: (1) a first level of information 700 which represents ‘summary information’ that would be given, for example, to a ‘geomarket organization’ and above; for example, a summary ‘dashboard’ of information and indicators would be given to the ‘geomarket organization’, (2) a second level of information 702 which represents ‘additional information in addition to the first level of information 700’ that could be given to a project manager; for example, a overall project schedule could be given to the project manager, (3) a third level of information 704 which represents ‘additional information in addition to the second level of information 702’ that could be given to discipline leaders; for example, individual schedules showing detailed activities could be given to the discipline leaders, and (4) a fourth level of information 706 which represents ‘additional information in addition to the third level of information 704’ that could be given to team members; for example, a list of tasks listed in a discipline leader's schedule would be given to team members and the team members would ‘enter data against the list of tasks listed in the discipline leader's schedule’.

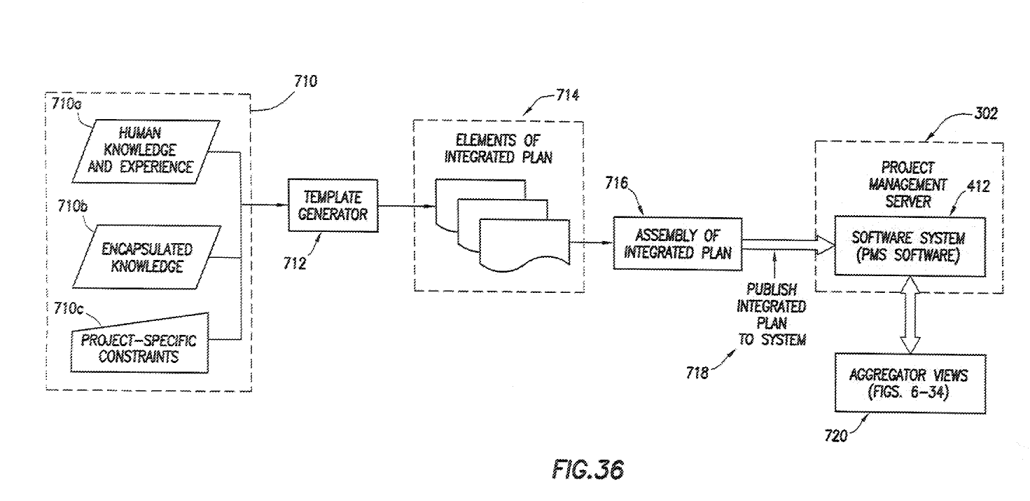

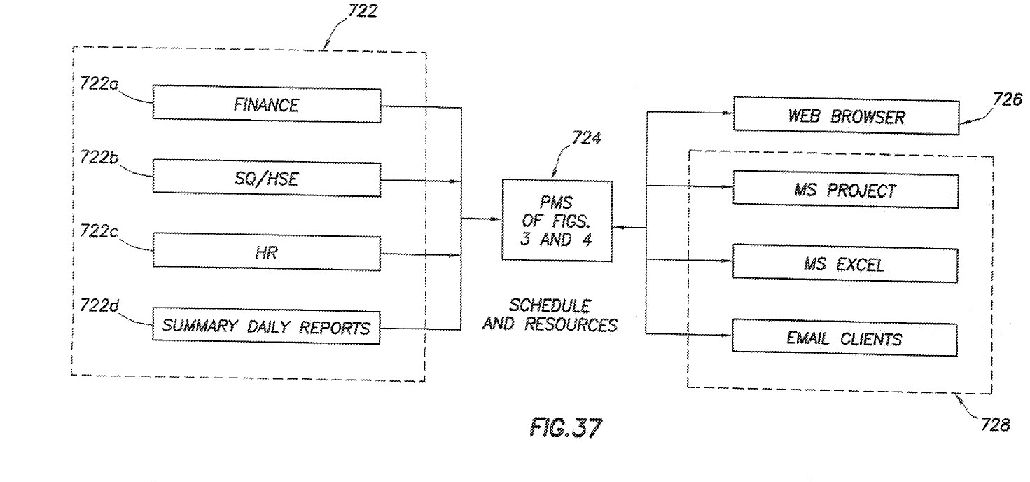

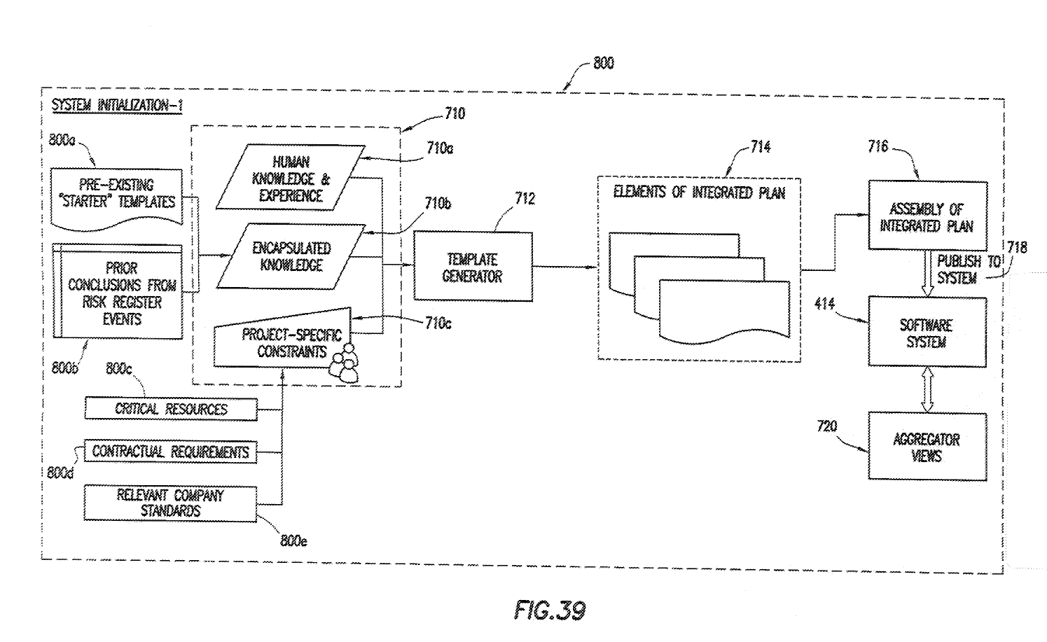

Referring to FIGS. 36 and 37, a brief discussion of the construction of the ‘Project Management System software’ 412 of FIG. 4 is set forth below with reference to FIGS. 36 and 37 (although a more detailed discussion of the construction of the ‘Project Management System software’ 412 will be discussed below with reference to FIGS. 38 through 43E), FIG. 36 representing the ‘system initialization-1’ as shown in FIG. 39 (to be discussed in more detail later in FIG. 39 of this specification) and FIG. 37 representing data flow.

In FIG. 36, refer in more detail to the ‘initialization-1’ of FIG. 39, to be discussed later in this specification. In FIG. 36, various types of ‘input data’ 710 are provided and input to a ‘template generator’ 712, where the ‘input data’ 710 includes ‘human knowledge and experience’ 710a, ‘encapsulated knowledge’ 710b, and ‘project-specific constraints’ 710c. In response thereto, the ‘template generator’ 712 will generate a set of ‘elements of an integrated plan’ 714. In a step called ‘assembly of an integrated plan’ 716, the ‘elements of an integrated plan’ 714 will be assembled into an ‘integrated plan’. In response thereto, the ‘integrated plan’ will be ‘published to the system’ via step 718 in FIG. 36. When the ‘integrated plan’ is ‘published to the system’, via step 718, the ‘Project Management System server’ 302 of FIG. 4 will receive the ‘integrated plan’. In response to the ‘integrated plan’, the processor 402 of FIG. 4 will execute the ‘Project Management System software’ 412, while utilizing the ‘integrated plan’, and, responsive thereto, the processor 402 will generate a set of ‘aggregator views’ 720, wherein the ‘aggregator views’ 720 will include the ‘screenshots’ of FIGS. 6 through 34 which have already been discussed above in this specification.

In FIG. 37, ‘data flow’ is illustrated. In FIG. 37, ‘a second set of input data’ 722 is provided to the ‘Project Management System (PMS) of FIGS. 3 and 4’ 724, where the ‘second set of input data’ 722 includes ‘finance data’ 722a, ‘safety quality/health, safety and environment (SQ/HSE) data’ 722b, ‘human resource (HR) data’ 722c, and ‘summary daily reports data’ 722d. The ‘Project Management System (PMS) of FIGS. 3 and 4’ 724 receives the ‘second set of input data’ 722 [including the ‘finance data’ 722a, the ‘health, safety and environment (SQ/HSE) data’ 722b, the ‘human resource (HR) data’ 722c, and the ‘summary daily reports data’ 722d] and the ‘integrated plan’ 718 of FIG. 36. Responsive thereto, the PMS system of FIGS. 3 and 4 will generate the ‘aggregator views’ 720 (including FIGS. 6 through 34 discussed above) of FIG. 36. The ‘aggregator views’ 720 (including FIGS. 6 through 34 discussed above) will be available for viewing by a user (on the ‘recorder or display device’ 404 of FIG. 4) via the ‘web browser’ 726 of FIG. 37. In addition, the ‘aggregator views’ 720 will be available for other purposes, including ‘MS project, MS Excel, and emailing clients’ 728 in FIG. 37.

In FIG. 37, the ‘aggregator views’ 720, including the ‘screenshots’ of FIGS. 6 through 34, have the following features or characteristics:
(1) The ‘screenshots’ of FIGS. 6 through 34, which can be recorded or displayed on the ‘recorder or display device’ 404 of FIG. 4, have a ‘scalable framework’, which means that the ‘screenshots’: can be applied to different size projects, can track a little data for lots of projects or lots of data for one or a few projects, and can incorporate one or many disciplines into a project.
(2) In addition, the ‘screenshots’ of FIGS. 6 through 34, which can be recorded or displayed on the ‘recorder or display device’ 404 of FIG. 4, include ‘Line-of-Sight access to information, which means that the ‘screenshots’ include ‘Line-of-Sight visibility’ (hereinafter, ‘LOS visibility’) into a business. Recall that the term ‘Line-of-Sight’ (or ‘LOS’) provides a user with a view into the ‘integrated project plan’ that is ‘filtered’ based on his/her discipline or responsibility in the project as well as the level of detail appropriate to his/her role in the project. This ‘LOS visibility’ will present the user with only that information which is needed to make decisions relating to his/her job and to prevent him/her from becoming overwhelmed by the actual integrated information being managed by the ‘PMS system’ disclosed herein.
(3) In addition, the ‘screenshots’ of FIGS. 6 through 34, which can be recorded or displayed on the ‘recorder or display device’ 404 of FIG. 4, include ‘Line-of-Sight’ views of information and project status, including a project-wide view of a production project (FIGS. 6 and 9), a finance view (FIGS. 7 and 8), and different discipline based LOS views (FIGS. 10 through 13).
(4) In addition, the ‘screenshots’ of FIGS. 6 through 34, which can be recorded or displayed on the ‘recorder or display device’ 404 of FIG. 4, include ‘LOS visibility’ for Earned Value, which is a key performance metric, which means that the ‘LOS’ feature, associated with the PMS system disclosed herein, is used to provide actionable feedback to individuals and teams in a project regarding their performance. This is accomplished through LOS views of Earned Value data based on discipline as well as specific categories of activities within a function.
(5) In addition, the ‘screenshots’ of FIGS. 6 through 34, which can be recorded or displayed on the ‘recorder or display device’ 404 of FIG. 4, include ‘LOS filtered data entry and project statusing’, wherein a user can: use the LOS concept for data input, and determine the status of only their ‘discipline’ across multiple project elements.
(6) In addition, the ‘screenshots’ of FIGS. 6 through 34, which can be recorded or displayed on the ‘recorder or display device’ 404 of FIG. 4, includes ‘LOS resource management’ which means that the ‘screenshots’ further include a ‘rig resource management view’ and a ‘rig resource availability view’.

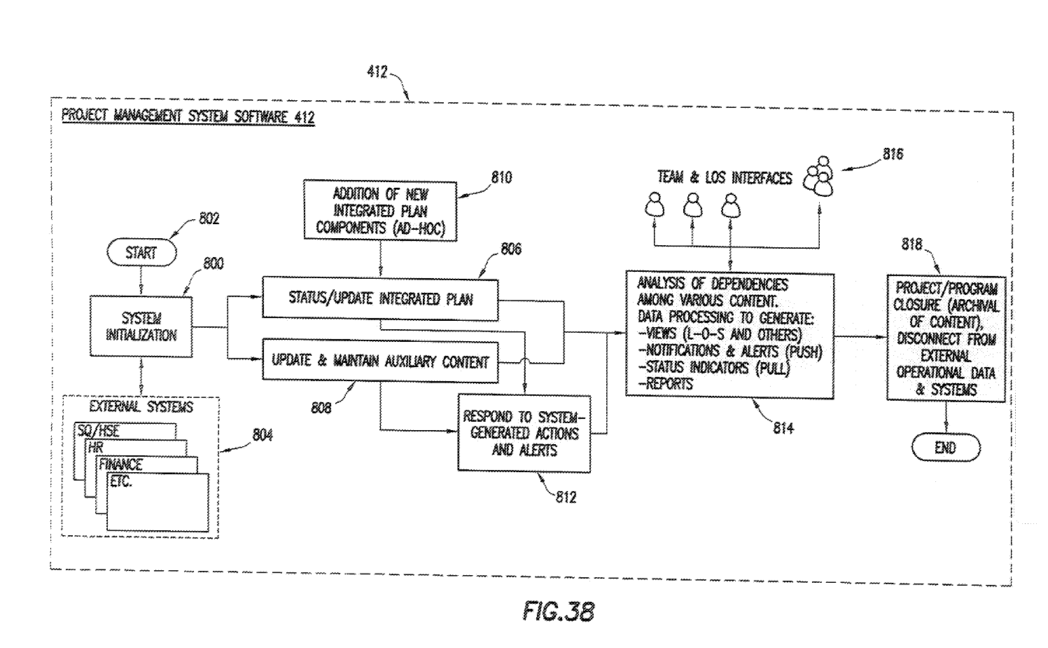

Referring to FIGS. 38 through 43E, the structure and functional operation of the ‘Project Management System software’ 412 of FIG. 4, which generates the ‘output displays’ of FIGS. 6 through 34, will be discussed below with reference to FIGS. 38 through 43E of the drawings.

In FIG. 38, an overall construction of the ‘project management system software’ 412 of FIG. 4 is illustrated. In FIG. 38, the ‘project management system software’ 412 of FIG. 4 includes the following steps: when execution of the ‘project management system software’ 412 starts with step 802, a ‘system initialization’ step 800 responds to ‘external systems’ 804. Following the ‘system initialization’ step 800, the ‘status/update integrated plan’ step 806 and the ‘update & maintain auxiliary content’ step 808 are executed in parallel. The ‘status/update integrated plan’ step 806 responds to any ‘addition of new integrated plan components’ 810. In addition, when the ‘status/update integrated plan’ step 806 and the ‘update & maintain auxiliary content’ step 808 are executed, the ‘respond to system generated actions and alerts’ step 812 is executed. When the ‘status/update integrated plan’ step 806 and the ‘update & maintain auxiliary content’ step 808 are executed, and when the ‘respond to system generated actions and alerts’ step 812 is executed, step 814 will respond to ‘team & LOS interfaces’ 816, and then step 814 will be executed. Step 814 of FIG. 38 includes: (1) analysis of dependencies among various content, and (2) data processing to generate: (a) views (such as LOS view and others, (b) notifications and alerts (push), (c) status indicators (pull), and (d) reports. When execution of step 814 of FIG. 38 is completed, the final step 818 will be executed, wherein the final step 818 includes: project/program closure (archival of content), and disconnect from external operational data and systems. Note, in step 814 of FIG. 38, that this step 814 includes: “Data processing to generate views (such as LOS view and others)”. The aforementioned “Data processing to generate views (such as LOS view and others)” substep associated with step 814 of FIG. 38 will generate the ‘output displays’ that are illustrated in FIGS. 6 through 34 of the drawings.

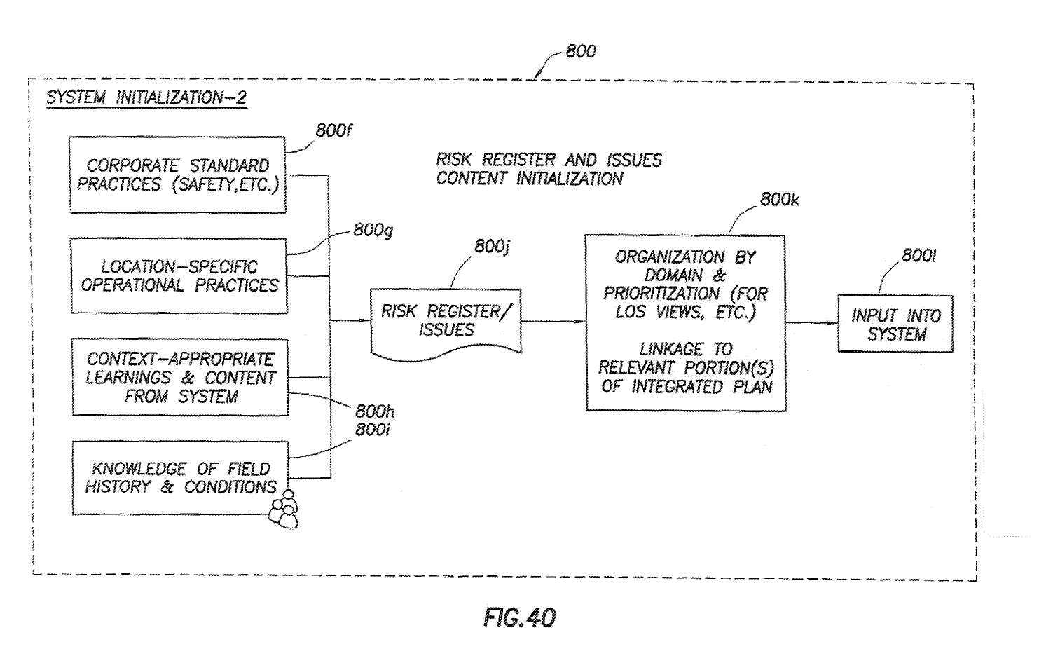

In FIGS. 39 and 40, a detailed construction of the ‘system initialization’ step 800 of FIG. 38 is illustrated.

In FIG. 39, a construction of a first part of the ‘system initialization’ step 800 of FIG. 38 is illustrated. In FIG. 39, as noted earlier, various types of ‘input data’ 710 are provided and input to a ‘template generator’ 712, where the ‘input data’ 710 includes ‘human knowledge and experience’ 710a, ‘encapsulated knowledge’ 710b, and ‘project-specific constraints’ 710c. The ‘encapsulated knowledge’ 710b will receive ‘pre-existing starter templates’ 800a and ‘prior conclusions from risk register events’ 800b. The ‘project-specific constraints’ 710c will receive ‘critical resources’ 800c, ‘contractual requirements’ 800d, and ‘relevant company standards’ 800e. In response thereto, the ‘template generator’ 712 will generate a set of ‘elements of an integrated plan’ 714. In a step called ‘assembly of an integrated plan’ 716, the ‘elements of an integrated plan’ 714 will be assembled into an ‘integrated plan’. In response thereto, the ‘integrated plan’ will be ‘published to the system’ via step 718 in FIG. 39. When the ‘integrated plan’ is ‘published to the system’, via step 718, the ‘Project Management System server’ 302 of FIG. 4 will receive the ‘integrated plan’. In response to the ‘integrated plan’, the processor 402 of FIG. 4 will execute the ‘Project Management System software’ 412, while utilizing the ‘integrated plan’, and, responsive thereto, the processor 402 will generate a set of ‘aggregator views’ 720, wherein the ‘aggregator views’ 720 will include the ‘screenshots’ of FIGS. 6 through 34 which have already been discussed above in this specification.

In FIG. 40, a construction of a second part of the ‘system initialization’ step 800 of FIG. 38 is illustrated. In FIG. 40, the workflow illustrated in FIG. 40 is a primary example of the steps involved in initializing auxiliary content. In FIG. 40, the risk register 800j and issues content initialization 800j include receiving ‘corporate standard practices (e.g., safety, etc)’ 800f, ‘location-specific operational practices’ 800g, ‘context-appropriate learnings and content from system’ 800h, and ‘knowledge of field history and conditions’ 800i. Step 800j of FIG. 40, involving the risk register and issues content initialization’, is followed by step 800k which includes ‘organization by domain & prioritization (for LOS views, etc)—linkage to relevant portions(s) of the integrated plan’ 800k. Step 800k is ‘input to the system’ in step 800L.

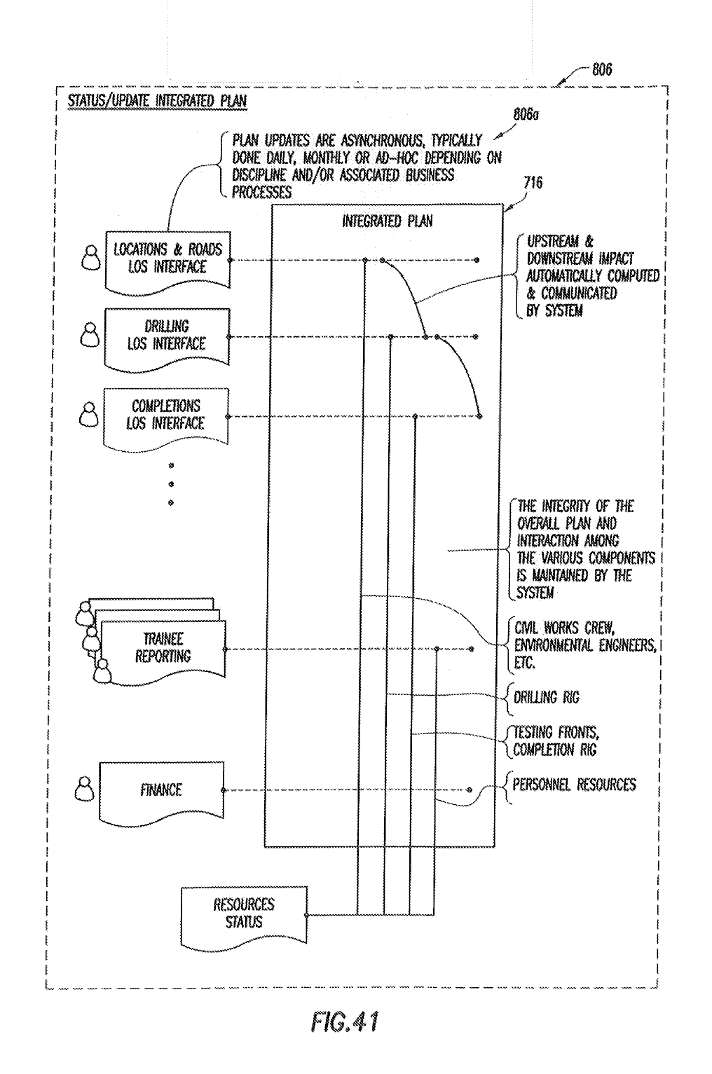

In FIG. 41, a detailed construction of the ‘status/update integrated plan’ step 806 of FIG. 38 is illustrated. In FIG. 39, recall that the ‘integrated plan’ 716 is generated in response to the ‘assembly of integrated plan’ step 716 in FIG. 39. In FIG. 41, that integrated plan 716 is ‘updated’ in the manner illustrated in FIG. 41. Here, when the integrated plan 716 is updated, the integrated plan updates are asynchronous, typically done daily, monthly, or ad-hoc depending on discipline and/or associated business processes, as noted by 806a.

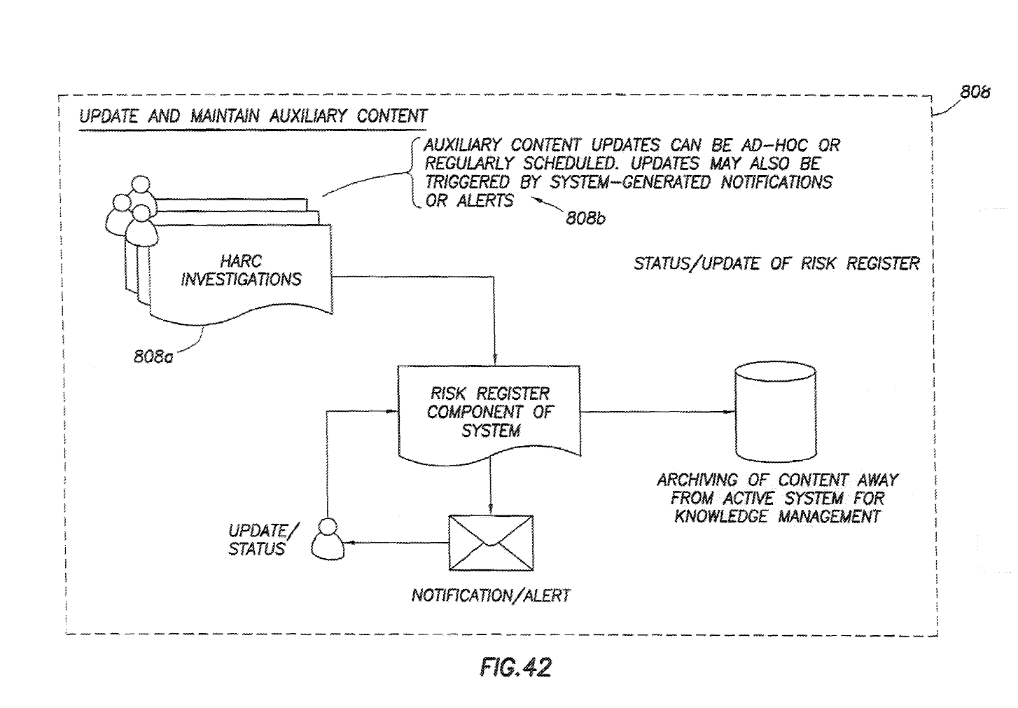

In FIG. 42, a detailed construction of the ‘update & maintain auxiliary content’ step 808 of FIG. 38 is illustrated. FIG. 42 illustrates an example involving the status and update of the risk register. In FIG. 42, in the ‘HARC investigations’ 808a, auxiliary content updates can be ad-hoc or regularly scheduled, and updates may also be triggered by system-generated notifications and alerts, 808b.

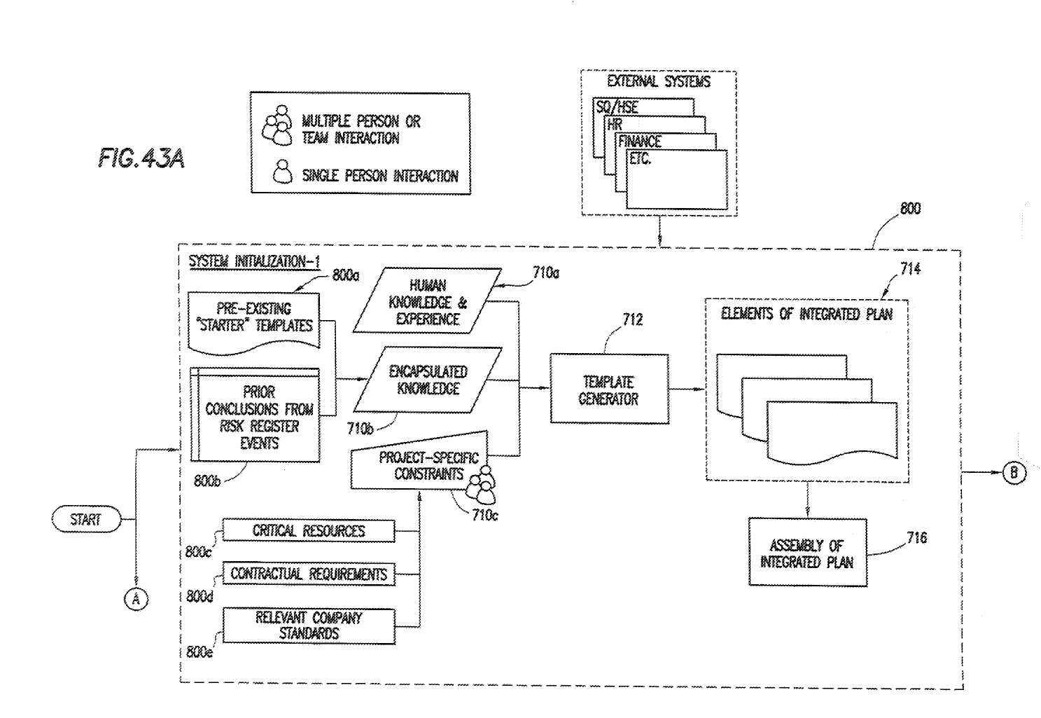

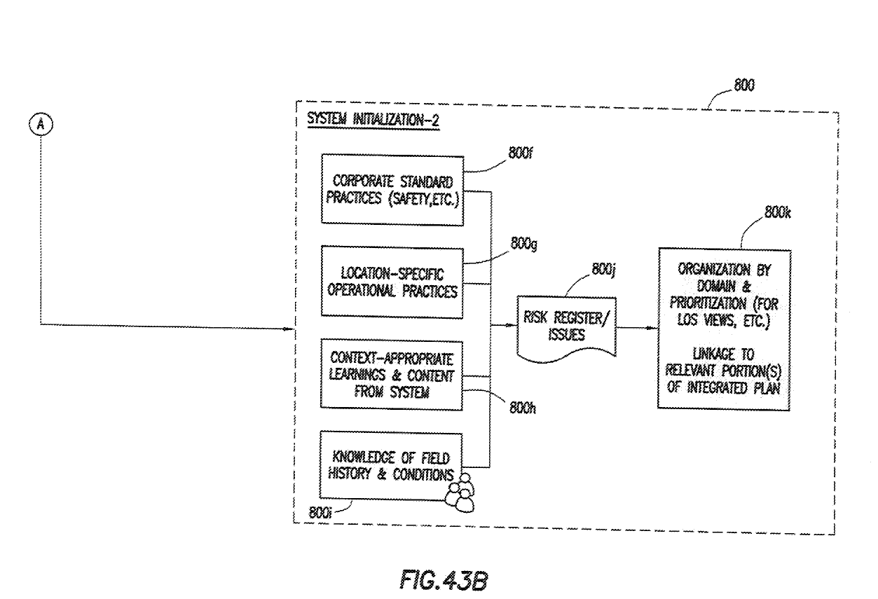

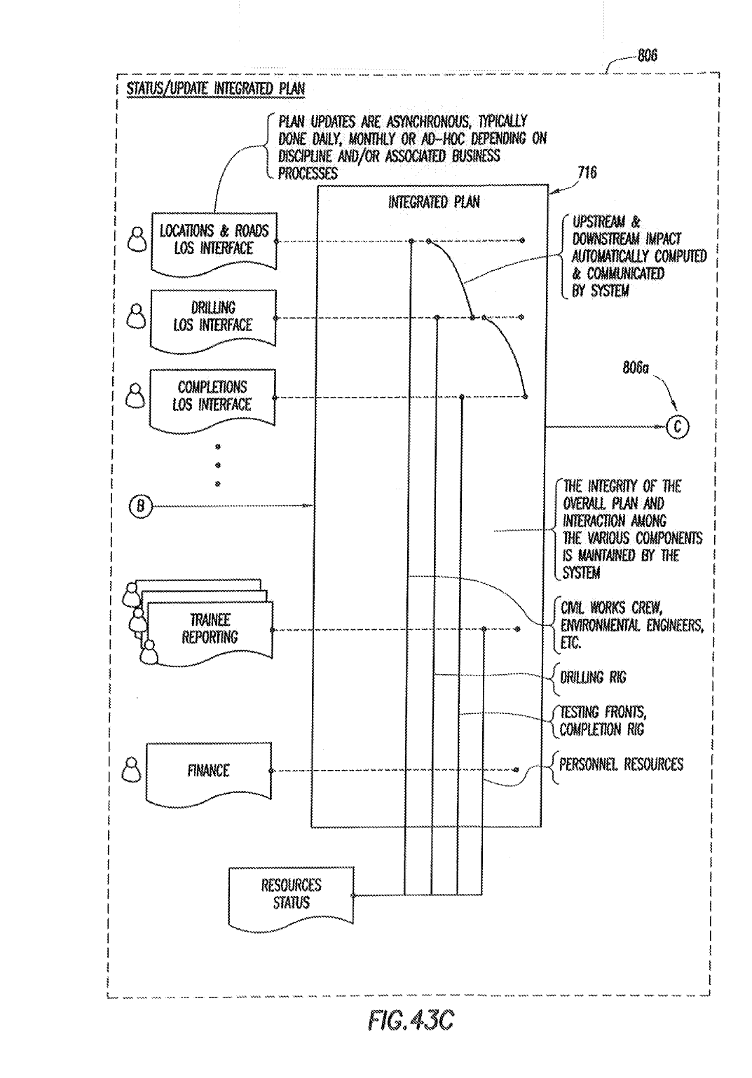

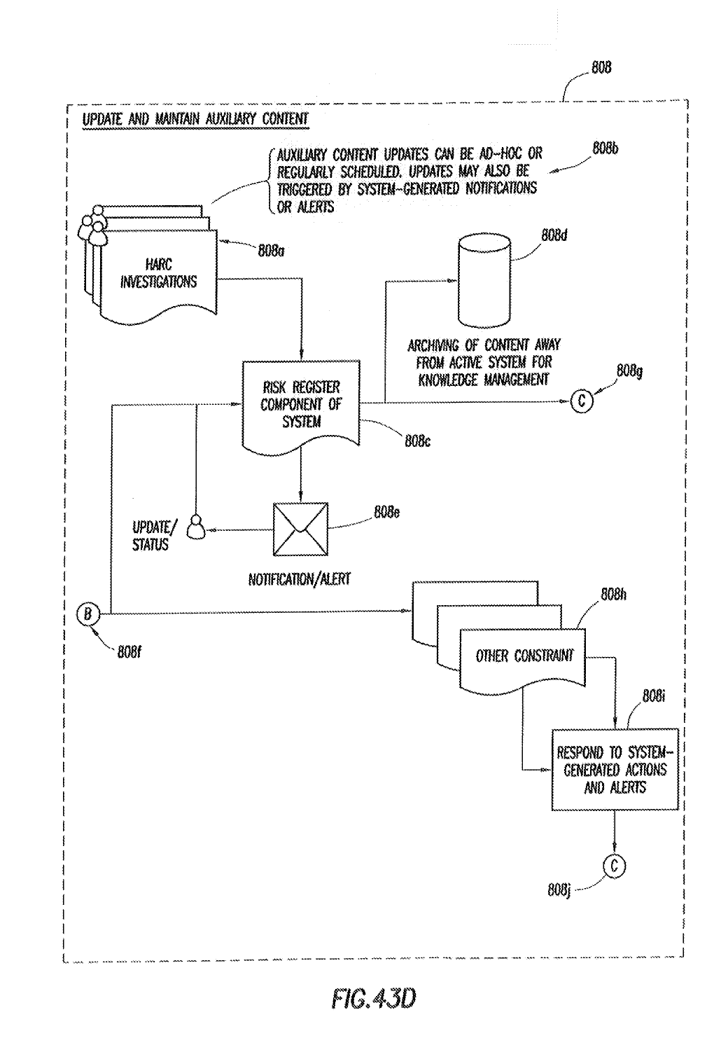

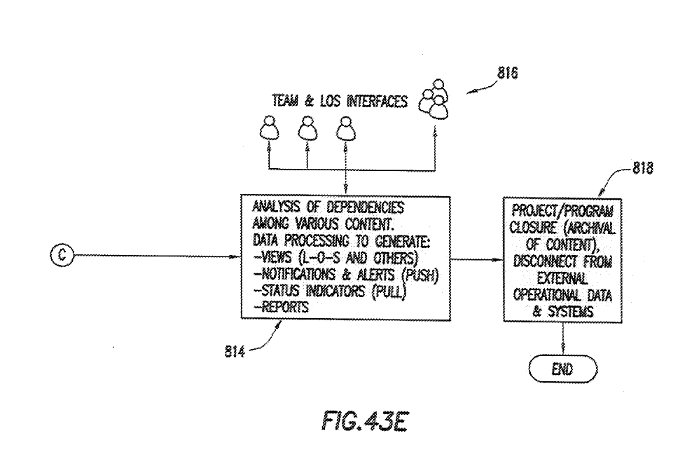

In FIGS. 43A through 43E, these figures collectively illustrate a ‘full workflow’ and a ‘detailed construction’ of the ‘Project Management System software’ 412 of FIG. 4, where the ‘full workflow’ of the ‘Project Management System software’ 412 illustrated in FIGS. 43A through 43E includes the ‘individual constructions’ that are illustrated in FIGS. 39, 40, 41, and 42; however, the ‘individual constructions’ of FIGS. 39-42 are ‘linked-together’ to form the ‘full workflow’ and ‘detailed construction’ of FIGS. 43A through 43E.

A functional description of the operation of the ‘Project Management System software’ 412 of FIG. 4 is set forth in the following paragraphs: (1) with reference to FIGS. 3, 4, 39, and 43A through 43E of the drawings, wherein the construction and functional operation of the ‘Project Management System software’ 412 of FIG. 4, adapted for generating and displaying the series of ‘output displays’ of FIGS. 6-34, is illustrated, and (2) with reference to FIGS. 6 through 34, wherein the actual content of the aforementioned ‘output displays’ are illustrated

In FIG. 3, the project management server 302 receives (as ‘input data’) the tasks and timing template 310 and the expert knowledge and best practices 308 and, responsive thereto, in FIG. 4, the processor 402 of the project management server 302 will: (1) execute the project management system software 412, while using the aforementioned ‘input data’, and (2) generate and a series of ‘output displays’ which are illustrated in FIGS. 6 through 34 of the drawings.

In FIG. 43A, when the processor 402 of the project management server 302 of FIG. 4 executes the project management system software 412, in FIG. 43A, the following steps of FIG. 43A are practiced. In FIG. 43A, various types of ‘input data’ are provided and input to a ‘template generator’ 712, where the ‘input data’ includes ‘human knowledge and experience’ 710a, ‘encapsulated knowledge’ 710b, and ‘project-specific constraints’ 710c. The ‘encapsulated knowledge’ 710b will receive ‘pre-existing starter templates’ 800a and ‘prior conclusions from risk register events’ 800b. The ‘project-specific constraints’ 710c will receive ‘critical resources’ 800c, ‘contractual requirements’ 800d, and ‘relevant company standards’ 800e. In response thereto, the ‘template generator’ 712 will generate a set of ‘elements of an integrated plan’ 714. In a step called ‘assembly of an integrated plan’ 716, the ‘elements of an integrated plan’ 714 will be assembled into an ‘integrated plan’.

As noted in FIG. 39, the ‘integrated plan’ will be ‘published to the system’ via step 718 in FIG. 39. When the ‘integrated plan’ is ‘published to the system’, via step 718, the ‘Project Management System server’ 302 of FIG. 4 will receive the ‘integrated plan’. In response to the ‘integrated plan’, the processor 402 of FIG. 4 will execute the ‘Project Management System software’ 412, while utilizing the ‘integrated plan’, and, responsive thereto, the processor 402 will generate a set of ‘aggregator views’ 720, wherein the ‘aggregator views’ 720 will include the ‘screenshots’ of FIGS. 6 through 34.

In FIG. 43B, when the steps of FIG. 43A are being practiced as indicated above, the steps of FIG. 43B are also being practiced. In FIG. 43B, the workflow illustrated in FIG. 43B is a primary example of the steps involved in initializing auxiliary content. In FIG. 43B, the ‘risk register and issues content initialization’ step 800j receives ‘corporate standard practices (e.g., safety, etc)’ 800f, ‘location-specific operational practices’ 800g, ‘context-appropriate learnings and content from system’ 800h, and ‘knowledge of field history and conditions’ 800i. Step 800j of FIG. 43B, involving the ‘risk register and issues content initialization’, is followed by step 800k which includes ‘organization by domain & prioritization (for LOS views, etc)—linkage to relevant portions(s) of the integrated plan’ 800k. In FIG. 40, step 800k is ‘input to the system’ in step 800L.

In FIG. 43C, the ‘integrated plan’ 716, which is generated by the ‘assembly of integrated plan’ 716 in FIG. 43A, is provided to the ‘status/update integrated plan’ step 806 of FIG. 43C. In FIG. 43C, that ‘integrated plan’ 716 is updated in the manner illustrated in FIG. 43C, thereby generating an ‘updated integrated plan’ via step 806a in FIG. 43C. As indicated in FIG. 43C, integrated plan updates are asynchronous, typically done daily, monthly, or ad-hoc, depending on the discipline and/or associated business processes.

In FIG. 43D, the ‘integrated plan’ 716, which is generated by the ‘assembly of integrated plan’ 716 in FIG. 43A, is also provided to the ‘update & maintain auxiliary content’ step 808 in FIG. 43D. FIG. 43D illustrates an example involving the status and the update of the ‘risk register’. Recall, from FIG. 6, numeral 610, that a ‘project risk register’ is illustrated, wherein the ‘risk register’ allows for the tracking and assignment of risks, and personnel assigned various risks are sent an email notification and reminders for follow-ups. In FIG. 43D, in the ‘HARC investigations’ 808a, ‘auxiliary content updates’ can be ad-hoc or regularly scheduled, and updates may also be triggered by system-generated notifications and alerts, 808b. The ‘auxiliary content updates’ are provided to the ‘risk register component of system’ 808c, wherein, in step 808d, that ‘auxiliary content updates’ may be archived away from the active system for knowledge management via step 808d. In step 808e, recall that personnel assigned various risks are sent an email notification and reminders for follow-ups via step 808e. In step 808g, the ‘update & maintain auxiliary content’ step 808 will generate the ‘contents of the ‘risk register’, via step 808g of FIG. 43D. In step 808f, recall that the ‘integrated plan’ 716, which is generated by the ‘assembly of integrated plan’ 716 in FIG. 43A, is also provided to the ‘update & maintain auxiliary content’ step 808 in FIG. 43D via step 808f. Here, in step 808h, the ‘integrated plan’ 716 is subject to other constraints, which, in step 808i, will ‘respond to system generated actions and alerts’, thereby generating, in step 808j, an ‘integrated plan subject to other constraints and responsive to system generated actions and alerts’, step 808j.

In FIG. 43E, the following ‘inputs’, which are denoted by the notation ‘©’, are received: (1) the ‘updated integrated plan’ from step 806a in FIG. 43C, (2) the ‘contents of the ‘risk register’ from step 808g of FIG. 43D, and (3) the ‘integrated plan subject to other constraints and responsive to system generated actions and alerts’ from step 808j in FIG. 43D. In FIG. 43E, in response to the above referenced ‘inputs’, step 814 will respond to ‘team & LOS interfaces’ 816, and then step 814 will be executed, wherein step 814 includes the following substeps: (1) analysis of dependencies among various content, and (2) data processing to generate: (a) views (such as LOS view and others, (b) notifications and alerts (push), (c) status indicators (pull), and (d) reports. When execution of step 814 of FIG. 43E is completed, the final step 818 will be executed, wherein the final step 818 includes: project/program closure (archival of content), and disconnect from external operational data and systems.

In FIG. 43E, step 814, note that this step 814 includes the following ‘substep’: “Data processing to generate views (such as LOS view and others)”. In the aformentioned ‘substep’ entitled “Data processing to generate views (such as LOS view and others)”, this substep (associated with step 814 of FIG. 43E) will generate the ‘output displays’ that are illustrated in FIGS. 6 through 34 of the drawings.

The following discussion will now focus on the ‘output displays’, that are illustrated in FIGS. 6 through 34, which are generated by the Project Management System software 412 in the manner discussed above with reference to FIGS. 43A-43E.

In FIG. 6 through 34 and 35, the term ‘Line-of-Sight (LOS)’ is used. The term ‘Line-of-Sight (LOS)’ is a term which refers to the act of viewing information at the level of details appropriate to one's role, or filtering-out certain information based on the discipline of the viewer, as illustrated in FIG. 35. In FIG. 35, when managing the disclosure information to others “only at a level of detail required for one's role”, there exists four possible levels of information to which a person should have access: (1) a first level of information 700 in FIG. 35 which represents ‘summary information’ that would be given, for example, to a ‘geomarket organization’ and above; for example, a summary ‘dashboard’ of information and indicators would be given to the ‘geomarket organization’, (2) a second level of information 702 in FIG. 35 which represents ‘additional information in addition to the first level of information 700’ that could be given to a project manager; for example, a overall project schedule could be given to the project manager, (3) a third level of information 704 in FIG. 35 which represents ‘additional information in addition to the second level of information 702’ that could be given to discipline leaders; for example, individual schedules showing detailed activities could be given to the discipline leaders, and (4) a fourth level of information 706 in FIG. 35 which represents ‘additional information in addition to the third level of information 704’ that could be given to team members; for example, a list of tasks listed in a discipline leader's schedule would be given to team members and the team members would ‘enter data against the list of tasks listed in the discipline leader's schedule’.

The ‘Project Management System (PMS)’ of FIGS. 3, 4, and 6 through 34 includes a plurality of ‘output displays’ that are illustrated in FIGS. 6 through 34, the ‘output displays’ further including the following ‘new and novel features or characteristics’: (1) a Scalable Framework, (2) Line-of-Sight (LOS) access to Information, (3) Line-of-Sight (LOS) views of information and project status, (4) Line-of-Sight (LOS) Visibility for Earned Value (a project performance metric), (5) Line-of-Sight (LOS) filtered data entry/project statusing, and (6) Line-of-Sight (LOS) Resource Management.

Each of the above referenced ‘new and novel features or characteristics’ (1) through (6) associated with the ‘output displays’ illustrated in FIGS. 6 through 34 of the ‘Project Management System (PMS)’ (of FIGS. 3, 4, and 6 through 34) will be discussed individually below in the following paragraphs.

### (1) Scalable Framework

The ‘Project Management System (PMS)’ illustrated in FIGS. 3, 4, and 6 through 34 provides a ‘Scalable Framework’ for the planning and execution of multi-disciplinary projects. The framework is termed ‘scalable’ because: (a) it can be applied to different sizes of projects, (b) it gives the user ‘flexibility’ to track a ‘little data’ for ‘lots of projects’ or ‘lots of data’ for ‘one or a few project’, and (c) it can incorporate one or many disciplines into a project. This ‘scaling’ has been verified in scope of the project (for example Drilling, from 1-rig projects to 12 rig projects), as well as in successive planning cycles (for example yearly plans for multi-year Production projects). The ‘scalable framework’ has been shown to be applicable across different ‘oilfield project contract models’, such as turnkey/lump-sum, gain-share, and bundled services. Data indicates that this ‘scalability’ is ‘linear’ or ‘sub-linear’, that is, increasing complexity of the work to be managed results in a less than linear increase in time required to manage the work by using the ‘Project Management System (PMS)’ disclosed in this specification. Practically speaking, the PMS disclosed in this specification provides a reliable model for forecasting the Project Management effort required for any project. This ‘scalability’ is achieved in significant measure by building ‘intelligence’ into the system through the use of ‘templates’ and ‘meta-data information’ that is automatically applied to ‘project elements’ by the PMS system disclosed herein. As a result, by using the ‘Project Management System (PMS)’ disclosed in this specification with reference to FIGS. 3, 4, and 6 through 37, new or junior field staff personnel can become just as ‘productive’ in ‘management of a project’, relative to more senior personnel, in a shorter amount of time. This has particular value to a company in light of impending shortage of experienced workers (for example, in the oil & gas industry). In this instance, the ‘scalable framework’ of the PMS system disclosed herein, including its use of ‘templates’, can be applied to any projects, such as ‘oilfield projects’. The ‘templates’ used in connection with the PSM system disclosed herein has been developed largely in connection with the ‘oilfield projects’. However, the PMS system disclosed herein, and the use of ‘templates’, is certainly not limited to the oil and gas industry. Indeed, any cross-disciplinary cross-functional project that is managing significant resources (e.g., CapEx and/or human resources) can benefit from this approach.

### (2) Line-of-Sight (LOS) Visibility or Access to Information

The ‘Project Management System (PMS)’ illustrated in FIGS. 3, 4, and 6 through 34 provides (via the ‘output displays’ that are generated by the processor 402 of FIG. 4) a ‘Line-of-Sight (LOS) visibility’ or ‘Line-of-Sight (LOS) access to information’ into the business. ‘LOS’ depends on the user's functional role and interaction level with the PMS system disclosed herein. The ‘LOS visibility’ provides the user with a ‘view into the integrated project plan’ that is filtered based on: (1) his/her discipline or responsibility in the project, and (2) the level of detail appropriate for the role. The ‘LOS visibility’ or ‘LOS access to information’ feature of the ‘Project Management System’, illustrated in FIGS. 3, 4, and 6 through 34, will allow the processor 402 of FIG. 4 to generate ‘output displays’ that will present to the user only that information which is needed to make decisions relating to his/her job and to prevent him/her from becoming overwhelmed by the actual integrated information being managed in the ‘Project Management System’.

Line-of-Sight (LOS) is applied in a variety of cases, as described below:

### (3) Line-of-Sight (LOS) Views of Information and Project Status

In FIGS. 6, 7, 8, 9, 10, 11, 12, and 13, as previously noted, when the processor 402 of FIG. 4 executes the ‘Project Management System software’ 412, one or more ‘output displays’ will be generated that will provide ‘Line-of-Sight (LOS) views of information and project status’. The ‘output displays’ that provide the ‘LOS views of information and project status’ are set forth below, as follows:
FIGS. 6 and 9 show project-wide views of a production project (PM role),
FIGS. 7 and 8 show the Finance view (or the Controller's view), and
FIGS. 10, 11, 12, and 13 show different discipline-based LOS views.

### (4) Line-of-Sight (LOS) Visibility for Earned Value (a Project Performance Metric)

In FIGS. 21, 22, and 23, perhaps even more importantly, the ‘Line-of-Sight (LOS)’ feature associated with the ‘Project Management System’ of FIGS. 3, 4, and 6 through 37 is used to provide actionable feedback to individuals and teams in a project regarding their performance. This is accomplished through ‘LOS slice-and-dice views’ of ‘Earned Value data’ based on ‘discipline’ as well as ‘specific categories of activities within a function’, as illustrated in the following screenshots: (1) FIG. 21 shows ‘Earned Value (EV)’ for a full project. Note that the view is integrated with actual financials in the lower graph taken from the Finance system. The user is selecting a discipline to see Earned Value (EV) for that discipline, and (2) FIGS. 22 and 23 illustrate ‘Earned Value (EV)’ data for specific well types in a project shown across multiple wells drilled of that type.
(5) Line-of-Sight (LOS) Filtered Data Entry/Project Statusing

In FIG. 25, the ‘Line-of-Sight (LOS)’ concept is also used for data input. For example, in FIG. 25, a user-filterable view is illustrated wherein the user can status only their discipline across multiple project elements, such as wells, road constructions, flowlines, etc.

### (6) Line-of-Sight (LOS) Resource Management

In FIGS. 26 and 27, a rig resource management view is illustrated.

In FIG. 26, although this would normally be of interest to a project manager or a drilling manager responsible for multiple rigs in a project, the view shown in FIG. 26 shows the ‘overall rig utilization’ thereby shielding the user from the ‘details of individual wells to which the rig may be assigned’ (the ‘details of individual wells to which the rig may be assigned’ being illustrated in FIG. 27).

In FIG. 27, the ‘details of individual wells to which the rig may be assigned’ is illustrated. In FIG. 27, a ‘rig resource availability view’ is illustrated for a single rig. FIG. 27 color-codes all of the well that the rig is scheduled to drill. FIG. 27 shows a potential under-utilization in the current plan and would normally be useful to the Well Site Supervisor or rig manager so that they can keep the rig fully utilized.

As a result, this specification discloses a ‘method for planning and managing project plans associated with one or more projects’, comprising: receiving a set of input data including knowledge and experience data, and generating one or more ‘output displays’, which are illustrated in FIGS. 6 through 34, that are adapted for planning and managing the project plans of the one or more projects in a business, the output displays including Line-of-Sight views of information pertaining to the business, the Line-of-Sight views providing a user with a view into the project plans of the one or more projects that is filtered based on the user's discipline or responsibility in the project and a level of detail that is appropriate to the user's role in the one or more projects. The input data further includes additional information including human knowledge and experience data, encapsulated knowledge, project-specific constraints, finance data, health safety and environment data, human resource data, and summary daily report data. The output displays are scalable, the scalable output displays being adaptable for application to different sizes of projects, for tracking different quantities of data for one or more projects, and for incorporating one or more disciplines into the project. The Line-of-Sight views of information pertaining to the business includes a Line-of-Sight project-wide view of a production project. The Line-of-Sight views of information pertaining to the business also includes a Line-of-Sight finance view. The Line-of-Sight views of information pertaining to the business also includes different Line-of-Sight discipline based views. The Line-of-Sight views of information pertaining to the business also includes Line-of-Sight visibility for Earned Value adapted for providing feedback information to individuals and teams in a project pertaining to their performance. The Line-of-Sight views of information pertaining to the business also includes Line-of-Sight project statusing adapted for allowing the user to obtain status information pertaining only to the user's discipline across multiple project elements. The Line-of-Sight views of information pertaining to the business also includes Line-of-Sight resource management adapted for allowing the user to view a resource management view and a resource availability view.

The above description of the ‘Project Management System Software’ being thus described, it will be obvious that the same may be varied in many ways. Such variations are not to be regarded as a departure from the spirit and scope of the claimed method or system or program storage device or computer program, and all such modifications as would be obvious to one skilled in the art are intended to be included within the scope of the following claims.

We claim:

1. A method, practiced by a computer system, for planning and managing project plans associated with one or more projects in a business, the computer system including a processor that is responsive to input data, a recorder or display device, and a memory, the memory storing software, comprising:
executing, by the processor, the software stored in the memory of the computer system in response to the input data including knowledge and experience data, and, in response to the executing step, generating one or more output displays adapted for planning and managing the project plans of the one or more projects in the business;
recording or displaying, by the recorder or display device, the one or more output displays on the recorder or display device;
wherein the one or more output displays being recorded or displayed on said recorder or display device include,
Line-of-Sight (LOS) views of information pertaining to the business, the Line-of-Sight views providing a user with a view into the project plans of the one or more projects that is filtered based on the user's discipline or responsibility in the project and a level of detail that is appropriate to the user's role in the one or more projects.

2. The method of claim 1, wherein the input data further includes additional information including human knowledge and experience data, encapsulated knowledge, project-specific constraints, finance data, health safety and environment data, human resource data, and summary daily report data.

3. The method of claim 1, wherein the one or more output displays are scalable, the scalable output displays being adaptable for application to different sizes of projects, for tracking different quantities of data for one or more projects, and for incorporating one or more disciplines into the project.

4. The method of claim 3, wherein the Line-of-Sight views of information pertaining to the business includes a Line-of-Sight project-wide view of a production project.

5. The method of claim 4, wherein the Line-of-Sight views of information pertaining to the business includes a Line-of-Sight finance view.

6. The method of claim 5, wherein the Line-of-Sight views of information pertaining to the business includes different Line-of-Sight discipline based views.

7. The method of claim 6, wherein the Line-of-Sight views of information pertaining to the business includes Line-of-Sight visibility for Earned Value adapted for providing feedback information to individuals and teams in a project pertaining to their performance.

8. The method of claim 7, wherein the Line-of-Sight views of information pertaining to the business includes Line-of-Sight project statusing adapted for allowing the user to obtain status information pertaining only to the user's discipline across multiple project elements.

9. The method of claim 8, wherein the Line-of-Sight views of information pertaining to the business includes Line-of-Sight resource management adapted for allowing the user to view a resource management view and a resource availability view.

10. A program storage device readable by a processor, tangibly embodying a set of instructions executable by the processor, to perform method steps, which are practiced by a computer system, for planning and managing project plans associated with one or more projects in a business in response to a set of input data including knowledge and experience data, the computer system including the processor, and a recorder or display device, the method steps comprising:
in response to the execution, by the processor, of the set of instructions responsive to the input data, recording or displaying, by the recorder or display device, one or more output displays on the recorder or display device, the one or more output displays adapted for planning and managing the project plans of the one or more projects in the business,
wherein the one or more output displays, that are adapted for planning and managing the project plans of the one or more projects in a business and are being recorded or displayed on the recorder or display device, include,
Line-of-Sight (LOS) views of information pertaining to the business, the Line-of-Sight views providing a user with a view into the project plans of the one or more projects that is filtered based on a user's discipline or responsibility in the project and a level of detail that is appropriate to the user's role in the one or more projects.

11. The program storage device of claim 10, wherein the input data further includes additional information including human knowledge and experience data, encapsulated knowledge, project-specific constraints, finance data, health safety and environment data, human resource data, and summary daily report data.

12. The program storage device of claim 10, wherein the output displays are scalable, the scalable output displays being adaptable for application to different sizes of projects, for tracking different quantities of data for one or more projects, and for incorporating one or more disciplines into the project.

13. The program storage device of claim 12, wherein the Line-of-Sight views of information pertaining to the business includes a Line-of-Sight project-wide view of a production project.

14. The program storage device of claim 13, wherein the Line-of-Sight views of information pertaining to the business includes a Line-of-Sight finance view.

15. The program storage device of claim 14, wherein the Line-of-Sight views of information pertaining to the business includes different Line-of-Sight discipline based views.

16. The program storage device of claim 15, wherein the Line-of-Sight views of information pertaining to the business includes Line-of-Sight visibility for Earned Value adapted for providing feedback information to individuals and teams in a project pertaining to their performance.

17. The program storage device of claim 16, wherein the Line-of-Sight views of information pertaining to the business includes Line-of-Sight project statusing adapted for allowing the user to obtain status information pertaining only to the user's discipline across multiple project elements.

18. The program storage device of claim 17, wherein the Line-of-Sight views of information pertaining to the business includes Line-of-Sight resource management adapted for allowing the user to view a resource management view and a resource availability view.

19. A computer system adapted for planning and managing project plans associated with one or more projects in a business, comprising:
a memory storing a software;
a processor adapted for executing the software stored in the memory in response to a set of input data including knowledge and experience data; and
a recorder or display device, responsive to the execution by the processor of the software stored in the memory, adapted for recording or displaying one or more output displays, adapted for planning and managing the project plans of the one or more projects in the business, on the recorder or display device,
wherein the one or more output displays include,
Line-of-Sight (LOS) views of information pertaining to the business, the Line-of-Sight views providing a user with a view into the project plans of the one or more projects that is filtered based on the user's discipline or responsibility in the project and a level of detail that is appropriate to the user's role in the one or more projects.

20. A program storage device readable by a machine, tangibly embodying a set of instructions executable by the machine, to perform method steps for planning and managing project plans associated with one or more projects in a business, said method steps comprising:
in response to a set of input data, generating views representing one or more output displays adapted for planning and managing the project plans of the one or more projects in the business; and
recording or displaying the views representing one or more output displays on a recorder or display device, the views including Line-of-Sight (LOS) views of information pertaining to the business, the Line-of-Sight views providing a user with a view into the project plans of the one or more projects that is filtered based on the user's discipline or responsibility in the project and a level of detail that is appropriate to the user's role in the one or more projects.

21. The program storage device of claim 20, wherein the input data includes human knowledge and experience data, encapsulated knowledge, and project specific constraints, and wherein, in response to the input data, the step of generating views representing one or more output displays adapted for planning and managing the project plans of the one or more projects in the business comprises:
performing a system initialization step;
in response to the performance of the system initialization step, performing a status/update an integrated plan step and performing an update and maintain auxiliary content step; and
in response to the performance of the status/update an integrated plan step and the update and maintain auxiliary content step, generating the views representing the one or more output displays adapted for planning and managing the project plans of the one or more projects in the business.

22. The program storage device of claim 21, wherein the step of performing a system initialization step comprises:
in response to the input data including human knowledge and experience data, encapsulated knowledge, and project specific constraints, generating, by a template generator, a set of elements of an integrated plan;
assembling an integrated plan from said set of elements of the integrated plan; and
initializing auxiliary content, the step of initializing auxiliary content including performing a risk register and issues content initialization step in response to corporate standard practices, location specific operational practices, and knowledge of field history and conditions.

23. The program storage device of claim 22, wherein the step of performing a status/update an integrated plan step comprises:
in response to the step of assembling an integrated plan from said set of elements of the integrated plan, generating an updated integrated plan.

24. The program storage device of claim 23, wherein the step of performing an update and maintain auxiliary content step comprises:
in response to the step of assembling an integrated plan from said set of elements of the integrated plan, updating and maintaining auxiliary content thereby generating a set of contents of a risk register in response to the integrated plan, and
subjecting the integrated plan to other constraints including system generated actions and alerts thereby generating an integrated plan that is subject to other constraints and is responsive to system generated actions and alerts.

25. The program storage device of claim 24, wherein the step of generating the views representing the one or more output displays adapted for planning and managing the project plans of the one or more projects in the business comprises:
in response to the updated integrated plan and the set of contents of the risk register and the integrated plan that is subject to other constraints and is responsive to system generated actions and alerts, generating the views representing one or more output displays adapted for planning and managing the project plans of the one or more projects in the business from said updated integrated plan and the set of contents of the risk register and the integrated plan that is subject to other constraints and is responsive to system generated actions and alerts,
the views representing one or more output displays adapted for planning and managing the project plans of the one or more projects in the business including Line-of-Sight (LOS) views of information pertaining to the business, the Line-of-Sight views providing a user with a view into the project plans of the one or more projects that is filtered based on the user's discipline or responsibility in the project and a level of detail that is appropriate to the user's role in the one or more projects,
the Line-of-Sight views of information pertaining to the business being selected from a group consisting of: a Line-of-Sight project-wide view of a production project, a Line-of-Sight finance view, different Line-of-Sight discipline based views, Line-of-Sight visibility for Earned Value adapted for providing feedback information to individuals and teams in a project pertaining to their performance, Line-of-Sight project statusing adapted for allowing the user to obtain status information pertaining only to the user's discipline across multiple project elements, and Line-of-Sight resource management adapted for allowing the user to view a resource management view and a resource availability view.
